(19) United States
(12) Patent Application Publication
(10) Pub. No.: US 2025/0372657 A1
(43) Pub. Date: Dec. 4, 2025

(54) HIGH ENERGY DENSITY GEL ELECTRODES AND METHOD OF MAKING AND USING THE SAME

(71) Applicant: Battelle Memorial Institute, Richland, WA (US)

(72) Inventors: Wei Wang, West Richland, WA (US); Litao Yan, Richland, WA (US); Yuyan Shao, Richland, WA (US); Ruozhu Feng, Richland, WA (US)

(73) Assignee: Battelle Memorial Institute, Richland, WA (US)

(21) Appl. No.: 19/043,092

(22) Filed: Jan. 31, 2025

Related U.S. Application Data
(60) Provisional application No. 63/548,998, filed on Feb. 2, 2024.

(51) Int. Cl. H01M 4/62; H01M 4/02; H01M 4/24; H01M 10/24

(52) U.S. Cl. CPC H01M 4/628; H01M 4/244; H01M 4/625; H01M 10/24; H01M 2004/023

(57) ABSTRACT

Disclosed herein are embodiments of gel electrodes, cells comprising the same, and methods of making and using the same. The gel electrodes comprise both a conductive material and an electroactive material, which are dispersed in a polymer gel. The cells described herein comprising the disclosed electrode(s) exhibit high energy density and are capable of long-duration energy storage.

### CROSS REFERENCE TO RELATED APPLICATION

This application claims the benefit of and priority to the earlier filing date of U.S. Provisional Patent Application No. 63/548,998, filed on Feb. 2, 2024, the entirety of which is incorporated herein by reference.

### ACKNOWLEDGMENT OF GOVERNMENT SUPPORT

This invention was made with Government support under Contract No. DE-AC05-76RL01830, awarded by the U.S. Department of Energy. The Government has certain rights in the invention.

### FIELD

The present disclosure is directed to a gel electrode and a battery comprising the same, which exhibit high energy density and are capable of long-duration energy storage, along with methods of making and using the same.

### BACKGROUND

Conventional technologies for long-duration energy storage (LDES) are confined by geographical and environmental conditions, unsafe, and/or have a high cost or large carbon footprint to produce. There exists a need in the art for low-cost, safe, and highly-efficient LDES systems that can function in various environments.

### SUMMARY

Disclosed herein are gel electrodes, comprising: a conductive material; and an electrolyte comprising a polymer, an electroactive material, and a solvent; wherein the polymer and the solvent form a gel, and wherein the conductive material and the electroactive material are dispersed in the gel.

Also disclosed herein are cells, comprising a first electrode; a second electrode; and a separator disposed between a first surface of the first electrode and a first surface of the second electrode; wherein the first electrode and second electrode are according to aspects of the present disclosure.

Also disclosed here are methods of making a gel electrode according to aspects of the present disclosure, the method comprising mixing a conductive material, a polymer, an electroactive material, and a solvent to form the gel electrode, wherein the conductive material and the electroactive material are dispersed in the gel electrode. Also disclosed herein are methods of using the cells or batteries according to aspects of the present disclosure, the method comprising charging and/or discharging the cells or batteries.

The foregoing and other objects, features, and advantages of the present disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B are illustrations of batteries according to aspects of the present disclosure, which further illustrate features of the gel electrode described herein, wherein the gel electrode can be used as both a positive electrode and a negative electrode (FIG. 1A) and/or wherein two gel electrodes can be used in combination with a metal substrate (FIG. 1B).

FIG. 2 is a photographic image of a gel electrode according to aspects of the present disclosure prepared in the laboratory.

FIGS. 3A-3C are photographic images of three solutions, wherein FIG. 3A shows an aqueous solution comprising 7.5 M KI; FIG. 3B shows an aqueous solution comprising 7.5 M KI and 3.75 M ZnCl₂; and FIG. 3C shows an aqueous solution comprising 3.75 M ZnCl₂.

FIGS. 4A-4G show ab initio molecular dynamics (AIMD) and classical molecular dynamics (CMD) simulation results of an electrolyte comprising water, 7.5 M KI, and 3.75M ZnCl₂, with or without xanthan gum (XG)polymer that facilitate forming a gel electrode according to the present disclosure; wherein FIG. 4A provides the coordination number of K⁺ and Zn²⁺ in AIMD simulation for an electrolyte without XG; FIG. 4B shows the mean squared displacement of ions and water in CMD simulation for an electrolyte without XG; FIG. 4C shows the mean squared displacement of ions and water in CMD simulation for a gel electrolyte with XG; FIG. 4D shows the radial distribution function of K⁺ and Cl⁻ ions, in an electrolyte with or without XG, obtained by CMD simulation; FIG. 4E shows the radial distribution function of K⁺ and I⁻ ions, in an electrolyte with or without XG, obtained by CMD simulation; FIG. 4F shows the radial distribution function of Zn²⁺ and I⁻ ions, in an electrolyte with or without XG, obtained by CMD simulation; and FIG. 4G shows the radial distribution function of Zn²⁺ and Cl⁻ ions, in the electrolyte with or without XG, obtained by CMD simulation.

FIG. 5 is a spectrum showing results obtained using ⁶⁷Zn nuclear magnetic resonance (NMR) for liquid electrolytes comprising (i) 1 M ZnSO₄ in H₂O; (ii) 3.5 M ZnCl₂ in H₂O; or (iii) 3.5 M ZnCl₂+7.5 M KI in H₂O; and gel electrodes comprising (i) 3.5 M ZnCl₂+7.5 M KI+XG in H₂O; or (ii) 3.5 M ZnCl₂+7.5 M KI+XG+carbon black in H₂O.

FIG. 6 is a spectrum showing results obtained using ¹⁷O NMR for H₂O; liquid electrolytes comprising (i) 3.5 M ZnCl₂ in H₂O; (ii) saturated KI in H₂O; or (iii) 3.5 M ZnCl₂+7.5 M KI in H₂O; and gel electrodes comprising (i) 3.5 M ZnCl₂+7.5 M KI+XG in H₂O; or (ii) 3.5 M ZnCl₂+7.5 M KI+XG+carbon black in H₂O.

FIG. 7 is a spectrum showing results obtained using ¹H NMR for XG in H₂O; liquid electrolytes comprising (i) 3.5 M ZnCl₂ in H₂O; or (ii) saturated KI in H₂O; and gel electrodes comprising (i) 3.5 M ZnCl₂+7.5 M KI+XG in H₂O; (ii) 3.5 M ZnCl₂+7.5 M KI+XG+carbon black in H₂O; or (iii) 3.5 M ZnCl₂+7.5 M KI+XG+carbon black in H₂O at 20% state of charge (“SoC”).

FIG. 8 shows water diffusion rates for H₂O; XG in H₂O; liquid electrolyte comprising (i) saturated KI in H₂O; or (ii) 3.5 M ZnCl₂ in H₂O; and gel electrodes comprising (i) 3.5 M ZnCl₂+7.5 M KI+XG in H₂O; or (ii) 3.5 M ZnCl₂+7.5 M KI+XG+carbon black in H₂O.

FIGS. 9A-9C show information pertaining to the bonding between Zn²⁺ and COO⁻ in XG, wherein FIG. 9A is a schematic showing the chemical structure of XG and highlighting functional groups of the XG that can coordinate with Zn²⁺; FIG. 9B is a spectrum showing complexes formed with Zn²⁺ (halide and XG complexes) as evidenced using ⁶⁷Zn NMR for an electrolyte comprising 3.5 M ZnCl₂+7.5 M KI+XG in H₂O; and FIG. 9C is a radial distribution function showing the distance between oxygens in two carboxyl groups of the polymer in the gel electrode comprising 3.5 M ZnCl₂+7.5 M KI+XG in H₂O.

FIG. 10 is a snapshot from using an ab initio molecular dynamics (AIMD) simulation that shows ion clusters in an electrolyte comprising 3.5 M ZnCl₂+7.5 M KI in H₂O.

FIG. 11 shows images obtained using high-angle annular dark-field scanning transmission electron microscopy (HAADF-STEM) and transmission electron microscopy bright-field (TEM-BF) to analyze a gel electrode comprising 3.5 M ZnCl₂+7.5 M KI+XG+carbon in H₂O, at 20% SoC.

FIG. 12 shows STEM energy-dispersive X-ray spectroscopy (STEM-EDX) images of a sample from a gel electrode comprising 3.5 M ZnCl₂+7.5 M KI+XG+carbon in H₂O, at 20% SoC, wherein the distribution of Zn metal on carbon was observed after washing the sample with water to remove most of KI, ZnCl₂ and XG before analysis.

FIG. 13 shows STEM-HAADF and TEM-BF images of a gel electrode comprising 3.5 M ZnCl₂+7.5 M KI+XG+carbon in H₂O, at 60% SoC.

FIG. 14 shows STEM-EDX images of a sample from a gel electrode comprising 3.5 M ZnCl₂+7.5 M KI+XG+carbon in H₂O, at 60% SoC, wherein the distribution of Zn metal on carbon was observed after washing the sample with water to remove most of KI, ZnCl₂ and XG before analysis.

FIG. 15 shows STEM-HAADF and TEM-BF images of a gel electrode comprising 3.5 M ZnCl₂+7.5 M KI+XG+carbon in H₂O, at 100% SoC.

FIG. 16 shows STEM-EDX images of a sample from a gel electrode comprising 3.5 M ZnCl₂+7.5 M KI+XG+carbon in H₂O, at 100% SoC, wherein the distribution of Zn metal on carbon was observed after washing the sample with water to remove most of KI, ZnCl₂ and XG before analysis.

FIGS. 17A and 17B are Nyquist plots of symmetric Zn—I gel electrode-containing cells (wherein the same gel electrode is used for the positive electrode and the negative electrode), comprising the CB 0.1, CB 0.2, CB 0.3 or CB 0.4 gel electrodes described herein, respectively, wherein FIG. 17A shows the full-scale plots, and FIG. 17B shows the enlarged version of the region in square in FIG. 17A.

FIG. 18 shows Raman spectra of gel electrode comprising 3.5 M ZnCl₂+7.5 M KI+XG+carbon in H₂O, used as a positive electrode, at 0, 20%, 40%, 70%, 80%, and 100% SoCs.

FIGS. 19A-19E show voltage-capacity plots, Coulombic efficiency (CE), and energy efficiency (EE) obtained using cells comprising different symmetric gel electrodes as positive and negative electrode pairs, wherein FIG. 19A shows the voltage-capacity plots of the CB 0.2 cell described herein at 1, 1.5, and 2 mA/cm² current density; FIG. 19B shows the voltage-capacity plots of CB 0.3 cell described herein at 1, 1.5, and 2 mA/cm² current density; FIG. 19C shows the voltage-capacity plots of CB 0.4 cell described herein at 1, and 1.5 mA/cm² current density; FIG. 19D is a graph that shows CE of CB 0.2, CB 0.3, and CB 0.4 cells described herein, at 1, 1.5, and 2 mA/cm² current density; and FIG. 19E is a graph that shows EE of CB 0.2, CB 0.3, and CB 0.4 cells described herein, at 1, 1.5, and 2 mA/cm² current density.

FIG. 20 is a voltage-capacity plot at 1 mA/cm² current density of a gel electrode-containing cell with a negative electrode comprising 7.5 M ZnCl₂+XG+carbon in H₂O, and a positive electrode comprising 3.5 M ZnCl₂+7.5 M KI+XG+carbon in H₂O.

FIG. 21 is a voltage-capacity plot at 5 mA/cm² charge current density and 1 mA/cm² discharge current density of a gel electrode cell with symmetric positive and negative electrodes, both comprising 3.5 M ZnCl₂+7.5 M KI+XG+carbon in H₂O.

FIGS. 22A and 22B show voltage-capacity plots, CE, EE, and cyclic performance for symmetric CB 0.3 cells described herein, wherein FIG. 22A shows voltage-capacity plots of a symmetric cell with 2 mm CB 0.3 electrodes described herein; and a graph that shows CE and EE of the cell, at 1, 1.5, and 2 mA/cm² current density; and FIG. 22B is a graph that shows cyclic performance (capacity, CE, and EE) of a symmetric cell with 1 mm CB 0.3 electrodes, or 2 mm CB 0.3 electrodes described herein.

FIGS. 23A and 23B show cyclic performance (capacity, CE, and EE) at 1 mA/cm² current density of a gel electrode cell with symmetric positive and negative electrodes, both comprising 3.5 M ZnCl₂+7.5 M KI+XG+carbon in H₂O (cutoff potential: 0.45-1.55V), wherein FIG. 23A shows capacity of this cell for 70 charge-discharge cycles, and FIG. 23B shows CE and EE of this cell for 70 charge-discharge cycles.

FIG. 24 shows STEM-EDX images of the negative gel electrode of the gel electrode-containing cell described in FIGS. 23A and 23B, after completing the 70 charge-discharge cycles.

FIG. 25 shows a voltage-capacity plot of a Cr/Fe gel electrode-containing cell when charged at 10 mA/cm² and discharged at 5 mA/cm².

FIGS. 26A and 26B show a voltage-capacity plot and cyclic performance for a Cr/Mn gel electrode-containing cell, wherein FIG. 26A shows a voltage-capacity plot of the cell when charged at 10 mA/cm² and discharged at 5 mA/cm²; and FIG. 26B shows the capacity, CE, and EE of this cell for 18 charge-discharge cycles.

FIGS. 27A and 27B show voltage-capacity plots for a Fe/V gel electrode-containing cell, wherein FIG. 27A shows a voltage-capacity plot of the cell when charged at 10 mA/cm² and discharged at 5 mA/cm², and FIG. 27B shows a voltage-capacity plot of the cell when charged at 10 mA/cm² and discharged at 2.5 mA/cm².

FIG. 28 shows a voltage-capacity plot for a hydrogen-iron gel electrode-containing cell when charged at 5 mA/cm² and discharged at 5 mA/cm².

FIG. 29 shows a voltage-capacity plot for a hydrogen-manganese gel electrode-containing cell when charged at 5 mA/cm² and discharged at 5 mA/cm².

FIG. 30 shows a voltage-capacity plot for a S/Fe gel electrode-containing cell when charged at 1 mA/cm² and discharged at 1 mA/cm².

FIG. 31 shows a voltage-capacity plot for a titanium-manganese gel electrode-containing cell when charged at 5 mA/cm² and discharged at 5 mA/cm².

FIG. 32 shows a voltage-capacity plot for a S/I² gel electrode-containing cell when charged at 1 mA/cm² and discharged at 1 mA/cm².

FIG. 33 shows a voltage-capacity plot for a V/V gel electrode-containing cell when charged at 10 mA/cm² and discharged at 10 mA/cm².

FIG. 34 shows a voltage-capacity plot for a Zn—MnO₂ gel electrode-containing cell when charged at 5 mA/cm² and discharged at 5 mA/cm².

FIG. 35 shows a voltage-capacity plot for a Zn/TEMPO gel electrode-containing cell when charged at 2 mA/cm² and discharged at 2 mA/cm².

FIG. 36 shows a voltage-capacity plot for a Zn/ferrocene gel electrode-containing cell when charged at 2 mA/cm² and discharged at 2 mA/cm².

FIG. 37 shows a voltage-capacity plot for a disulfonated fluorenone/K₄Fe(CN)₆ gel electrode-containing cell when charged at 2 mA/cm² and discharged at 2 mA/cm².

FIG. 38 shows a voltage-capacity plot for a PVA linked TEMPO gel electrode-containing cell when charged at 1 mA/cm² and discharged at 1 mA/cm².

FIGS. 39A-39C show characterizations of gel electrode and electrolyte structures, wherein FIG. 39A is a schematic description of the gel electrode; and FIGS. 39B and 39C show NMR mapping of ¹H (FIG. 39B) and ³⁹K (FIG. 39C) chemical shift for (i) 1.5 M KI, (ii) 7.5 M KI+3.75 M ZnCl₂+XG gel electrolyte, and (iii) 7.5 M KI+3.75 M ZnCl₂+XG+carbon gel electrode.

FIGS. 40A-40E show characterizations of molecular structures and interactions, wherein FIG. 40A is a schematic showing ion cluster formed by cations and anions in the solution after 400 ns under CMD simulation; FIGS. 40B and 40C show Raman spectra of Zn species and water, respectively, for different samples; FIG. 40D shows ⁶⁷Zn NMR for different samples; and FIG. 40E shows ¹²⁷I NMR for different samples.

FIGS. 41A-41G show characterizations of molecular structures and interactions, wherein FIG. 41A show schematic description of XG polymer (FIG. 41A, left image), the hydration shell of XG/water gel (FIG. 41A, middle image), and salt distribution near the hydration shell of XG+ZnCl₂+KI+water gel (FIG. 41A, right image); FIG. 41B shows radial distribution function values for O_{polymer}−O_{water}; FIG. 41C shows the number of water molecules within the 2.5 nm radius around the polymer chain; FIG. 41D shows the average ion-water-concentration ratio inside and outside the hydration shell (<2.5 nm) of the polymer chain; FIG. 41E shows ¹H NMR spectra; FIG. 41F shows water diffusion coefficient, ³⁹K T₁ or T₂, for three different electrolytes; and FIG. 41G shows ion mobility from MD simulation.

FIGS. 42A-42C are graphs showing cell performance, wherein FIG. 42A shows cyclic performance of Zinc/12 gel battery (cut-off potential: 0.45-1.55 V; thickness: ˜1 mm; current density: 1 mA/cm²); FIG. 42B shows charge/discharge voltage curve of Zinc/l gel battery (0.5 mm 7.5 M ZnCl₂ gel negative electrode; 3.75 M ZnCl₂+7.5 M KI 1 mm gel positive electrode; current density: 1 mA/cm²); and FIG. 42C shows the area usage of current conductors across different commercial rechargeable batteries with the same area capacity (commercial LIBs: 4.5 mAh/cm²; commercial NIBs: ˜2 mAh/cm²; commercial Li—S battery: 6-8 mAh/cm²; rechargeable zinc batteries: 8-10 mAh/cm²; battery of the present disclosure: 28 mAh/cm²).

FIG. 43 shows images from cryo-plasma focused ion beam SEM-EDX mapping showing that the element carbon, oxygen, potassium, zinc and chloride are uniformly distributed, indicating that the electrolyte are uniformly dispersed within the carbon network.

FIG. 44 shows photographic images of different electrolytes (A: 25 g KI+10 g water; B: 10.22 g ZnCl₂+10 g water; C: 25 g KI+10.22 g ZnCl₂+10 g water), and illustrates that 25 g of KI cannot fully dissolve in 10 g of water (KI solubility at 25° C.: ˜ 15 g/10 g water), while an interesting phenomenon was observed that a mixture of 25 g KI, 10.22 g ZnCl₂, and 10 g water can achieve a homogenous aqueous solution state.

FIG. 45 is a photographic image of different gel electrolytes, which illustrates that the gel electrolyte made from 25 g KI, 10 g ZnCl₂, 0.45 g XG, and 10 ml water settled at the bottom of the plastic tube (indicated with dashed lines on the image), indicating this sample has fluidic behaviors.

FIG. 46 is a bar graph showing viscosity for 12 different gel electrolytes with compositions summarized in Table 2.

FIG. 47 is a schematic showing ion cluster formed by cations and anions in the solution after 400 ns under CMD simulation.

FIG. 48 shows Zn NMR spectra for gel electrode, wherein the 2^{nd} component can be explained by Zn²⁺ associated to XG-COO⁻ contributing to 5-15% of the total population.

FIG. 49 shows Raman spectra for different samples, wherein the small peak of [ZnI₂(OH)₂]²⁻ at 280 cm⁻¹ in 3.75M ZnCl₂ and 7.5M KI gel electrolyte was absent, suggesting that Zn²⁺ might coordinate with oxygen from polymer chain.

FIG. 50 shows ³⁹K-NMR spectra for different samples.

FIG. 51A and FIG. 51B are bar graphs showing the ion conductivity of two different electrolytes with or without XG, wherein “ZnCl₂+KI” included 10 g ZnCl₂, 25 g KI and 10 ml water; “ZnCl₂+KI+XG” included 10 g ZnCl₂, 25 g KI, 0.45 g XG and 10 ml water; “3.75 M KI” included 12.5 g KI, 10 ml water; and “3.75 M KI+XG” included 12.5 g KI, 10 ml water and 0.45 g XG.

FIG. 52 is a graph showing viscosity and electronic conductivity of gel electrode with different carbon content (g/10 ml).

FIG. 53 is a plot of charge/discharge voltage over time for zinc symmetric cell at a current density of 1 mA/cm² (area capacity: 8 mAh/cm²).

FIG. 54 shows results from charge/discharge profiles of cycling tests, with enlarged profiles for 16-19 cycles and 66-69 cycles shown in the bottom images.

FIG. 55 shows a charge/discharge profile for Zn/l gel battery (cut off potential window: 0.4V-1.55 V; current density: 1 mA/cm²).

FIG. 56 is a bar graph showing water diffusion coefficient, ³⁹K T₁ or T₂, for a gel electrolyte before and after cycling test, showing that almost no decrease on water diffusion coefficient, T₁ and T₂, is observed, suggesting that the electrolyte is very stable after 10 cycles test.

FIG. 57 shows NMR mapping of ¹H chemical shift, wherein spectrum (a) is from gel electrode before cyclic test and spectrum (b) is from gel electrode after 10 cyclic test.

FIGS. 58A and 58B show ex situ Raman spectra of I³⁻ and I⁵⁻ for the positive gel electrode at different SOCs during the charging process (FIG. 58A) and discharging process (FIG. 58B).

FIGS. 59A and 59B are plots that show cycling performance, coulombic efficiency (CE), energy efficiency (EE) (FIG. 59A), and capacity (FIG. 59B), of 1 mm and 2 mm CB 0.3 gel electrode.

FIG. 60 is a plot comparing the thickness and corresponding area capacity of different electrodes reported in the literatures.

FIG. 61 is a plot comparing the mass of I₂ per 1 gram carbon black and corresponding area capacity of different electrodes reported in the literatures.

### DETAILED DESCRIPTION

### Overview of Terms

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited. For numerical ranges provided herein, the endpoints also are contemplated as part of the range unless expressly indicated otherwise.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “introduce,” “flow,” or “provide” to describe the disclosed methods. These terms are high-level abstractions of the actual operations that are performed. The actual operations that correspond to these terms may vary depending on the particular implementation and are readily discernible by one of ordinary skill in the art.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Directions and other relative references (e.g., inner, outer, upper, lower, etc.) may be used to facilitate discussion of the drawings and principles herein, but are not intended to be limiting. For example, certain terms may be used such as “inside,” “outside,” “top,” “down,” “interior,” “exterior,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

Any functional group disclosed herein and/or defined above can be substituted or unsubstituted, unless otherwise indicated herein.

In order to facilitate review of the various embodiments of the disclosure, the following explanations of specific terms are provided:

Aliphatic: A hydrocarbon group having at least one carbon atom to 50 carbon atoms (C1-50), such as one to 25 carbon atoms (C1-25), or one to ten carbon atoms (C1-10), and which includes alkanes (or alkyl), alkenes (or alkenyl), alkynes (or alkynyl), including cyclic versions thereof, and further including straight- and branched-chain arrangements, and all stereo and position isomers as well.

Backbone Polymer: A polymer to which one or more electroactive monomers may be linked. Any polymer having a side chain that can be linked to the electroactive monomer through a crosslinking reaction can be used as a backbone polymer. A backbone polymer may itself be electroactive or non-electroactive. Exemplary backbone polymer includes, but not limited to, polyacrylic acid (PAA), polyvinyl alcohol (PVA) or polyvinyl acetate, carboxyl methyl cellulose, chitosan, starch, dextran, alginate, glycogen, xanthan gum (XG), or iota-carrageenan (IC).

Capacity: The capacity of a cell is the amount of electrical charge a cell can deliver. The capacity is typically expressed in units of mAh, or Ah, and indicates the maximum constant current a cell can produce over a period of one hour. For example, a cell with a capacity of 100 mAh can deliver a current of 100 mA for one hour or a current of 5 mA for 20 hours.

Cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Charge carrier: A chemical species that carries an electric charge and can freely move in an electrolyte to balance electron flow during operation of a cell. Charge carrier includes, but is not limited to, protons, cations, and anions.

Conductive material: This term refers to an electrode component that provides additional electronic conductivity to enable electrochemical reactions of the electrode. In some aspects, the conductive material includes, but is not limited to, metals; transition metal carbides or nitrides, such as MXene; or conductive carbon material such as (but not limited to) amorphous carbon, carbon powder, carbon black, carbon fiber, carbon nanofiber (CNF), carbon nanotube (CNT), graphene, graphite, reduced graphene oxide, carbon products formed from decomposing organic precursors, or any combination thereof.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle.

Counter ion: The ionic species accompanying another ionic species to provide electric neutrality. In some aspects, counter ion(s) accompany an electroactive species. For example, in KI, K⁺ is the counterion to I⁻; in ZnCl₂, Cl⁻ is a counter ion to Zn²⁺.

Current density: The amount of current per unit area. Current density may be expressed in units of mA/cm².

Dispersed: A first substance (e.g., elements, ions, compounds, or molecules) is dispersed in a second substance, if the first substance, or particles formed by the substance, are surrounded by, contained within, or distributed in the second substance. In one example, when the first substance is metal (such as Zn), the first substance can form metal plates or coats at different location within the second substance. Dispersed as used herein includes even distribution and uneven distribution. For example, the first substance can be evenly distributed throughout the second substance, or can be denser in some parts of the second substance than in other parts, or can form aggregates at some parts of the second substance. The second substance can be a single compound or molecule, or mixtures of two or more compounds or molecules, such as a gel formed by a polymer and a solvent. In one example, when the first substance is ion, the first substance can be evenly dispersed in the gel through electrostatic interaction with the charged groups of the polymer. This term does not include a situation wherein a zinc foil is contained within a gel electrolyte.

Electroactive species: A substance (e.g., an element, ion, compound, or molecule including organic and inorganic molecule) that is capable of forming redox couples having different oxidation and reduction states (e.g., ionic species with differing oxidation states, or a metal cation and its corresponding neutral metal atom), including the ionic species formed therefrom. Electroactive species include inorganic and organic active species, which includes electroactive monomers, and dimers and polymers built from such monomers. Conversions between chemical energy and electrical energy occur with an accompanying change in the oxidation state of these substances. As used herein, electroactive species can refer to either species, or both species, of a redox couple. A redox couple includes a species that can donate electron(s), and the resulting species after the electron(s) are donated; or includes a species that can receive electron(s), and the resulting species after the electron(s) are received.

Electroactive material: Material that comprises, consists essentially of, or consists of one or more electroactive species.

Electrode: An electronically conductive structure of a cell where oxidation or reduction reaction takes place. An anode is an electrode where an oxidation reaction occurs (loss of electrons for the electroactive species). A cathode is an electrode where a reduction reaction occurs (gain of electrons for the electroactive species). The positive electrode is the electrode with a higher potential than the negative electrode. During discharge, the positive electrode is a cathode, and the negative electrode is an anode. During charge, the positive electrode is an anode, and the negative electrode is a cathode.

Electrolyte: A substance containing free ions and/or radicals that behaves as an ionically conductive medium. The free ions and/or radicals may include electroactive species, and/or counter ions. In some aspects, the electrolyte is a gel formed by a solvent and a polymer. In some aspects, the solvent may be water, methanol, dimethoxyethane (DME), methyl cyanide (MeCN), dimethylformamide (DMF), 1,3-dioxolane (DOL), or alkyl carbonate solvents such as ethylene carbonate (EC), dimethyl carbonate (DMC), ethylmethyl carbonate (EMC), diethyl carbonate (DEC), or fluoroethylene carbonate (FEC). In some aspects, the polymer may comprise one or more hydrophilic functional groups in its side chains, such hydrophilic functional groups being described herein. In some aspects, the polymer may be, but is not limited to, a protein (e.g., collagen, or gelatin), denatured protein (e.g., methacrylated gelatin (GelMA), or methacrylated collagen (Col-MA)), polysaccharide (e.g., chitosan, starch, alginate, xanthan gum (XG), or iota-carrageenan (IC)), or synthetic polymers (e.g., polyacrylic acid (PAA), polyvinyl alcohol (PVA) or polyvinyl acetate).

Energy efficiency (EE): The product of coulombic efficiency (CE) and voltage efficiency (VE), wherein EE=CE×VE.

Gel: A colloidal system comprising a solid three-dimensional network within a liquid (e.g., water or other solvent), wherein the three-dimensional network is formed by polymeric materials (including polymeric materials that can be formed in situ from monomers when forming the gel electrode described herein). Gels according to aspects of the present disclosure may be formed by polymeric structures comprising one or more hydrophilic functional groups in their side chains; and can be natural-, or synthetic-polymeric-based networks. In some aspects of the disclosure, the gel can comprise one or more monomers that have not reacted to form the polymeric material that makes up the gel.

Gel electrode: A structure comprising a gel that is both electronically conductive and ionically conductive, and contains one or more electroactive species discussed herein in combination with a conductive material dispersed within the gel. In some aspects, a gel electrode can further comprise a metal substrate placed on a surface of the gel.

Heteroaliphatic: An aliphatic group comprising at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group. Alkoxy, ether, amino, disulfide, peroxy, and thioether groups are exemplary (but non-limiting) examples of heteroaliphatic. In some embodiments, a fluorophore can also be described herein as a heteroaliphatic group, such as when the heteroaliphatic group is a heterocyclic group.

Metal substrate: As used herein, a metal substrate refers to a plate, sheet, or foil of metal that can be placed on a surface of an electrode (e.g., a negative or positive electrode) opposite a surface of the electrode that faces the separator in a cell (or that will face a separator when the electrode is used in a cell). The metal substrate can serve as a source of metal or metallic ions that participate in an electrochemical reaction. In some aspects, the metal substrate is a metallic foil, such as a Zn foil.

Organic solvent: An organic substance capable of dissolving other substances.

Organometallic compound: A compound containing a chemical bond between a carbon atom and a metal.

Polymer: A molecule of repeating structural units (e.g., monomers) formed via a chemical reaction, e.g., polymerization, amongst at least two monomers. In some aspects, the polymer can comprise a plurality of the same monomeric units. In other aspects, the polymer can comprise a plurality of different monomeric units. Polymers capable of forming gels according to aspects of the present disclosure may comprise one or more hydrophilic functional groups in their side chains, and can be natural, or synthetic polymers. Exemplary polymers that can form gels may include, but are not limited to, proteins (e.g., collagen, or gelatin), denatured proteins (e.g., methacrylated gelatin (GelMA), or methacrylated collagen (Col-MA)), polysaccharide (e.g., hemicellulose; cellulose; a cellulose ether, such as carboxyl methyl cellulose; chitosan; starch; dextran; alginate; glycogen; xanthan gum (XG); or iota-carrageenan (IC)), and synthetic polymers (e.g., polyacrylic acid (PAA), polyvinyl alcohol (PVA) or polyvinyl acetate).

Polymerization: A chemical reaction, usually carried out with a catalyst, heat or light, in which a large number of relatively simple molecules (monomers) combine to form a chainlike macromolecule (a polymer). The chains further can be combined, or crosslinked, by the addition of appropriate chemicals. The monomers typically are unsaturated or otherwise reactive substances. Polymerization commonly occurs by addition or condensation. Addition polymerization occurs when an initiator, usually a free radical, reacts with a double bond in the monomer. The free radical adds to one side of the double bond, producing a free electron on the other side. This free electron then reacts with another monomer, and the chain becomes self-propagating. Condensation polymerization involves the reaction of two monomers, resulting in the splitting out of a water molecule.

Polysaccharide: A polysaccharide is a polymer of monosaccharides linked together by glycosidic bonds. Monosaccharides are aldehydes or ketones with two or more hydroxyl groups, and a general chemical formula of (C·H₂O)n. Common examples of polysaccharide include, but are not limited to, hemicellulose, cellulose, cellulose ether (e.g., carboxyl methyl cellulose), starch, dextran, chitosan, glycogen, alginate, xanthan gum (XG), or iota-carrageenan (IC).

Powder: A composition comprising fine solid particles that are relatively free flowing from one another.

Separator: A separator is a porous sheet or film of synthetic or natural material, placed between two electrodes in a cell (e.g., between a positive and a negative electrodes). The pores in a separator can be nanopores, micropores, or a combination thereof. The main function of a separator is to prevent physical contact between the positive and negative electrodes to prevent electrical short circuits while allowing the transport of ionic charge carriers that are needed to close the circuit during the passage of current in an electrochemical cell. A separator can be made from materials include, but not limited to, polymer films (such as polyethylene (PE), polypropylene, polytetrafluoroethylene (PTFE), polyvinyl chloride (PVC)); nonwoven fibers (such as cotton, nylon, polyesters, glass); ceramic; and naturally occurring substances (such as rubber, asbestos, wood). A separator can also be made from a polymeric composite material, wherein particles (such as silica particles) are enmeshed in a polymer matrix. In some aspects, such a composite material includes, but is not limited to, PVC/silica, PE/silica, and PTFE/silica. In some aspects, the separator is an ion-selective membrane, which impedes passage of the redox active molecules while permitting the flow of solvent molecules and/or ion species such as hydrogen ions, halide ions, or metal ions. In some aspects, the ion-selective membrane is an anion-selective membrane, while in other aspects, the ion-selective membrane is a cation-selective membrane. The ion-selective membrane can be made from materials include, but not limited to, poly(phthalazinone ether ketone) (PPEK) or sulfonated version thereof (SPPEK); poly(phthalazinone ether sulfone) (PPES) or sulfonated version thereof (SPPES); poly(phthalazinone ether sulfone ketone) (PPESK) or sulfonated version thereof (SPPESK); or a fluoropolymer (such as fluoroethylene, fluoropropylene), or sulfonated fluoropolymer (such as sulfonated tetrafluoroethylene-based polymer, e.g., Nafion®). In some aspects, the separator is a polymeric composite separator, such as a PVC/silica separator, a PE/silica separator, and a PTFE/silica separator.

Specific capacity: Capacity per unit of mass, which may be expressed in units of mAh/g.

Solvent: As used herein, solvent refers to any liquid substance that, together with a polymer, can form a gel, in which a conductive material and electroactive material can be dispersed. Non-limiting examples of solvents can include water, or organic solvents, such as methanol, dimethoxyethane (DME), methyl cyanide (MeCN), dimethylformamide (DMF), 1,3-dioxolane (DOL), or alkyl carbonate solvents such as ethylene carbonate (EC), dimethyl carbonate (DMC), ethylmethyl carbonate (EMC), diethyl carbonate (DEC), or fluoroethylene carbonate (FEC).

Voltage efficiency (VE): The voltage produced by the battery while discharging divided by the charging voltage.

### INTRODUCTION

The intermittent and fluctuating nature of renewable energy sources is becoming a key barrier in modern grid management as production from these sources steadily increases. There exists a need in the art for low-cost and highly-efficient stationary energy storage (SES) technologies to provide stable services, particularly a need for long-duration energy storage (LDES). LDES provides quasi-baseload energy services, such as extended backup power in response to natural disasters or grid outage; renewable integration for seasonal shift or regional electricity grid; and island/remote microgrids.

Historically, pumped hydroelectric storage (PHS) and underground compressed air energy storage (CAES) provide LDES for bulk energy management through conversion of electrical energy to potential energy for storage. These technologies are confronted with challenges including geographical and environmental limitations, large construction costs, and inability to provide distributed services.

Electrochemically based SES technologies, such as batteries, are confined by the fact that the amount and volume of the active materials needed proportionally increase with storage duration. Long-duration batteries require significant amounts and volumes of active materials, which pushes up the cost of the SES systems. Redox flow battery (RFB) is an energy storage system that utilizes redox-active materials with different redox potentials. In an RFB, energy is stored in a liquid electrolyte, which is driven by pumps to flow through the electrochemical cell for redox reactions. An RFB-based LDES system, however, requires a proportional increase in the amount of the redox-active materials. This makes it undesirable to use RFBs that rely on high-cost active materials, such as vanadium. Other RFBs, e.g., zinc bromide or all-iron flow batteries, were proposed as possible solutions for LDES; however, they exhibit low volumetric energy density, which will cause a significant increase in carbon footprint if adapted for LDES. Other RFBs that purport to use low-cost materials, such as O₂/S, have poor performance. Additionally, the complex pipe and pump system in RFBs consumes extra energy to flow the electrolyte and requires frequent maintenance.

Another technology, lithium-ion batteries (LIBs), feature high energy density and miniatured structure design, and are commonly used in consumer electronic devices; however, the rapidly growing cost of component materials in LIBs, and safety issues caused by flammable materials raised concerns for developing LIBs as part of a LDES system. In summary, the currently available SES systems cannot simultaneously meet the requirements of safety, low-cost, small-footprint, and long-duration.

Disclosed herein are electrodes that can be used to prepare stationary redox batteries, wherein the electrodes offer a low-cost electrode design and high capacity using highly soluble redox-active materials. In some aspects of the disclosure, the electrodes are gel electrodes that can be used in symmetric cell configurations wherein the same material is used to provide the positive and negative electrodes of the cell.

### Electrodes

Electrodes according to aspects of the present disclosure comprise (i) a conductive material; and (ii) an electrolyte comprising a polymer, an electroactive material, and a solvent. The electrodes are also referred to herein as “gel electrodes” because the polymer and the solvent components of the electrolyte form a gel in which the conductive material and the electroactive material are dispersed. Gel electrodes of the present disclosure are not equivalent to gel electrolytes that might be used in the art because all electrically active components of the disclosed electrodes are contained within the gel of the gel electrode, whereas conventional gel electrolytes must be paired with separate electrodes that comprise electroactive and/or conductive materials. In particular aspects of the disclosure, the gel electrode provides both ionic conductivity and electrical conductivity.

In some aspects of the disclosure, the electrolyte component of the electrode provides ionic conductivity.

Any polymer comprising a hydrophilic side chain can be included as a component of the electrolyte. In some aspects, the polymer may be formed by monomers that comprise a hydrophilic side chain; the monomers may be the same or different. In some aspects, the polymer may be formed by a mixture of monomers, wherein some monomers comprise a hydrophilic side chain and other monomers do not comprise a hydrophilic side chain. In yet additional aspects comprising a mixture of monomers, the monomers having hydrophilic side chains can be the same or different as one another and/or the monomers without the hydrophilic side chains can be the same or different as one another. A hydrophilic side chain refers to a side chain that comprises a hydrophilic functional group. In some aspects, the hydrophilic functional group includes amino (—NH₂), hydroxyl (—OH), amide (—CONH₂), sulfonic acid (—SO₃H), sulfonate (—SO₃⁻), organosulfate (—OSO₃H or —OSO₃), carboxylic acid (—COOH), carboxylate (—COO⁻), a phosphoric acid (—OP(═O)(OH)₂), phosphate (—OP(═O)(O⁻)₂), phosphorous acid (—P(═O)(OH)₂), phosphonate (—P(═O)(OR)₂ or —P(═O)(O)₂, wherein R is H, aliphatic, or aromatic), or any combination thereof. In some aspects, the hydrophilic functional group can be selected from electron withdrawing group described as being suitable of the R¹ or R² groups disclosed in U.S. Patent Application Publication No. US 2021/0147347 A1, the relevant portion of which is incorporated herein by reference. In some such aspects, the hydrophilic functional group includes —SO₃Z, —CO₂Z, —(CH₂)ₘPO₃Z₂, X, —NR′₃⁺, —NO₂, —SO₂R′, —CN, —CX₃, —COX, —C(H)O, —C(O)R′, —C(O)NH₂, —C(O)NHR′, —C(O)NR′₂, —N═O, —OR′, —(CH₂CH₂O)ₚR′, or any combination thereof, wherein each R′ independently is H, aliphatic, or heteroaliphatic; X is halo; each Z independently is a counterion with a +1 charge; m is an integer from 0 to 10; and p is an integer from 1 to 10. In some aspects, the polymer is a natural polymer (e.g., a natural polysaccharide) or a synthetic polymer (e.g., a synthetic polysaccharide or other synthetic polymer). In some aspects, the polymer is xanthan gum (XG), chitosan, cellulose, carboxyl methyl cellulose, gelatin, iota-carrageenan (IC), polyacrylic acid (PAA), polyvinyl alcohol (PVA), or polyvinyl acetate.

In aspects of the present disclosure, the polymer is present in the gel electrode at a concentration ranging from 5 g/L to 100 g/L, 10 g/L to 100 g/L, 15 g/L to 100 g/L, 20 g/L to 100 g/L, 25 g/L to 100 g/L, 30 g/L to 100 g/L, 35 g/L to 100 g/L, 40 g/L to 100 g/L, 5 g/L to 95 g/L, 10 g/L to 95 g/L, 15 g/L to 95 g/L, 20 g/L to 95 g/L, 25 g/L to 95 g/L, 30 g/L to 95 g/L, 35 g/L to 95 g/L, 40 g/L to 95 g/L, 5 g/L to 90 g/L, 10 g/L to 90 g/L, 15 g/L to 90 g/L, 20 g/L to 90 g/L, 25 g/L to 90 g/L, 30 g/L to 90 g/L, 35 g/L to 90 g/L, 40 g/L to 90 g/L, 5 g/L to 85 g/L, 10 g/L to 85 g/L, 15 g/L to 85 g/L, 20 g/L to 85 g/L, 25 g/L to 85 g/L, 30 g/L to 85 g/L, 35 g/L to 85 g/L, 40 g/L to 85 g/L, 5 g/L to 80 g/L, 10 g/L to 80 g/L, 15 g/L to 80 g/L, 20 g/L to 80 g/L, 25 g/L to 80 g/L, 30 g/L to 80 g/L, 35 g/L to 80 g/L, 40 g/L to 80 g/L, 5 g/L to 75 g/L, 10 g/L to 75 g/L, 15 g/L to 75 g/L, 20 g/L to 75 g/L, 25 g/L to 75 g/L, 30 g/L to 75 g/L, 35 g/L to 75 g/L, 40 g/L to 75 g/L, 5 g/L to 70 g/L, 10 g/L to 70 g/L, 15 g/L to 70 g/L, 20 g/L to 70 g/L, 25 g/L to 70 g/L, 30 g/L to 70 g/L, 35 g/L to 70 g/L, 40 g/L to 70 g/L, 5 g/L to 65 g/L, 10 g/L to 65 g/L, 15 g/L to 65 g/L, 20 g/L to 65 g/L, 25 g/L to 65 g/L, 30 g/L to 65 g/L, 35 g/L to 65 g/L, 40 g/L to 65 g/L, 5 g/L to 60 g/L, 10 g/L to 60 g/L, 15 g/L to 60 g/L, 20 g/L to 60 g/L, 25 g/L to 60 g/L, 30 g/L to 60 g/L, 35 g/L to 60 g/L, 40 g/L to 60 g/L, 5 g/L to 55 g/L, 10 g/L to 55 g/L, 15 g/L to 55 g/L, 20 g/L to 55 g/L, 25 g/L to 55 g/L, 30 g/L to 55 g/L, 35 g/L to 55 g/L, 40 g/L to 55 g/L, 5 g/L to 50 g/L, 10 g/L to 50 g/L, 15 g/L to 50 g/L, 20 g/L to 50 g/L, 25 g/L to 50 g/L, 30 g/L to 50 g/L, 35 g/L to 50 g/L, 40 g/L to 50 g/L, 5 g/L to 45 g/L, 10 g/L to 45 g/L, 15 g/L to 45 g/L, 20 g/L to 45 g/L, 25 g/L to 45 g/L, 30 g/L to 45 g/L, 35 g/L to 45 g/L, or 40 g/L to 45 g/L.

In some aspects, monomers used to form the polymer materials of the electrolyte as disclosed herein may be present in the electrolyte. For example, the gel electrode-containing cell or battery (which comprises two or more cells) disclosed herein may include such monomers that have not polymerized. In such aspects, the monomers may be present and do not negatively impact performance of the electrode, cell, or battery. The monomers may include a hydrophilic side chain disclosed herein. In some examples, the monomers include monosaccharide (such as glucose, fructose, galactose, galactopyranose, mannose), unsubstituted or substituted, for example, with a carboxymethyl group; glucuronic acid; glucosamine; amino acid; acrylic acid; vinyl alcohol; vinyl acetate; or any combination thereof. In some examples, the monomers are those that can form one or more of xanthan gum (XG), chitosan, cellulose, carboxymethyl cellulose, gelatin, iota-carrageenan (IC), polyacrylic acid (PAA), polyvinyl alcohol (PVA), and polyvinyl acetate. In some aspects of the disclosure, the electrolyte may be prepared by combining monomer units with other electrolyte components and performing a polymerization step wherein the monomer units are polymerized to the polymer component in the presence of other electrolyte components. In yet other aspects of the disclosure, the monomers are first polymerized and then combined with the other electrolyte components. Methods for polymerizing monomer units to arrive at the polymer are recognized in the art, particularly with the benefit of the present disclosure. In some aspects, polymerization can involve addition polymerization, radical polymerization, anionic polymerization, acid-catalyzed polymerization, condensation polymerization, and the like. In some aspects, a mixture of the monomers and polymers may be included in the electrolyte. In some examples, the monomers are those that form the polymers disclosed herein.

Any solvent that can form a gel with the polymer can be included as a component of the electrolyte. In some aspects, the solvent may be an aqueous solvent, an organic solvent, or a combination thereof. In some particular aspects, the solvent is selected from water, methanol, dimethoxyethane (DME), methyl cyanide (MeCN), dimethylformamide (DMF), 1,3-dioxolane (DOL), or alkyl carbonate solvents such as ethylene carbonate (EC), dimethyl carbonate (DMC), ethylmethyl carbonate (EMC), diethyl carbonate (DEC), fluoroethylene carbonate (FEC), or a combination thereof. In some aspects, the solvent is water. In some further aspects the solvent is present in the gel electrode at a concentration ranging from 5 M to 60 M, 5 M to 55 M, 5 M to 50 M, 5 M to 45 M, 5 M to 40 M, 5 M to 35 M, 5 M to 30 M, 10 M to 60 M, 10 M to 55 M 10 M to 50 M, 10 M to 45 M, 10 M to 40 M, 10 M to 35 M, 10 M to 30 M, 15 M to 60 M, 15 M to 55 M, 15 M to 50 M, 15 M to 45 M, 15 M to 40 M, 15 M to 35 M, 15 M to 30 M, 20 M to 60 M, 20 M to 55 M, 20 M to 50 M, 20 M to 45 M, 20 M to 40 M, 20 M to 35 M, 20 M to 30 M, 25 M to 60 M, 25 M to 55 M, 25 M to 50 M, 25 M to 45 M, 25 M to 40 M, 25 M to 35 M, 25 M to 30 M, 30 M to 60 M, 30 M to 55 M, 30 M to 50 M, 30 M to 45 M, 30 M to 40 M, 30 M to 35 M, 35 M to 60 M, 35 M to 55 M, 35 M to 50 M, 35 M to 45 M, 35 M to 40 M, 40 M to 60 M, 40 M to 55 M, 40 M to 50 M, 40 M to 45 M.

In the gel electrodes of the present disclosure, an electroactive material is dispersed in the gel. Any electroactive material that can donate or receive electrons in the gel can be used. The electroactive material comprises one or more electroactive species. The electroactive material can include an inorganic material, an organic material, or a combination thereof.

In some aspects, the electroactive material can include an inorganic material that provides inorganic electroactive species (or redox couples). Exemplary inorganic electroactive species (or redox couples) include, but are not limited to, Zn/Zn²⁺; Cr²⁺/Cr³⁺; V²⁺/V³⁺; S₄²⁻/S₂²⁻; H⁺/H₂; Ti³⁺/Ti⁴⁺; I³⁻/I⁻; Fe²⁺/Fe³⁺; V⁴⁺/V⁵⁺; Br₂/Br⁻; Mn²⁺/Mn⁴⁺; or Mn²⁺/Mn³⁺.

In particular aspects, the electroactive material may comprise Zn, or ions thereof; I₂, or ions thereof; Cr, or ions thereof; V, or ions thereof; S, or ions thereof; Ti, or ions thereof; H₂, or ions thereof; Br₂, or ions thereof; Mn, or ions thereof; Fe, or ions thereof; or any combination thereof. In some aspects, the electroactive material is initially provided as a precursor compound. In some aspects, the precursor compound can be a metal oxide, such as manganese oxide, vanadium oxide, or the like. In some other aspects, the precursor compound can be a metal salt having a structure according to a formula MXₙ, wherein M is a metal and each X independently is selected from halogen (e.g., Cl⁻, F⁻, Br⁻, or I⁻), sulfate (SO₄⁻²), or combinations thereof; and n is an integer selected from 1 to 4, such as 1, 2, 3, or 4. In some aspects, M is selected from Na, K, Zn, Fe, Cr, V, Mn, Ti, or the like, including oxides thereof. In some aspects, each X independently is selected from Br⁻, Cl⁻, I⁻, F⁻, or SO₄²⁻. In some exemplary aspects of the disclosure, the precursor compound is selected from ZnCl₂, ZnBr₂, ZnSO₄, KI, NaI, FeCl₂, FeBr₂, FeSO₄, FeCl₃, FeBr₃, Fe₂(SO₄)₃, CrCl₃, CrBr₃, Cr₂(SO₄)₃, VOSO₄, MnCl₂, MnBr₂, MnSO₄, TiOSO₄, or TiCl₄.

In particular aspects, the electroactive material may comprise Zn, Zn²⁺, I₃⁻, I⁻, or any combination thereof. In some aspects, the electroactive material may comprise Zn²⁺, I⁻, or a combination thereof. In some other aspects, the electroactive material may comprise: Zn and/or Zn²⁺; Cr²⁺ and/or Cr³⁺; V²⁺ and/or V³⁺; S₄²⁻ and/or S₂²⁻; H⁺ and/or H₂; or Ti³⁺ and/or Ti⁴⁺ (e.g., TiO²⁺). In some aspects, the electroactive material may comprise Zn²⁺ Cr³⁺, V³⁺, S₄²⁻, H⁺, or Ti⁴⁺ (e.g., TiO²⁺). In some aspects, such electroactive material is included in the negative electrode, or is included in both the positive and negative electrodes but undergoes redox reactions at the negative electrode. In some other aspects, the electroactive material may comprise I³⁻ and/or I⁻; Fe²⁺ and/or Fe³⁺; V⁴⁺ and/or V⁵⁺; Br₂ and/or Br⁻; Mn²⁺ and/or Mn⁴⁺; or Mn²⁺ and/or Mn³⁺. In some aspects, the electroactive material may comprise I⁻, Fe²⁺, Fe³⁺, V⁴⁺, Br, Mn⁴⁺, or Mn²⁺. In some aspects, such electroactive material is included in the positive electrode, or is included in both the positive and negative electrodes but undergoes redox reactions at the positive electrode.

In some aspects, the electroactive material can include an organic material, which can be (i) an electroactive monomer, (ii) an electroactive dimer comprising two electroactive monomers that are bound together, (iii) an electroactive polymer comprising three or more electroactive monomers that are bound together, (iv) an electroactive polymer comprising a backbone polymer linked with one or more electroactive monomers, or (v) any combination of two or more of (i), (ii), (iii), or (iv).

In particular aspects, the electroactive material can be an organic material that provides organic electroactive species (or organic redox molecules). Exemplary organic electroactive species can include monomers and/or polymers of organic molecules, including, but not limited to, molecules comprising aromatic ring systems, heterocyclic ring systems, carbocyclic ring systems, or combinations thereof (e.g., such as fused ring systems comprising a combination of two or more aromatic ring systems, heterocyclic ring systems, or carbocyclic ring systems); organometallic compounds; and/or ions thereof. All such materials can be functionalized with one or more aliphatic and/or functional groups. Such functional groups include, but are not limited to, ether groups, amide groups, hydroxyl groups, sulfonate groups, carboxylate groups, quaternary amine groups, phosphonate groups. In some aspects of the disclosure, the organic electroactive species can comprise a heteroaryl ring system (e.g., a 5- or 6-membered heteroaryl ring comprising one or more heteroatoms, such as nitrogen); an aryl ring system (e.g., a 5- or 6-membered aryl ring system, such as a cyclopentadienyl ring or a phenyl ring, such as for metallocene monomers, catechol monomers, and/or resorcinol monomers); a heterocyclic ring system (e.g., a phenazine ring system or an N-functionalized version thereof; an alloxazine ring system; a naphthalene diimide ring system; a TEMPO ring system; a phenothiazine ring system, or an N-functionalized version thereof; a phenoxazine ring system, or an N-functionalized version thereof; and the like); a carbocyclic ring system (e.g., an anthraquinone ring system, a fluorenone ring system, a quinone ring system; or the like).

In particular aspects, the electroactive monomer can comprise a phenazine ring system and/or ions and/or N-functionalized versions thereof; an anthraquinone ring system and/or ions thereof; an alloxazine ring system and/or ions thereof; a viologen ring system and/or ions thereof; a diazobenzene ring system and/or ions thereof; a fluorenone ring system and/or ions thereof; a naphthalene diimide ring system and/or ions thereof; a TEMPO ring system and/or ions thereof; a quinone ring system and/or ions thereof; a phenothiazine ring system and/or ions and/or N-functionalized versions thereof; a phenoxazine ring system and/or ions and/or N-functionalized versions thereof; a catechol ring system and/or ions thereof; a resorcinol ring system and/or ions thereof; or an organometallic compound, and/or ions thereof.

In particular aspects, the organometallic compound can be a metal complex and/or a metallocene complex that comprises one or more organic ligands. Exemplary metals for such complexes can include Zn, Fe, Cr, Mn, Co, Ti, Ni, Ru, Os, Cu, and the like. Ligands used in such complexes can include monodentate chelating ligands (e.g., cyanide ion, ammonia, halide, nitric oxide), bidentate chelating ligands (e.g., ethylenediamine, glycinate ion, oxalate ion, 2-diaminocyclohexane, 2,2′-bipyridine, 1,10-phenanthroline), tridentate chelating ligands (e.g., 1,2,4-triazole, terpyridine, triethylenetetramine, tris(2-aminoethyl)amine, 1,4,7-triazacyclononane, 1,4,7-trioxonane), quadridentate chelating ligands (e.g., chlorin, corrin, 1,4,7,10-tetraoxacyclododecane, 1,4,8,11-tetraazacyclotetradecane, 1,4,7,10-tetraazacyclododecane), pentadentate chelating ligands (e.g., ethylenediaminetriacetic acid, PY₄lm), hexadentate chelating ligands (e.g., ethylenediaminetetraacetate (EDTA), diethylenetriaminepentaacetic acid (DTPA), diaminopropanetetraacetic acid (PDTA)), aryl ligands (e.g., cyclopentadienyl ligands), heteroaryl ligands (e.g., pyridine, bipyridine, and the like, including substituted versions thereof), and phosphonate-based ligands (e.g., those disclosed in U.S. Patent Application Publication No. US 2023/0051932 A1, the relevant portion of which is incorporated herein by reference). Such complexes may comprise the ligand and metal at a ligand to metal ratio of 6:1, 5:1, 4:1, 3:1, 2:1, or 1:1. In some examples, the organometallic compound can include a metallocene, such as a ferrocene, cobaltocene, manganocene, chromocene, nickelocene, or the like. In some examples, the organometallic compound can include a cyanometallate, such as [Fe(CN)₆]³⁻, [Fe(CN)₆]⁴⁻, [Ni(CN)₄]²⁻, [Ni(CN)₄]⁴⁻, [Co(CN)₆]³⁻, [Co(CN)₆]⁴⁻, [Cu(CN)₄]²⁻, [Cu(CN)₄]³⁻, [Cr(CN)₆]³⁻, [Cr(CN)₆]⁴⁻, [Mn(CN)₆]³⁻, [Mn(CN)₆]⁴⁻, and/or a salt thereof (such as a potassium salt selected from K₄Fe(CN)₆, K₃Fe(CN)₆, and others). In some examples, the ligands in the organometallic compounds can include the phosphonate-based ligands, which can include etidronic acid, nitrilotri(methylenephosphonic acid), ethylenediaminetetra(methylenephosphonic acid), iminodi(methylphosphonic acid), methylenediphosphonic acid, (aminomethyl)phosphonic acid, 2-aminoethylphosphonic acid, N,N-bis(phosphonomethyl)glycine, N-(phosphonomethyl)glycine, N-(phosphonomethyl)iminodiacetic acid, phosphonoacetic acid, pyrophosphate, and trimetaphosphate. In such examples, the metal may include Fe or Ti. In some examples, the organometallic compounds can include those disclosed in U.S. Patent Application Publication No. US 2023/0051932 A1, the relevant portion of which is incorporated herein by reference, particularly the portion describing multidentate ligands. In some examples, the ligands in the organometallic compounds can include DTPA or PDTA. In such examples, the metal may include Fe or Cr. In some examples, the organometallic compounds can include FeDTPA or CrPDTA.

Exemplary organic electroactive monomers include, but are not limited to compounds comprising one or more structures shown in the table below, including ions thereof. Dimers and/or polymers formed from such monomers are known to those in the art with the benefit of the present disclosure. With reference to the structures below, each M can be a metal selected from Zn, Fe, Cr, Mn, Co, Ni, and the like and X can be a counter ion selected from a halide (e.g., F, Br, I, or Cl) or other suitable negatively charged counter ion. The wavy lines included in the structures below illustrate bond disconnections between the illustrated compounds and either (i) other monomers in the instance of a dimer or polymer comprising the illustrated compound, and/or (ii) substituents attached to the monomer. In some aspects, the connections denoted by the wavy lines are optional connections, and when the illustrated monomers are not in the form of a dimer or polymer, there is no connection of the monomer with another monomer.

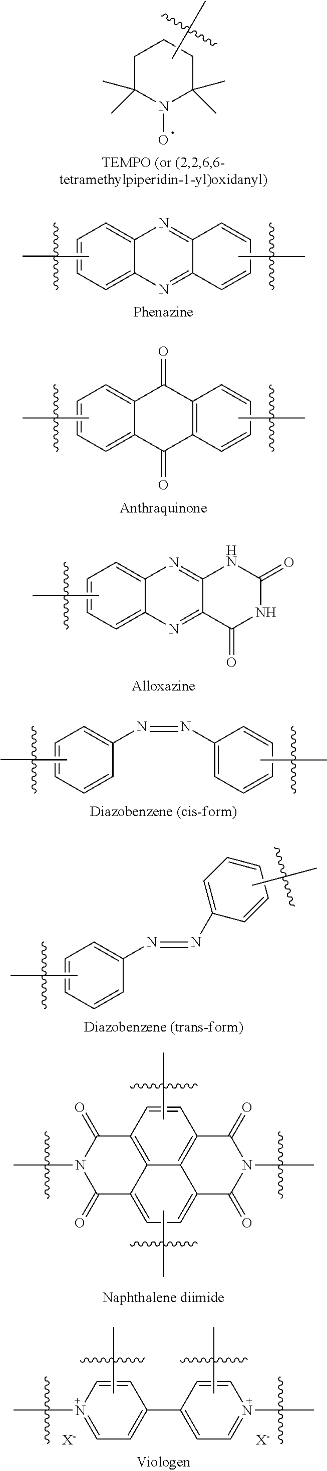

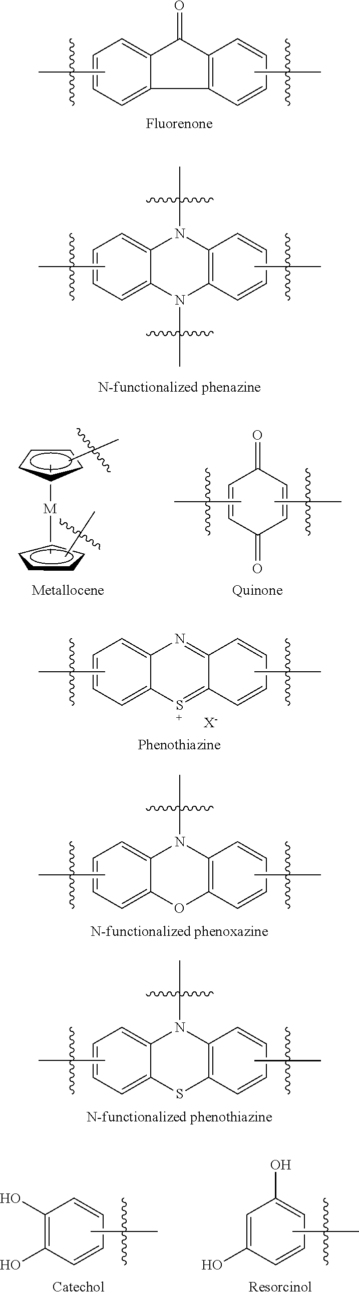

In representative aspects, an organic electroactive material comprising TEMPO, ferrocene, [Fe(CN)₆]⁴⁻, [Fe(CN)₆]³⁻, fluorenone, and/or disulfonated fluorenone can be used. In such aspects, the organic electroactive material can be used to provide a positive electrode and/or a negative electrode. In some aspects, these electroactive materials (and any of the other organic electroactive materials described herein) can be used in combination with one or more other types of inorganic electroactive materials described herein.

In yet other particular aspects, one or more types of electroactive monomers can be used to make dimers and/or polymers (including oligomers), thereby forming an electroactive dimer or polymer. In such aspects, a single type of monomer can be used to make a homodimer or a homopolymer, or a mixture of different types of monomers can be used to make a heterodimer or a heteropolymer. In some examples, the dimers and/or polymers comprise one or more of the electroactive monomers linked together via a sigma-type conjugation (e.g., wherein two monomers are bound together via a covalent bond formed between a single atom of each monomer). In yet other examples, the monomers can be bound together via a pi-type conjugation (wherein two monomers are bound together such that electrons can flow through the pi-bond system of the polymer).

In yet other particular aspects, one or more electroactive monomers can be linked to a backbone polymer (electroactive or non-electroactive backbone polymer), for example, through a crosslinking reaction. In some examples, the backbone polymer is selected from polyacrylic acid (PAA), polyvinyl alcohol (PVA), polyvinyl acetate, or any combination thereof. In some examples, the electroactive monomer linked to the backbone polymer can comprise a TEMPO ring system or ions thereof. In some examples, TEMPO is linked to PVA through a reaction with a crosslinking agent, such as glutaraldehyde.

In some examples, a TEMPO-containing dimer or polymer is used, which can comprise a structure according to the formula below, wherein X is a heteroatom, carboxyl, heteroaliphatic, or amide, Y is a heteroatom, n is an integer of 1 or more (e.g., 1 to 10,000), and p is 0 or 1.

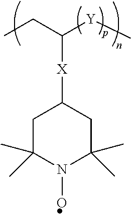

Exemplary dimers/polymers also are illustrated below.

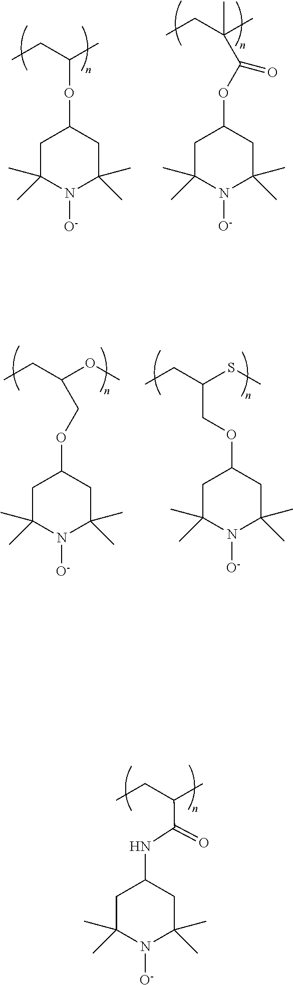

wherein n is 1 to 10,000.

In some further aspects, each redox couple of the electroactive material is present in the electrode at a concentration ranging from 1 M to 50 M, 1 M to 45 M, 1 M to 40 M, 1 M to 35 M, 1 M to 30 M, 1 M to 25 M, 1 M to 20 M, 1 M to 19 M, 1 M to 18 M, 1 M to 17 M, 1 M to 16 M, 1 M to 15 M, 2 M to 15 M, 3 M to 15 M, 1 M to 14 M, 2 M to 14 M, 3 M to 14 M, 1 M to 13 M, 2 M to 13 M, 3 M to 13 M, 1 M to 12 M, 2 M to 12 M, 3 M to 12 M, 1 M to 11 M, 2 M to 11 M, 3 M to 11 M, 1 M to 10 M, 2 M to 10 M, 3 M to 10 M, 1 M to 9 M, 2 M to 9 M, 3 M to 9 M, 1 M to 8 M, 2 M to 8 M, 3 M to 8 M, 1 M to 7 M, 2 M to 7 M, 3 M to 7 M, 1 M to 6 M, 2 M to 6 M, 3 M to 6 M, 1 M to 5 M, 2 M to 5 M, 3 M to 5 M, 1 M to 4 M, 2 M to 4 M, 3 M to 4 M, or 1 M to 3 M. In some aspects, the electroactive material is included as part of the negative electrode, or as part of both the positive and negative electrodes, but undergoes redox reactions at the negative electrode and in such instances can be present in the electrode at a concentration ranging from 1 M to 10 M, 2 M to 10 M, 3 M to 10 M, 1 M to 9 M, 2 M to 9 M, 3 M to 9 M, 1 M to 8 M, 2 M to 8 M, 3 M to 8 M, 1 M to 7 M, 2 M to 7 M, 3 M to 7 M, 1 M to 6 M, 2 M to 6 M, 3 M to 6 M, 1 M to 5 M, 2 M to 5 M, 3 M to 5 M, 1 M to 4 M, 2 M to 4 M, 3 M to 4 M. In some aspects, the electroactive material is included as part of the positive electrode, or as part of both the positive and negative electrodes, but undergoes redox reactions at the positive electrode and in such instances can be present in the electrode at a concentration ranging from 1 M to 15 M, 2 M to 15 M, 3 M to 15 M, 4 M to 15 M, 5 M to 15 M, 6 M to 15 M, 7 M to 15 M, 1 M to 14 M, 2 M to 14 M, 3 M to 14 M, 4 M to 14 M, 5 M to 14 M, 6 M to 14 M, 7 M to 14 M, 1 M to 13 M, 2 M to 13 M, 3 M to 13 M, 4 M to 13 M, 5 M to 13 M, 6 M to 13 M, 7 M to 13 M, 1 M to 12 M, 2 M to 12 M, 3 M to 12 M, 4 M to 12 M, 5 M to 12 M, 6 M to 12 M, 7 M to 12 M, 1 M to 11 M, 2 M to 11 M, 3 M to 11 M, 4 M to 11 M, 5 M to 11 M, 6 M to 11 M, 7 M to 11 M, 1 M to 10 M, 2 M to 10 M, 3 M to 10 M, 4 M to 10 M, 5 M to 10 M, 6 M to 10 M, 7 M to 10 M, 1 M to 9 M, 2 M to 9 M, 3 M to 9 M, 4 M to 9 M, 5 M to 9 M, 6 M to 9 M, 7 M to 9 M, 1 M to 8 M, 2 M to 8 M, 3 M to 8 M, 4 M to 8 M, 5 M to 8 M, 6 M to 8 M, 7 M to 8 M, 1 M to 7 M, 2 M to 7 M, 3 M to 7 M, 1 M to 6 M, 2 M to 6 M, 3 M to 6 M, 1 M to 5 M, 2 M to 5 M, 3 M to 5 M, 1 M to 4 M, 2 M to 4 M, or 3 M to 4 M.

In some aspects, the precursor compound used to provide the electroactive material can be present at a concentration ranging from 1 M to 50 M, 1 M to 45 M, 1 M to 40 M, 1 M to 35 M, 1 M to 30 M, 1 M to 25 M, 1 M to 20 M, 1 M to 19 M, 1 M to 18 M, 1 M to 17 M, 1 M to 16 M, 1 M to 15 M, 2 M to 15 M, 3 M to 15 M, 1 M to 14 M, 2 M to 14 M, 3 M to 14 M, 1 M to 13 M, 2 M to 13 M, 3 M to 13 M, 1 M to 12 M, 2 M to 12 M, 3 M to 12 M, 1 M to 11 M, 2 M to 11 M, 3 M to 11 M, 1 M to 10 M, 2 M to 10 M, 3 M to 10 M, 1 M to 9 M, 2 M to 9 M, 3 M to 9 M, 1 M to 8 M, 2 M to 8 M, 3 M to 8 M, 1 M to 7 M, 2 M to 7 M, 3 M to 7 M, 1 M to 6 M, 2 M to 6 M, 3 M to 6 M, 1 M to 5 M, 2 M to 5 M, 3 M to 5 M, 1 M to 4 M, 2 M to 4 M, 3 M to 4 M, or 1 M to 3 M.

In some further aspects, the electrolyte component of the gel electrode (the negative and/or the positive electrode) may further comprise an acid, such as HCl, H₂SO₄, or other sulfonic acids, such as methanesulfonic acid, p-toluenesulfonic acid, benzenesulfonic acid, and the like, to increase ionic conductivity of the gel electrode. In some aspects, the acid is present in the gel electrode at a concentration ranging from 0.1 M to 10 M, 0.2 to 10 M, 0.3 M to 10 M, 0.4 M to 10 M, 0.5 M to 10 M, 0.6 M to 10 M, 0.7 M to 10 M, 0.8 M to 10 M, 0.9 M to 10 M, 1 M to 10 M, 1.5 M to 10 M, 2 M to 10 M, 2.5 M to 10 M, 3 M to 10 M, 3.5 M to 10 M, 4 M to 10 M, 0.1 M to 9 M, 0.2 M to 9 M, 0.3 M to 9 M, 0.4 M to 9 M, 0.5 M to 9 M, 0.6 M to 9 M, 0.7 M to 9 M, 0.8 M to 9 M, 0.9 M to 9 M, 1 M to 9 M, 1.5 M to 9 M, 2 M to 9 M, 2.5 M to 9 M, 3 M to 9 M, 3.5 M to 9 M, 4 M to 9 M, 0.1 M to 8 M, 0.2 M to 8 M, 0.3 M to 8 M, 0.4 M to 8 M, 0.5 M to 8 M, 0.6 M to 8 M, 0.7 M to 8 M, 0.8 M to 8 M, 0.9 M to 8 M, 1M to 8 M, 1.5 M to 8 M, 2 M to 8 M, 2.5 M to 8 M, 3 M to 8 M, 3.5 M to 8 M, 4 M to 8 M, 0.1 M to 7 M, 0.2 M to 7 M, 0.3 M to 7 M, 0.4 M to 7 M, 0.5 M to 7 M, 0.6 M to 7 M, 0.7 M to 7 M, 0.8 M to 7 M, 0.9 M to 7 M, 1 M to 7 M, 1.5 M to 7 M, 2 M to 7 M, 2.5 M to 7 M, 3 M to 7 M, 3.5 M to 7 M, 4 M to 7 M, 0.1 M to 6 M, 0.2 M to 6 M, 0.3 M to 6 M, 0.4 M to 6 M, 0.5 M to 6 M, 0.6 M to 6 M, 0.7 M to 6 M, 0.8 M to 6 M, 0.9 M to 6 M, 1 M to 6 M, 1.5 M to 6 M, 2 M to 6 M, 2.5 M to 6 M, 3 M to 6 M, 3.5 M to 6 M, 4 M to 6 M, 0.1 M to 5 M, 0.2 M to 5 M, 0.3 M to 5 M, 0.4 M to 5 M, 0.5 M to 5 M, 0.6 M to 5 M, 0.7 M to 5 M, 0.8 M to 5 M, 0.9 M to 5 M, 1 M to 5 M, 1.5 M to 5 M, 2 M to 5 M, 2.5 M to 5 M, 3 M to 5 M, 3.5 M to 5 M, 4 M to 5 M, 0.1 M to 4.5 M, 0.2 M to 4.5 M, 0.3 M to 4.5 M, 0.4 M to 4.5 M, 0.5 M to 4.5 M, 0.6 M to 4.5 M, 0.7 M to 4.5 M, 0.8 M to 4.5 M, 0.9 M to 4.5 M, 1 M to 4.5 M, 1.5 M to 4.5 M, 2 M to 4.5 M, 2.5 M to 4.5 M, 3 M to 4.5 M, 3.5 M to 4.5 M, 4 M to 4.5 M, 0.1 M to 4 M, 0.2 M to 4 M, 0.3 M to 4 M, 0.4 M to 4 M, 0.5 M to 4 M, 0.6 M to 4 M, 0.7 M to 4 M, 0.8 M to 4 M, 0.9 M to 4 M, 1M to 4 M, 1.5 M to 4 M, 2 M to 4 M, 2.5 M to 4 M, 3M to 4 M, 3.5 M to 4 M, 0.1 M to 3.5 M, 0.2 M to 3.5 M, 0.3 M to 3.5 M, 0.4 M to 3.5 M, 0.5 M to 3.5 M, 0.6 M to 3.5 M, 0.7 M to 3.5 M, 0.8 M to 3.5 M, 0.9 M to 3.5 M, 1 M to 3.5 M, 1.5 M to 3.5 M, 2 M to 3.5 M, 2.5 M to 3.5 M, 3 M to 3.5 M, 0.1 M to 3 M, 0.2 M to 3 M, 0.3 M to 3 M, 0.4 M to 3 M, 0.5 M to 3 M, 0.6 M to 3 M, 0.7 M to 3 M, 0.8 M to 3 M, 0.9 M to 3 M, 1 M to 3 M, 1.5 M to 3 M, 2 M to 3 M, 2.5 M to 3 M, 0.1 M to 2.5 M, 0.2 M to 2.5 M, 0.3 M to 2.5 M, 0.4 M to 2.5 M, 0.5 M to 2.5 M, 0.6 M to 2.5 M, 0.7 M to 2.5 M, 0.8 M to 2.5 M, 0.9 M to 2.5 M, 1 M to 2.5 M, 1.5 M to 2.5 M, 2 M to 2.5 M, 0.1 M to 2 M, 0.2 M to 2 M, 0.3 M to 2 M, 0.4 M to 2 M, 0.5 M to 2 M, 0.6 M to 2 M, 0.7 M to 2 M, 0.8 M to 2 M, 0.9 M to 2 M, 1 M to 2 M, 1.5 M to 2 M, 0.1 M to 1.5 M, 0.2 M to 1.5 M, 0.3 M to 1.5 M, 0.4 M to 1.5 M, 0.5 M to 1.5 M, 0.6 M to 1.5 M, 0.7 M to 1.5 M, 0.8 M to 1.5 M, 0.9 M to 1.5 M, 1 M to 1.5 M, 0.1 M to 1 M, 0.2 M to 1 M, 0.3 M to 1 M, 0.4 M to 1 M, or 0.5 M to 1 M.

The conductive material component of the electrode according to aspects of the present disclosure provides electronic conductivity. The conductive material is dispersed in the gel formed by the polymer and solvent of the electrolyte component. In some aspects, the conductive material may be selected from metals; transition metal carbides or nitrides (e.g., MXene); or conductive carbon materials, such as amorphous carbon, carbon powder, carbon black, carbon fiber, carbon nanofiber (CNF), carbon nanotube (CNT), graphene, graphite, reduced graphene oxide, carbon products formed from decomposing organic precursors, or any combination thereof. In some particular aspects, the conductive material is a conductive carbon material. In some exemplary aspects, the conductive material is carbon powder. In an independent embodiment, the carbon material is not, or is other than, carbon felt. In some further aspects, the conductive material is present in the electrode at a concentration ranging from 10 g/L to 100 g/L, 15 g/L to 100 g/L, 20 g/L to 100 g/L, 25 g/L to 100 g/L, 30 g/L to 100 g/L, 35 g/L to 100 g/L, 40 g/L to 100 g/L, 10 g/L to 95 g/L, 15 g/L to 95 g/L, 20 g/L to 95 g/L, 25 g/L to 95 g/L, 30 g/L to 95 g/L, 35 g/L to 95 g/L, 40 g/L to 95 g/L, 10 g/L to 90 g/L, 15 g/L to 90 g/L, 20 g/L to 90 g/L, 25 g/L to 90 g/L, 30 g/L to 90 g/L, 35 g/L to 90 g/L, 40 g/L to 90 g/L, 10 g/L to 85 g/L, 15 g/L to 85 g/L, 20 g/L to 85 g/L, 25 g/L to 85 g/L, 30 g/L to 85 g/L, 35 g/L to 85 g/L, 40 g/L to 85 g/L, 10 g/L to 80 g/L, 15 g/L to 80 g/L, 20 g/L to 80 g/L, 25 g/L to 80 g/L, 30 g/L to 80 g/L, 35 g/L to 80 g/L, 40 g/L to 80 g/L, 10 g/L to 75 g/L, 15 g/L to 75 g/L, 20 g/L to 75 g/L, 25 g/L to 75 g/L, 30 g/L to 75 g/L, 35 g/L to 75 g/L, 40 g/L to 75 g/L, 10 g/L to 70 g/L, 15 g/L to 70 g/L, 20 g/L to 70 g/L, 25 g/L to 70 g/L, 30 g/L to 70 g/L, 35 g/L to 70 g/L, 40 g/L to 70 g/L, 10 g/L to 65 g/L, 15 g/L to 65 g/L, 20 g/L to 65 g/L, 25 g/L to 65 g/L, 30 g/L to 65 g/L, 35 g/L to 65 g/L, 40 g/L to 65 g/L, 10 g/L to 60 g/L, 15 g/L to 60 g/L, 20 g/L to 60 g/L, 25 g/L to 60 g/L, 30 g/L to 60 g/L, 35 g/L to 60 g/L, 40 g/L to 60 g/L, 10 g/L to 55 g/L, 15 g/L to 55 g/L, 20 g/L to 55 g/L, 25 g/L to 55 g/L, 30 g/L to 55 g/L, 35 g/L to 55 g/L, 40 g/L to 55 g/L, 10 g/L to 50 g/L, 15 g/L to 50 g/L, 20 g/L to 50 g/L, 25 g/L to 50 g/L, 30 g/L to 50 g/L, 35 g/L to 50 g/L, 40 g/L to 50 g/L, 10 g/L to 45 g/L, 15 g/L to 45 g/L, 20 g/L to 45 g/L, 25 g/L to 45 g/L, 30 g/L to 45 g/L, 35 g/L to 45 g/L, or 40 g/L to 45 g/L, 10 g/L to 40 g/L, 15 g/L to 40 g/L, 20 g/L to 40 g/L, 25 g/L to 40 g/L, 30 g/L to 40 g/L, 35 g/L to 40 g/L, 10 g/L to 35 g/L, 15 g/L to 35 g/L, 20 g/L to 35 g/L, 25 g/L to 35 g/L, 30 g/L to 35 g/L, 10 g/L to 30 g/L, 15 g/L to 30 g/L, 20 g/L to 30 g/L, or 25 g/L to 30 g/L.

The electrode according to aspects of the present disclosure may further comprise a metal substrate positioned on a surface of the electrode, depending on the electroactive material contained in the electrode. For example, in some aspects of the disclosure, a metal substrate capable of regenerating one or more of the redox pairs of the electroactive material can be used in combination with the gel electrode to supply additional ions into the gel. Solely by way of example, a zinc substrate can be used in combination with the gel electrode to provide an additional source of Zn ions that become dispersed in the electrode as electroactive species and participate in an electrochemical reaction. In some aspects, the metal substrate may be a metallic foil, such as a Zn foil.

The electrode according to aspects of the present disclosure may be used as a negative electrode, a positive electrode, or both. In some aspects, the electrode can be used in a symmetric cell wherein a first electrode and a second electrode are provided as the negative electrode and positive electrode components and wherein the first and second electrodes comprise the same conductive material and the same electrolyte component. In yet other aspects, the electrode may be used in an asymmetric cell, wherein (i) a first electrode comprises a first conductive material and a first electrolyte component and (ii) a second electrode comprises a second conductive material and a second electrolyte component. In some such aspects, the first electrolyte material and the second electrolyte material may be different. In yet other aspects of the disclosure, an asymmetric cell can comprise a gel electrode according to the present disclosure in combination with a second electrode that is not a gel electrode as disclosed herein.

The gel electrode according to aspects of the present disclosure can tolerate a higher amount of electroactive material than a traditional electrode without sacrificing cell performance. For example, a traditional vanadium flow battery can include only up to 1.5-2 M VOSO₄. As a result, the electrode according to aspects of the present disclosure has a high energy density, and is particularly suitable for LDES. In some aspects, the electrode according to aspects of the present disclosure can be 10-20 times thicker compared to a traditional electrode without sacrificing cell performance. Additionally, the structure of the electrode according to aspects of the present disclosure prevents the formation of metal dendrites (such as Zn dendrites), such that the cell made of the electrodes can maintain a stable performance during and even after several charge/discharge cycles (e.g., 75 cycles or more).

In some aspects, the electrode comprises carbon powder as the conductive material; and an electrolyte comprising (i) a polymer selected from xanthan gum (XG) or polyvinyl alcohol (PVA); (ii) an electroactive material comprising Zn, Zn²⁺, I₃⁻, I⁻, or any combination thereof; and (iii) water; wherein the polymer and the water form a gel, and wherein the carbon powder and electroactive material are dispersed in the gel. In some aspects, such an electrode can be incorporated into a cell with symmetric electrode design according to aspects of the present disclosure and can function as a negative electrode or a positive electrode.

In some other aspects, the electrode comprises carbon powder as the conductive material; and an electrolyte comprising (i) a polymer selected from xanthan gum (XG) or polyvinyl alcohol (PVA); (ii) an electroactive material comprising Zn and/or Zn²⁺; Cr²⁺ and/or Cr³⁺; V²⁺ and/or V³⁺; S₄²⁻ and/or S₂²⁻; H⁺ and/or H₂; or Ti³⁺ and/or TiO²⁺; and (iii) water; wherein the polymer and the water form a gel, and wherein the carbon powder and electroactive material are dispersed in the gel. In some such aspects, the electrode can be incorporated into a cell according to aspects of the present disclosure and can function as a negative electrode.

In some aspects, the electrode comprises carbon powder as the conductive material; and an electrolyte comprising (i) a polymer selected from xanthan gum (XG) or polyvinyl alcohol (PVA); (ii) an electroactive material comprising I³⁻ and/or I⁻; Fe²⁺ and/or Fe³⁺; V⁴⁺ and/or V⁵⁺; Br₂ and/or Br⁻; Mn²⁺ and/or MnO₂; or Mn²⁺ and/or Mn³⁺; and (iii) water; wherein the polymer and the water form a gel, and wherein the carbon powder and electroactive material are dispersed in the gel. In some such aspects, electrode can be incorporated into a cell according to aspects of the present disclosure and can function as a positive electrode.

In some aspects, the electrode comprises carbon powder as the conductive material; and an electrolyte comprising (i) a polymer selected from xanthan gum (XG) or polyvinyl alcohol (PVA); (ii) an organic electroactive material comprising a heteroaryl ring system (e.g., a 5- or 6-membered heteroaryl ring comprising one or more heteroatoms, such as nitrogen); an aryl ring system (e.g., a 5- or 6-membered aryl ring system, such as a cyclopentadienyl ring or a phenyl ring, such as for metallocene monomers, catechol monomers, and/or resorcinol monomers); a heterocyclic ring system (e.g., a phenazine ring system or an N-functionalized version thereof; an alloxazine ring system; a naphthalene diimide ring system; a TEMPO ring system; a phenothiazine ring system, or an N-functionalized version thereof; a phenoxazine ring system, or an N-functionalized version thereof; and the like); a carbocyclic ring system (e.g., an anthraquinone ring system, a fluorenone ring system, a quinone ring system; or the like); an organometallic compound; and/or any ions thereof; and (iii) water; wherein the polymer and the water form a gel, and wherein the carbon powder and electroactive material are dispersed in the gel. In some such aspects, electrode can be incorporated into a cell according to aspects of the present disclosure and can function as a positive electrode.

### Cells and Batteries

Cells according to aspects of the present disclosure comprise a first electrode, a second electrode, and a separator disposed between a first surface of the first electrode and a first surface of the second electrode. In some aspects, the first electrode and second electrode are each a gel electrode according to aspects of the present disclosure.

In some aspects, the cells have a symmetric design, wherein both electrodes of the cell (e.g., positive electrode and negative electrode) comprise the same gel electrode components as described by aspects of the present disclosure. In some aspects, one gel electrode of a symmetric design (e.g., a negative or positive electrode) may further comprise a metal substrate placed on a second surface of the electrode.

In some aspects, the cells have an asymmetric design, wherein each electrode of the cell (e.g., positive electrode and negative electrode) each comprises different gel electrode components. In some such aspects, the electrodes are different in terms of electroactive materials but are the same in terms of other components. In some aspects, one gel electrode of an asymmetric design (e.g., a negative or positive electrode) may further comprise a metal substrate placed on a second surface of the electrode. Any of the electroactive materials described herein can be used, including any of the inorganic and/or organic electroactive materials.

In some aspects, the cell comprises a first electrode; a second electrode; and a separator disposed between a first surface of the first electrode and a first surface of the second electrode; wherein the first electrode and the second electrode independently comprise a carbon conductive material (e.g., carbon powder) and an electrolyte comprising (i) a polymer selected from a natural polysaccharide (e.g., xanthan gum (XG)) or a synthetic polymer (e.g., polyvinyl alcohol (PVA)); (ii) an electroactive material selected from an inorganic electroactive material as described herein (and/or any ions thereof), an organic electroactive material as described herein (and/or any ions thereof), or a combination thereof; and (iii) an aqueous solvent (e.g., water).

In some aspects, the cell comprises a first electrode; a second electrode; and a separator disposed between a first surface of the first electrode and a first surface of the second electrode; wherein the first electrode and the second electrode independently comprise a carbon conductive material (e.g., carbon powder) and an electrolyte comprising (i) a polymer selected from a natural polysaccharide (e.g., xanthan gum (XG)) or a synthetic polymer (e.g., polyvinyl alcohol (PVA)); (ii) an electroactive material selected from Zn, Zn²⁺, I³⁻, I⁻, or any combination thereof; and (iii) an aqueous solvent (e.g., water). In such aspects of the disclosure, the polymer and the water form a gel, and the carbon conductive material and the electroactive material (e.g., Zn, Zn²⁺, I³⁻, I⁻, or the combination thereof) are dispersed in the gel. In some aspects, the first electrode and the second electrode are the same (that is, they contain the same conductive material, electroactive material, solvent, and polymer). In some aspects, the first electrode and the second electrode are the same except that the first electrode (or the negative electrode) further comprises a Zn foil placed on a second surface of the first electrode.

In some aspects, the cell comprises a first electrode; a second electrode; and a separator disposed between a first surface of the first electrode and a first surface of the second electrode; wherein the first electrode and the second electrode independently comprise a carbon conductive material (e.g., carbon powder) and an electrolyte comprising (i) a polymer selected from a natural polysaccharide (e.g., xanthan gum (XG)), or a synthetic polymer (e.g., polyvinyl alcohol (PVA)); (ii) an electroactive material selected from an organic electroactive material (e.g., a phenazine or N-functionalized version thereof; an anthroquinone; an alloxazine; a viologen; a diazobenzene; a fluorenone; an organometallic compound; a naphthalene diimide; TEMPO, a metallocene, a phenoxazine or an N-functionalized version thereof; a phenothiazine or an N-functionalized version thereof; a catechol; a resorcinol; a quinone; or a combination thereof); or an inorganic electroactive material (e.g., Zn, Zn²⁺, I³⁻, I⁻, S₄²⁻, S₂²⁻, Fe²⁺, Fe³⁺, Cr²⁺, Cr³⁺, V²⁺, V³⁺, V⁴⁺, V⁵⁺, Br₂, Br⁻, Mn²⁺, Mn⁴⁺, Ti³⁺, Ti⁴⁺, Mn²⁺, Mn³⁺, or any combinations thereof); and (iii) an aqueous solvent (e.g., water). In such aspects of the disclosure, the polymer and the water form a gel, and the carbon conductive material and the electroactive material are dispersed in the gel. In some aspects, the electroactive material of the first electrode comprises Zn and/or Zn²⁺, and the electroactive material of the second electrode comprises I³⁻ and/or I⁻. In some aspects, the electroactive material of the first electrode comprises S₄²⁻ and/or S₂²⁻, and the electroactive material of the second electrode comprises Fe²⁺ and/or Fe³⁺. In some aspects, the electroactive material of the first electrode comprises S₄²⁻ and/or S₂²⁻, and the electroactive material of the second electrode comprises I³⁻ and/or I⁻. In some aspects, the electroactive material of the first electrode comprises Cr²⁺ and/or Cr³⁺, and the electroactive material of the second electrode comprises Fe²⁺ and/or Fe³⁺. In some aspects, the electroactive material of the first electrode comprises Cr²⁺ and/or Cr³⁺, and the electroactive material of the second electrode comprises Mn²⁺, Mn³⁺, and/or Mn⁴⁺. In some aspects, the electroactive material of the first electrode comprises V²⁺ and/or V³⁺, and the electroactive material of the second electrode comprises V⁴⁺ and/or V⁵⁺. In some aspects, the electroactive material of the first electrode comprises H⁺ and/or H₂, and the electroactive material of the second electrode comprises Mn²⁺, Mn³⁺, and/or Mn⁴⁺. In some aspects, the electroactive material of the first electrode comprises H⁺ and/or H₂, and the electroactive material of the second electrode comprises Fe²⁺ and/or Fe³⁺. In some aspects, the electroactive material of the first electrode comprises Ti³⁺ and/or Ti⁴⁺ (TiO²⁺), and the electroactive material of the second electrode comprises Mn²⁺, Mn³⁺, and/or Mn⁴⁺. In some aspects, the electroactive material of the first electrode comprises Zn and/or Zn²⁺, and the electroactive material of the second electrode comprises TEMPO and/or ions thereof. In some aspects, the electroactive material of the first electrode comprises Zn and/or Zn²⁺, and the electroactive material of the second electrode comprises ferrocene. In some aspects, the electroactive material of the first electrode comprises fluorenone (or disulfonated fluorenone) and/or ions thereof, and the electroactive material of the second electrode comprises [Fe(CN)₆]⁴⁻ and/or [Fe(CN)₆]³⁻. In some aspects, the electroactive material of the first electrode comprises Zn and/or Zn²⁺, and the electroactive material of the second electrode comprises PVA linked TEMPO. In some aspects, the one (or both) of the first or second electrodes further comprises a metal substrate placed on a second surface of the first electrode (and/or) the second electrode. In some aspects, the first electrode is the negative electrode, and the second electrode is the positive electrode. In some aspects, the first electrode (or the negative electrode) further comprises a Zn foil placed on a second surface of the first electrode.

In some aspects, the cell exhibits an energy efficiency greater than 80%, such as greater than 81%, 82%, 83%, or 85%; and/or a coulombic efficiency greater than 95%, such as greater than 96%, 97%, 98%, 99%, 99.1%, 99.2%, 99.3%, 99.4%, or 99.5%. In some aspects, the cell exhibits an energy efficiency greater than 81% and/or a coulombic efficiency greater than 99%. In some aspects, the cell does not exhibit a change in energy and/or coulombic efficiency greater than 5% after 20 or more cycles of charging and/or discharging.

Batteries according to aspects of the present disclosure comprise one or more cells according to aspects of the present disclosure. In some aspects, a battery according to the disclosure can comprise a plurality of cells comprising at least one gel electrode as described herein. In some aspects, at least two of the cells in a battery according to the disclosure are the same. In some aspects, a battery according to the disclosure can include a combination of one or more gel containing-electrode cells according to the present disclosure and one or more cells known in the art that are not gel electrode-containing cells.

### Methods

Methods of making a gel electrode according to aspects of the present disclosure are also described herein. In some aspects, the method comprises mixing a conductive material, a polymer, an electroactive material, and a solvent according to aspects of the present disclosure to form the gel electrode, wherein the conductive material and the electroactive material are dispersed in the gel electrode. In some aspects, an acid, such as, HCl or H₂SO₄, may be added and mixed with these components to increase ionic conductivity of the gel electrode. In some aspects, the electroactive material is provided as precursor compound as discussed herein. In some aspects, these components can be combined in any order. In some other aspects, these components are combined in the following order: adding the electroactive material (or the precursor compound) and optionally, the acid, to the solvent to form a solution first; adding in the polymer and mixing; and adding in the conductive material and mixing to form the gel electrode.

In some aspects, when making the gel electrode, the concentration of each component is calculated based on the final volume of the gel electrode taking into account the volume swollen due to addition of the polymer. Amounts of each component can be selected from amounts described herein. In some aspects of the disclosure, two different precursor compounds can be combined to provide the electroactive material, such as one precursor compound that provides one redox couple and a second precursor compound that provides anther redox couple. In such embodiments, a first precursor compound can be selected to provide the electroactive species of the negative electrode and the second precursor compound can be selected to provide the electroactive species of the positive electrode. The ratio of the first precursor compound to the second precursor compound can range from 1:1 to 1:4, such as 1:1, 1:2, 1:3, or 1:4.

Methods of using the cells or batteries according to aspects of the present disclosure comprise charging and/or discharging the cells or batteries. In some aspects, the cell exhibits an energy efficiency greater than 80%, such as greater than 81%, 82%, 83%, or 85%; and/or a coulombic efficiency greater than 95%, such as greater than 96%, 97%, 98%, 99%, 99.1%, 99.2%, 99.3%, 99.4%, or 99.5%. In some aspects, the cell exhibits an energy efficiency greater than 81% and/or a coulombic efficiency greater than 99%. In some aspects, the cell does not exhibit a change in energy and/or coulombic efficiency greater than 5% after 20 or more cycles of charging and/or discharging.

### Overview of Several Aspects

Disclosed herein is a gel electrode, comprising: a conductive material; and an electrolyte comprising a polymer, an electroactive material, and a solvent; wherein the polymer and the solvent form a gel, and wherein the conductive material and the electroactive material are dispersed in the gel.

In any or all of the above aspects, the polymer comprises a hydrophilic side chain.

In any or all of the above aspects, the hydrophilic side chain comprises an amino group, a hydroxyl group, an amide group, a sulfonic acid, a sulfonate group, an organosulfate group, a carboxylic acid, a carboxylate group, a phosphoric acid, a phosphate group, a phosphorous acid, a phosphonate group, —SO₃Z, —CO₂Z, —(CH₂)ₘPO₃Z₂, X, —NR′₃⁺, —NO₂, —SO₂R′, —CN, —CX₃, —COX, —C(H)O, —C(O)R′, —C(O)NH₂, —C(O)NHR′, —C(O)NR′₂, —N═O, —OR′, —(CH₂CH₂O)ₚR′, or any combination thereof, wherein each R′ independently is H, aliphatic, or heteroaliphatic; X is halo; each Z independently is a counterion with a +1 charge; m is an integer from 0 to 10; and p is an integer from 1 to 10.

In any or all of the above aspects, the polymer is a polysaccharide.

In any or all of the above aspects, the polymer is xanthan gum (XG), chitosan, gelatin, iota-carrageenan (IC), cellulose, carboxyl methyl cellulose, polyacrylic acid (PAA), polyvinyl alcohol (PVA), or polyvinyl acetate.

In any or all of the above aspects, the conductive material is a conductive carbon material.

In any or all of the above aspects, the conductive material is carbon powder, a carbon nanotube, a carbon fiber, or any combination thereof.

In any or all of the above aspects, the solvent is water, an organic solvent, or a mixture thereof.

In any or all of the above aspects, the electroactive material is an organic electroactive material, an inorganic electroactive material, or a combination thereof.

In any or all of the above aspects, the electroactive material is an inorganic electroactive material comprising Zn, Zn²⁺, I₃⁻, I⁻, or any combination thereof.

In any or all of the above aspects, the electroactive material is an inorganic electroactive material comprising Zn²⁺, I⁻, or a combination thereof.

In any or all of the above aspects, the electroactive material is an inorganic electroactive material comprising: Zn and/or Zn²⁺; Cr²⁺ and/or Cr³⁺; V²⁺ and/or V³⁺; S₄²⁻ and/or S₂²⁻; H⁺ and/or H₂; or Ti³⁺ and/or Ti⁴⁺.

In any or all of the above aspects, the electroactive material is an inorganic electroactive material comprising Zn²⁺ Cr³⁺, V³⁺, S₄²⁻, H⁺, or Ti⁴⁺.

In any or all of the above aspects, the electroactive material is an inorganic electroactive material comprising: I₃⁻ and/or I⁻; Fe²⁺ and/or Fe³⁺; V⁴⁺ and/or V⁵⁺; Br₂ and/or Br−; Mn²⁺ and/or Mn⁴⁺; or Mn²⁺ and/or Mn³⁺.

In any or all of the above aspects, the electroactive material is an inorganic electroactive material comprising I⁻, Fe²⁺, V⁴⁺, Br, or Mn²⁺.

In any or all of the above aspects, the electroactive material is an organic electroactive material comprising (i) an electroactive monomer, (ii) an electroactive dimer comprising two electroactive monomers that are bound together, (iii) an electroactive polymer comprising three or more electroactive monomers that are bound together, (iv) an electroactive polymer comprising a backbone polymer linked with one or more electroactive monomers, or (v) any combination of two or more of (i), (ii), (iii), or (iv).

In any or all of the above aspects, the electroactive monomer comprises: a phenazine ring system and/or ions and/or N-functionalized versions thereof; an anthraquinone ring system and/or ions thereof; an alloxazine ring system and/or ions thereof; a viologen ring system and/or ions thereof; a diazobenzene ring system and/or ions thereof; a fluorenone ring system and/or ions thereof; a naphthalene diimide ring system and/or ions thereof; a TEMPO ring system and/or ions thereof; a quinone ring system and/or ions thereof; a phenothiazine ring system and/or ions and/or N-functionalized versions thereof; a phenoxazine ring system and/or ions and/or N-functionalized versions thereof; a catechol ring system and/or ions thereof; a resorcinol ring system and/or ions thereof; or an organometallic compound, and/or ions thereof.

In any or all of the above aspects, the electroactive monomer comprises a structure selected from one or more of the following:

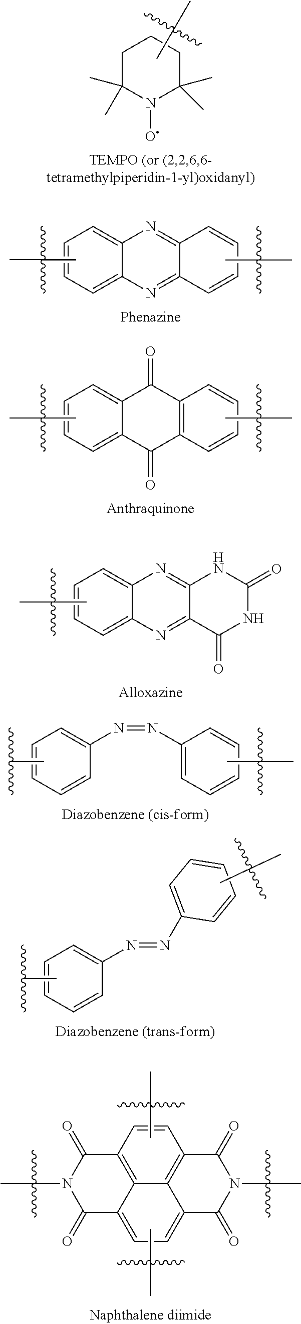

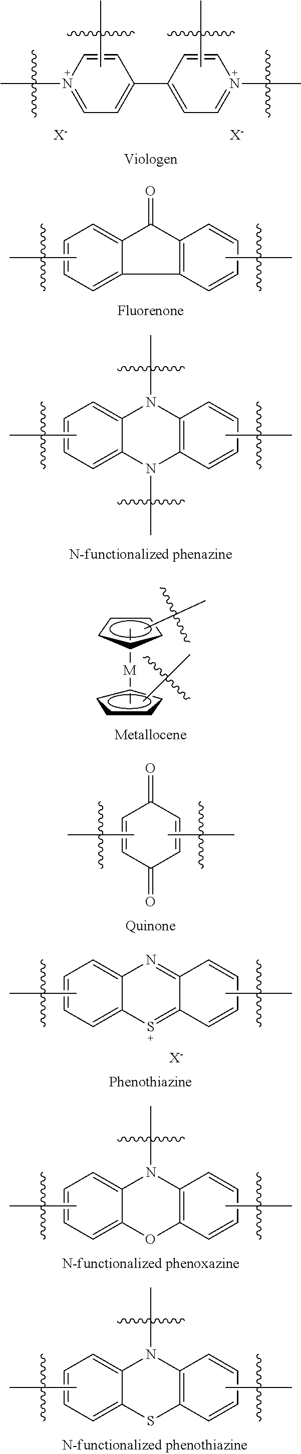

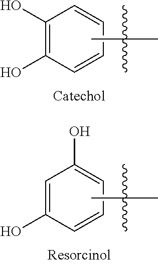

In any or all of the above aspects, metal in the organometallic compound is Fe, Co, Mn, Ti, Cr, or Cu.

In any or all of the above aspects, the organometallic compound comprises [Fe(CN)₆]⁴⁻ and/or [Fe(CN)₆]³⁻.

In any or all of the above aspects, the backbone polymer comprises polyacrylic acid (PAA), polyvinyl alcohol (PVA), polyvinyl acetate, or any combination thereof.

In any or all of the above aspects, the electroactive polymer in (iv) is polyvinyl alcohol (PVA) linked with one or more electroactive monomers comprising a TEMPO ring system and/or ions thereof.

In any or all of the above aspects, the electrode further comprises a metal substrate positioned on a surface of the electrode.

In exemplary aspects, the electrode comprises: carbon powder; and an electrolyte comprising (i) a polymer selected from xanthan gum (XG) or polyvinyl alcohol (PVA); (ii) an electroactive material comprising Zn, Zn²⁺, I₃⁻, I⁻, or any combination thereof; and (iii) water; wherein the polymer and the water form a gel, and wherein the carbon powder and electroactive material are dispersed in the gel.

In exemplary aspects, the electrode comprises: carbon powder; and an electrolyte comprising (i) a polymer selected from xanthan gum (XG) or polyvinyl alcohol (PVA); (ii) an electroactive material comprising Zn and/or Zn²⁺, or comprising disulfonated fluorenone and/or ions thereof; and (iii) water; wherein the polymer and the water form a gel, and wherein the carbon powder and electroactive material are dispersed in the gel.

In exemplary aspects, the electrode comprises: carbon powder; and an electrolyte comprising (i) a polymer selected from xanthan gum (XG) or polyvinyl alcohol (PVA); (ii) an electroactive material comprising a TEMPO ring system and/or ions thereof; ferrocene and/or ions thereof; and/or [Fe(CN)₆]⁴⁻ and/or [Fe(CN)₆]³⁻; and (iii) water; wherein the polymer and the water form a gel, and wherein the carbon powder and electroactive material are dispersed in the gel.

Also disclosed herein is a cell, comprising: a first electrode; a second electrode; and a separator disposed between a first surface of the first electrode and a first surface of the second electrode; wherein the first electrode comprises a structure according to the electrode of any or all of the above aspects; the second electrode comprises a structure according to the electrode of any or all of the above aspects; and the electroactive material in the first electrode is capable of receiving electrons from the electroactive material in the second electrode when charged, and donating electrons to the electroactive material in the second electrode when discharged.

In any or all of the above aspects, the electroactive material in the first electrode comprises Zn and/or Zn²⁺; Cr²⁺ and/or Cr³⁺; V²⁺ and/or V³⁺; S₄²⁻ and/or S₂²⁻; H⁺ and/or H₂; Ti³⁺ and/or Ti⁴⁺; fluorenone and/or ions thereof; or disulfonated fluorenone and/or ions thereof.

In any or all of the above aspects, the electroactive material in the second electrode comprises I₃⁻ and/or I⁻; Fe²⁺ and/or Fe³⁺; V⁴⁺ and/or V⁵⁺; Br₂ and/or Br⁻; Mn²⁺ and/or Mn⁴⁺; Mn²⁺ and/or Mn³⁺; TEMPO and/or ions thereof; PVA linked TEMPO and/or ions thereof; [Fe(CN)₆]⁴⁻ and/or [Fe(CN)₆]³⁻; or ferrocene.

In any or all of the above aspects, the first electrode and the second electrode are the same, and each comprises a structure according to the electrode of any or all of the above aspects.

In any or all of the above aspects, both the electroactive material in the first electrode and the electroactive material in the second electrode comprise Zn and/or Zn²⁺; and I³⁻ and/or I⁻.

In any or all of the above aspects, a metal substrate is positioned on a second surface of the first electrode or the second electrode.

In any or all of the above aspects, the cell comprises: a first electrode; a second electrode; and a separator disposed between a first surface of the first electrode and a first surface of the second electrode; wherein the first electrode and the second electrode independently comprise carbon powder and an electrolyte comprising (i) a polymer selected from xanthan gum (XG) or polyvinyl alcohol (PVA); (ii) Zn, Zn²⁺, I₃⁻, I⁻, or any combination thereof; and (iii) water; wherein the polymer and the water form a gel, and wherein the carbon powder and the Zn, Zn²⁺, I₃⁻, I⁻, or the combination thereof are dispersed in the gel.

In any or all of the above aspects, the first electrode and the second electrode are the same.

In any or all of the above aspects, a Zn foil is placed on a second surface of the first electrode or second electrode.

In exemplary aspects, the cell comprises: a first electrode; a second electrode; and a separator disposed between a first surface of the first electrode and a first surface of the second electrode; wherein the first electrode and the second electrode independently comprise carbon powder and an electrolyte comprising (i) a polymer selected from xanthan gum (XG) or polyvinyl alcohol (PVA); (ii) an electroactive material; and (iii) water; wherein the polymer and the water form a gel, and wherein the carbon powder and the electroactive material are dispersed in the gel; wherein the electroactive material in the first electrode comprises Zn and/or Zn²⁺, and the electroactive material in the second electrode comprises (i) a TEMPO ring system and/or ions thereof, or (ii) ferrocene and/or ions thereof.

In exemplary aspects, the cell comprises: a first electrode; a second electrode; and a separator disposed between a first surface of the first electrode and a first surface of the second electrode; wherein the first electrode and the second electrode independently comprise carbon powder and an electrolyte comprising (i) a polymer selected from xanthan gum (XG) or polyvinyl alcohol (PVA); (ii) an electroactive material; and (iii) water; wherein the polymer and the water form a gel, and wherein the carbon powder and the electroactive material are dispersed in the gel; wherein the electroactive material in the first electrode comprises fluorenone and/or ions thereof; and the electroactive material in the second electrode comprises [Fe(CN)₆]⁴⁻ and/or [Fe(CN)₆]³⁻.

Also disclosed herein is a method of making a gel electrode, comprising mixing (i) a conductive material, (ii) a polymer, or a monomer capable of polymerizing to form the polymer; (ii) an electroactive material, and (iv) a solvent to form the gel electrode, wherein the conductive material and the electroactive material are dispersed in the gel electrode.

In any or all of the above aspects, the method comprises charging and/or discharging the cell.

In any or all of the above aspects, the cell exhibits an energy efficiency greater than 80% and/or a coulombic efficiency greater than 95%.

In any or all of the above aspects, the cell exhibits an energy efficiency greater than 81% and/or a coulombic efficiency greater than 99%.

In any or all of the above aspects, the cell does not exhibit a change in energy and/or coulombic efficiency greater than 5% after 20 or more cycles of charging and/or discharging.

Also disclosed herein is a battery, comprising two or more cells, wherein at least one of the two or more cells is a cell according to any or all of the above aspects.

In any or all of the above aspects, each of the two or more cells are the same.

In any or all of the above aspects, the separator is a membrane separator, or a polymeric composite separator.

In any or all of the above aspects, the membrane separator is an anion-selective membrane or a cation-selective membrane; or the polymeric composite is PVC/silica, PE/silica, PTFE/silica, or a combination thereof.

### EXAMPLES

Electrochemical and Battery Testing: The electron/ion transportation in Zn—I gel electrodes with various carbon black concentrations was investigated using electrochemical impedance spectroscopy (EIS). The galvanostatic charge/discharge tests were carried out in the voltage range of 0.45-1.55 V on an Arbin battery tester.

### Molecular Dynamic Simulation Methods

AIMD simulation Ab initio molecular dynamics (AIMD) simulations were carried out by Vienna Ab initio Simulation Package (VASP). Electron-ion interactions were described by the projector-augmented wave (PAW) pseudopotentials with the cutoff energy of 400 eV. The exchange-correlation functional was represented using the Perdew-Burke-Ernzerhof generalized gradient approximation (GGA-PBE). The exchange-correlation functional with a Gaussian smearing width term of 0.05 eV was used. The convergence criterion for electronic self-consistent iteration was set to 1×10⁻⁵ eV. Long-range dispersion interaction was corrected by DFT-D3 method. The solvation structure of ZnCl₂+KI electrolyte was investigated using AIMD simulation in the canonical ensemble at 298 K. There are 15 ZnCl₂, 30 KI and 100 water molecules in the system. The density was set to experimental density. The constant temperature of the AIMD simulation systems was controlled using the Nose thermostat method with a Nose-mass parameter of 0.1. A time step of 0.5 fs was used in AIMD simulation. The gamma point sampling was used for the Brillouin zone. The ions and molecules were randomly inserted into the simulation box at initial state.

CMD simulation: As AIMD simulation is expensive, classical molecular dynamics (CMD) simulations were performed to investigate the solvation structures and interactions in electrolytes with polymer. The CMD simulation was performed for 5 ns with Chemistry at Harvard Macromolecular Mechanics (CHARMM) force field. The system was pre-equilibrated for 5 ps and the production simulation time was 10 ps. The snapshots were generated by visual molecular dynamics (VMD) software. Two systems, i.e., ZnCl₂+KI solution, and ZnCl₂+KI+XG polymer solution, were studied. The interaction parameters of salt (Zn, Cl and K ions), solvent (water) and XG polymer were obtained from CHARMM force field. The parameter of iodine ion was obtained from Orabi's work. Due to the computational cost, the number of repeat units was set to five for XG polymer in the simulation. As some of the functional groups on the side chain of XG polymer are uncertain, only one carboxyl group was included on the side chain of the XG polymer model. According to the pH value in experiment, the carboxyl group was deprotonated, and additional K ions were added to keep the system neutral. The transferable intermolecular potential 3P (TIP3P) water model was employed for water molecule.

All the CMD simulations were carried out with the GROningen MAchine for Chemical Simulations (GROMACS) simulation package. For the system with XG polymer, the polymer chains were separated in the simulation box. Then the solvent molecules and ions were randomly inserted into the simulation box according to the molar ratio in an experiment. The steepest descent method was used to minimize the energy of the systems. The systems were pre-equilibrated in isothermal-isobaric (NPT) ensemble with 200 ns at 298K and 1 bar. The temperature and pressure were controlled by V-rescale thermostat and Berendsen barostat with a time constant of 0.2 and 1 ps. Then 400 ns (for no polymer system) and 1000 ns (for polymer system) production simulations were performed at 298K in canonical (NVT) ensemble. The temperature is controlled by the Nose-Hoover themostat with a time constant of 0.6 and 6 ps. The cutoff of the Lennard-Jones potential is 1.2 nm. The particle mesh Ewald method with a Fourier spacing of 0.15 nm and a 1.2 nm real-space cutoff was used for calculating electrostatic interactions. Periodic boundary conditions were used in all three directions. The time step was 2 fs. The bonds between H and other atoms were constrained by the LINCS algorithm.

### Microscopy and Spectroscopy Methods

Transition electron microscopy (TEM) imaging for the samples with different state of charge (SoC) was conducted on FEI Titan at 300 kV. ⁶⁷Zn, 170 and ¹H NMR spectra were recorded with single-pulse measurements at room temperature using 5 mm NMR tubes with a Varian liquid probe. A 3.75 M ZnCl₂ aqueous solution, and a saturated KI aqueous solution are used as references (δᵢₛₒ=0 p.p.m.) to effectively monitor the chemical shift evolution with the charge/discharge process. Raman spectra were recorded with a Horiba LabRam HR Evolution spectrometer coupled with an inverted optical microscope (Nikon Ti-E) with a 40× objective and a 632.8-nm HeNe laser light source. A quartz cell was used for the Raman measurements.

### Example 1

In this example, different Zn—I gel electrodes were prepared with various compositions as exemplified in Table 1. The electrodes can be used as an positive electrode and/or a negative electrode. In one example, 5.11 g of zinc chloride (ZnCl₂), and 12.45 g of potassium iodide (KI) were added to 5 ml of water. 0.4 g of xanthan gum (XG) was added to the aqueous electrolyte to increase viscosity to hold components. Carbon black was added last, and the mixture was stirred overnight to obtain a homogenous gel electrode. The final volume of the gel electrode was around 10 mL by swelling of polymer binders, and the final concentration of ions was 3.75 M for ZnCl₂ and 7.5 M for KI.

Dependent on the desired redox reaction chemistry, ZnCl₂ can be replaced with other cation sources, for example, ZnSO₄ for Zn—MnO₂ batteries, or FeCl₂ for Fe—I₂ batteries application, as is described herein. XG can be replaced with other hydrophilic polymers disclosed herein. Carbon black can be replaced with other conductive material, e.g., other conductive carbon materials described herein.

TABLE 1

| | | | | Conductive | |
|---|---|---|---|---|---|
| | | | | Material | |
| | Ion Source | | Polymer | Carbon | Electrolyte |
| Sample # | ZnCl₂ (M) | KI (M) | XG (g) | black (g) | Water (mL) |
| CB 0.1 | 3.75 | 7.5 | 0.4 | 0.1 | 5 |
| CB 0.2 | 3.75 | 7.5 | 0.4 | 0.2 | 5 |
| CB 0.3 | 3.75 | 7.5 | 0.4 | 0.3 | 5 |
| CB 0.4 | 3.75 | 7.5 | 0.4 | 0.4 | 5 |

### Example 2

In this example, cells comprising the electrodes described in Example 1 were prepared. Evaluation of the cell was performed with lab-made prototypes of closed cells. A rubber gasket with 1 mm thickness and 5 cm² inner circular space was placed on a 1 mm thick zinc foil that was laid on top of a flat graphite plane. Gaskets can be stacked, or their thickness varied, to conform with the thickness of a desired gel electrode. The well formed by the gasket was filled with the gel electrode mixture prepared above. The well with the gel electrode was then covered with Nafion® ion-selective membrane (N211) or other types of battery separator. Another gasket was placed on the separator with fine alignments. The second well was filled with the gel electrode mixture, and closed with a flat graphite block (a positive electrode side current collector). The sandwiched graphite block cell was fully enclosed without any leakage using mechanical pressurization. For screening of a gel electrode composition, the same configuration can be used with gaskets having smaller inner circular space (˜0.71 cm²) and a tiny amount of gel electrode mixture.

### Example 3

This example describes the electrochemistry of redox couples and identifies the problem with traditional redox flow batteries (RFBs). The Zn or iodine redox couple has been extensively studied as a rechargeable battery for grid energy storage. During the charge process, the iodide in the electrolyte was first charged to solid 12 (Equation 1) and then simultaneously formed the complex with the remaining iodide in the electrolyte to form soluble triiodide anions (Equation 2). Therefore, the formation of polyiodide ions (Equation 2) can significantly increases the I₂ solubility with the presence of iodide.

$$2 {I}^{-} - 2 {e}^{-} \to {I}_{2} \qquad ( 1 )$$

$${I}^{-} + {I}_{2} ↔ {I}_{3}^{-} K \approx 720 \pm 10 ( 298 K ) \qquad ( 2 )$$

Among all the polyiodides, due to the low stability of other higher order polyiodides, triiodide anions are currently believed to be the predominant species in aqueous system. Therefore, the ultimate electrode reaction in the liquid based secondary RFBs is believed to be iodide/triiodide anions redox reaction at the positive electrode side, as shown in Equation (3).

$$\begin{matrix}3 {I}^{-} - 2 {e}^{-} ↔ {I}_{3}^{-} & {E}^{0} = 0.536 V vs SHE\end{matrix} \qquad ( 3 )$$

However, when the presence of iodide depleted after further charge process, the triiodide anions might be charged to unstable higher order polyiodides that will ultimately decompose to solid I₂ precipitate, according to Equation (4).

$$2 {I}_{3}^{-} - 2 {e}^{-} \to {I}_{2} \qquad ( 4 )$$

Therefore, the application of the I⁻/I₂ redox reaction in liquid based secondary RFBs is carefully controlled to not exceed its capacity limit (˜ 67% of theoretical capacity) because the extreme low solubility of I₂ can produce solid precipitate that will damage the flow system. To fully utilize the capacity of I⁻/I₂ redox reaction, Zn/I₂ static cell is another recharge battery developed in which I⁻ or I₂ species are absorbed on the surface of porous carbon or bonded with functional groups of a polymer to confine the I⁻/I₂ redox reaction and prevent the shuttling of polyiodides intermediate (mainly triiodide anions). Therefore, the volumetric energy density of Zn/I₂ is strongly dependent on the absorbed capacity of porous carbon. However, even KB carbon with high surface area of >1000 cm² g⁻¹ only has a limited polyiodide capture capacity of 2.35 g g⁻¹ carbon.

### Example 4

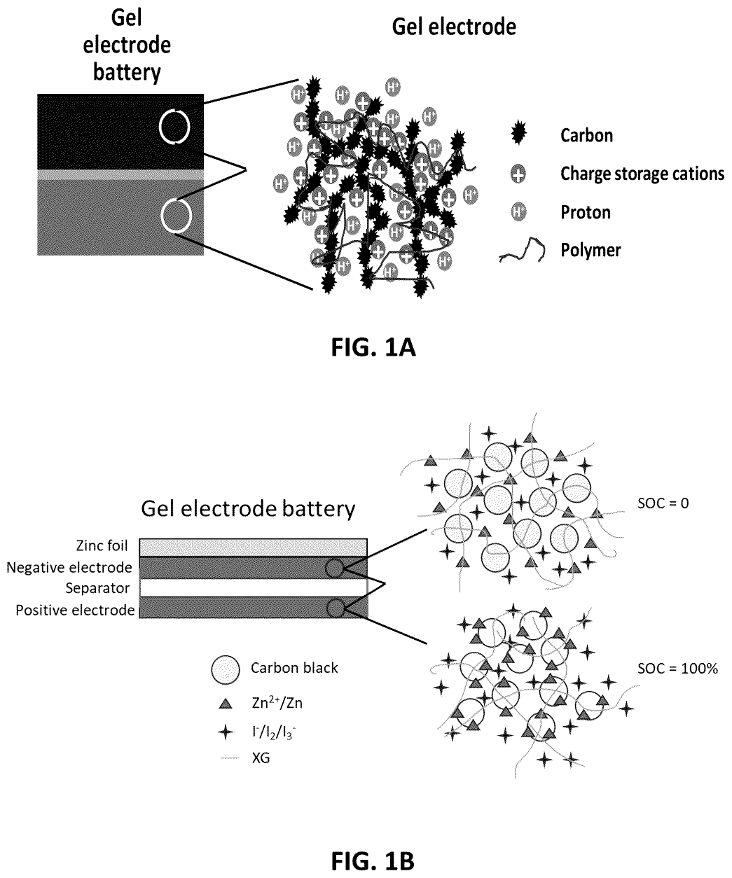

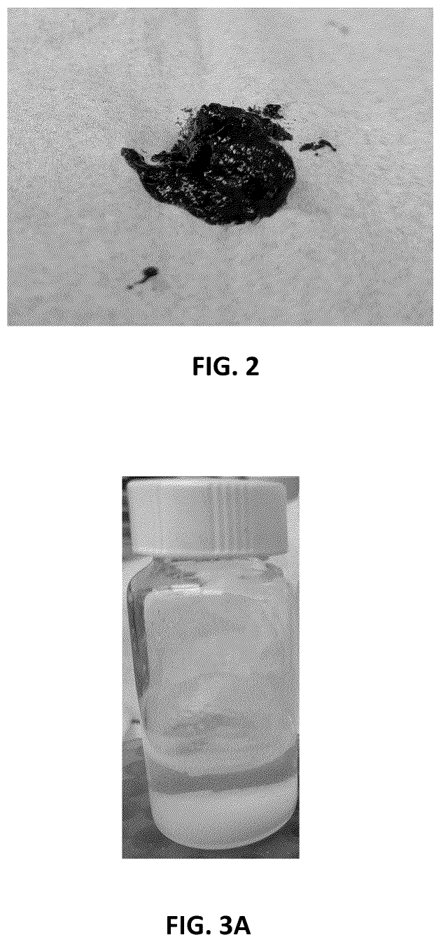

This example describes the molecular interactions and microstructures in the gel electrodes of the present disclosure. To overcome low-capacity utilization in liquid based secondary RFBs and low volumetric energy density in Zn/I₂ static cell, a gel electrode that comprises 7.5 M KI, 3.75 M ZnCl₂, 24 mol water, 0.3 g carbon black powder, and 0.4 g XG polymer (FIGS. 1A/1B and FIG. 2) was developed as a novel electrode for long duration energy storage (LDES), providing a theoretical energy density of 120 Wh/L.

The battery has a symmetric design wherein both the positive electrode and negative electrode comprise the same material, and a Nation® cation exchange membrane or separator is used as the electrolyte membrane. On the negative electrode, a zinc foil is added to provide sufficient zinc source as zinc may be trapped in the carbon black during the repeated plating/stripping process. In a freshly prepared gel electrolyte, Zn²⁺ is bonded to the polymer, while I⁻ is homogeneously dispersed in the gel. During the charge process, Zn²⁺ is reduced to Zn metal plating on the carbon black powder, while the I⁻ is oxidized to I₂ and remains evenly dispersed in the gel system (FIG. 1B).

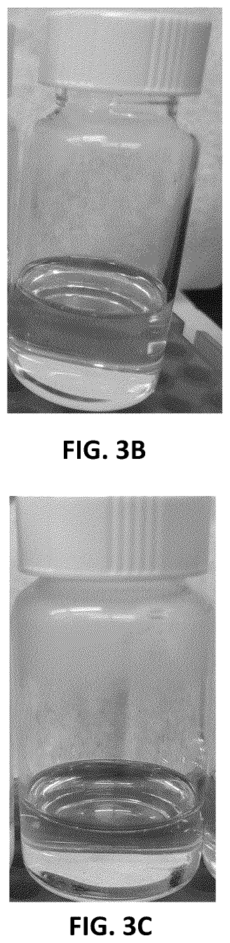

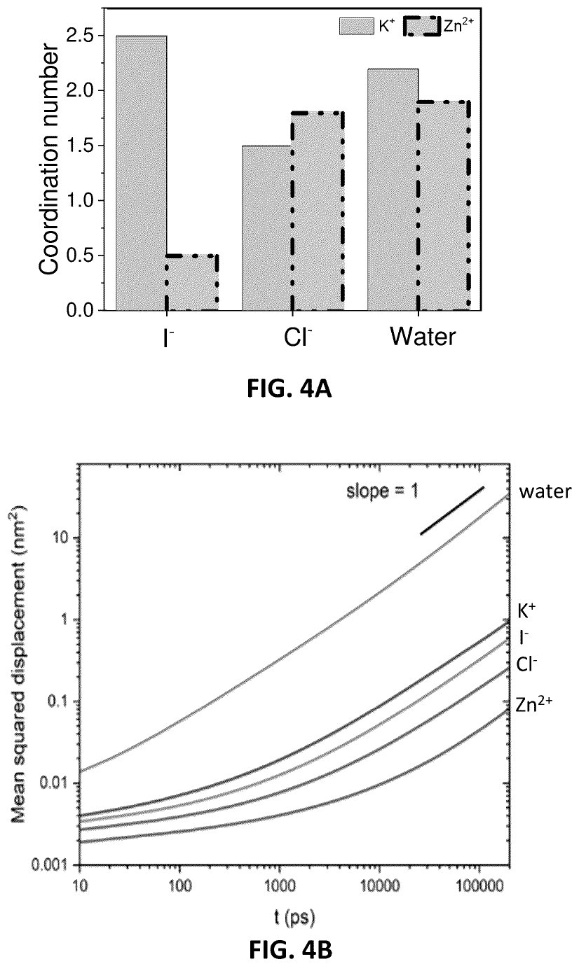

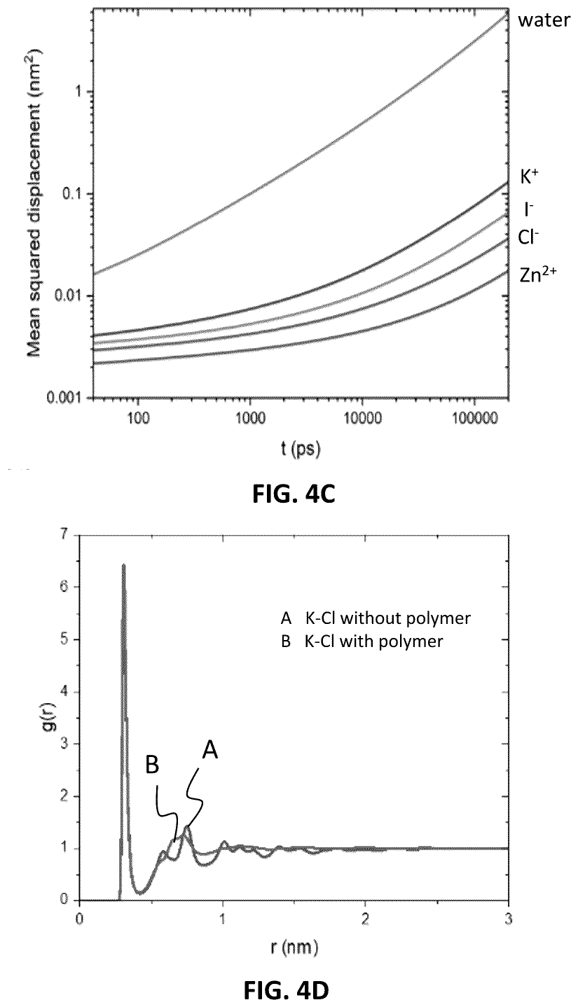

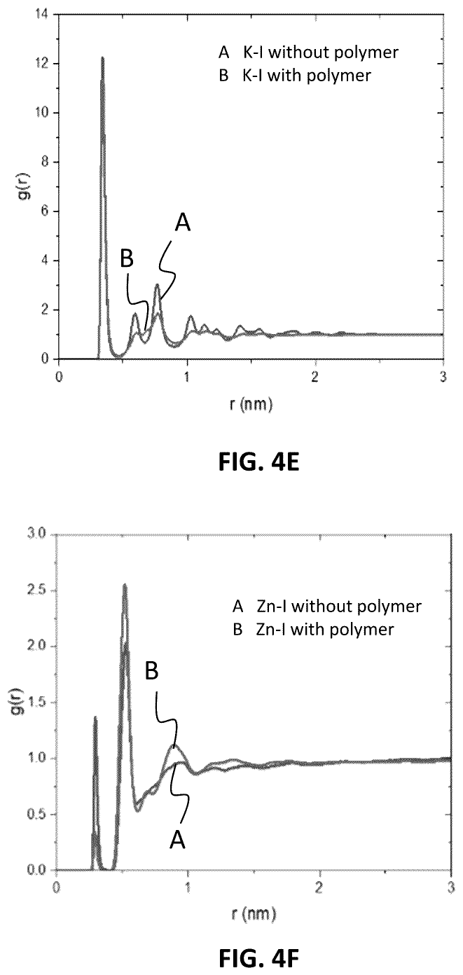

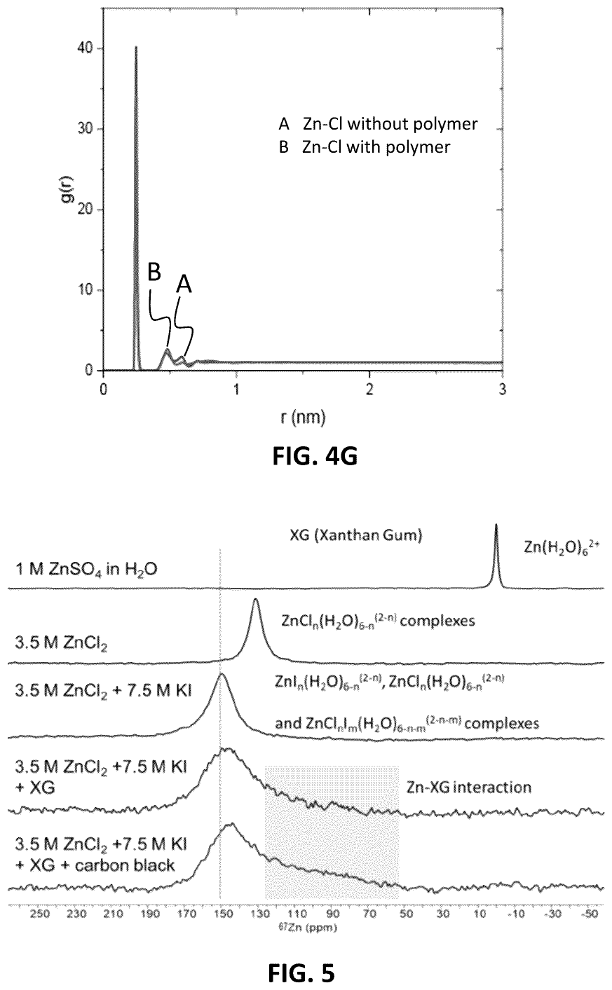

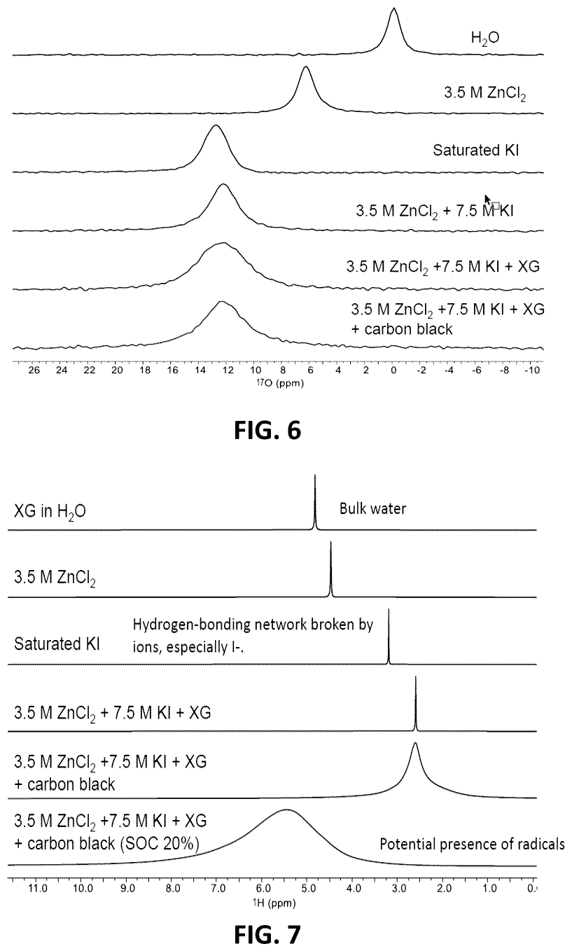

KI has a low solubility (<7.5 mol) when present alone in water; however, its solubility significantly increases when present together with ZnCl₂ (FIGS. 3A-3C). This indicates that KI, ZnCl₂ and water form complexes that can significantly increase the solubility of the active species in the gel electrode. AIMD and CMD simulations were conducted to understand coordination between ions and water, and the structure confinement in the electrolyte with and without polymer. The coordination number of water to cations in the 7.5 M KI plus 3.75 M ZnCl₂ electrolyte is lower than 6 (FIG. 4A) in a typical octahedral structure, but still indicating limited free water molecular, and cations and/or anions coordination in the electrolyte. ⁶⁷Zn NMR demonstrated the existence of ZnIₙ(H₂O)₆₋ₙ⁽²⁻ⁿ⁾, ZnClₙ(H₂O)₆₋ₙ⁽²⁻ⁿ⁾ and ZnClₙIₘ(H₂O)₆₋ₙ₋ₘ^{(2-n-m)} complexes in 7.5M KI and 3.75M ZnCl₂ electrolyte (FIG. 5). In addition, both ¹⁷O NMR (FIG. 6) and ¹H NMR (FIG. 7) showed that the hydrogen bond network was broken by large ions, especially I⁻, further demonstrating the existence of cations and/or anions (I⁻ or Cl⁻) coordination. The lower water molecular coordination to cations was expected because of the high ion concentrations in 7.5M KI and 3.75M ZnCl₂ electrolyte in which the ratio of ions/water is ˜1.

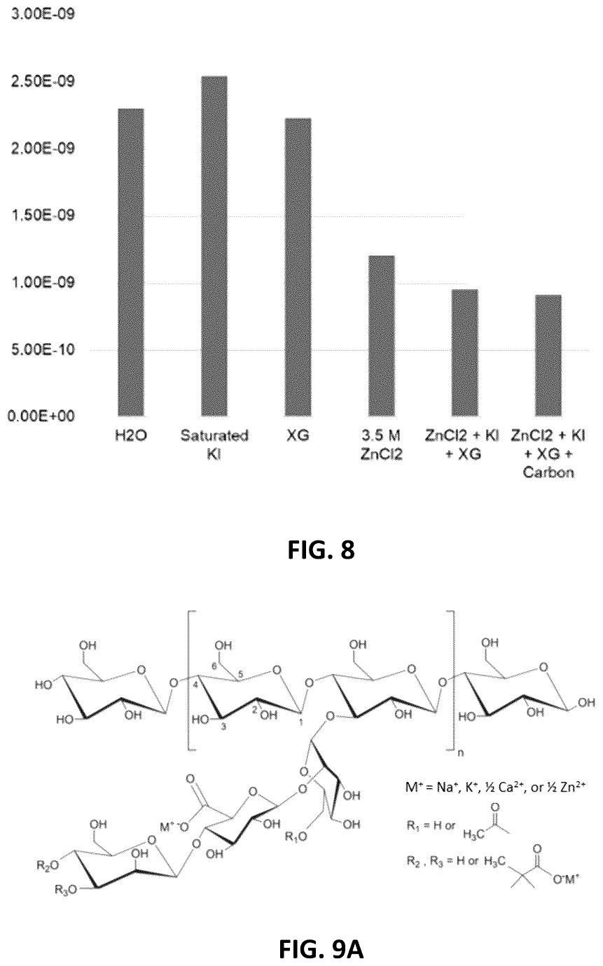

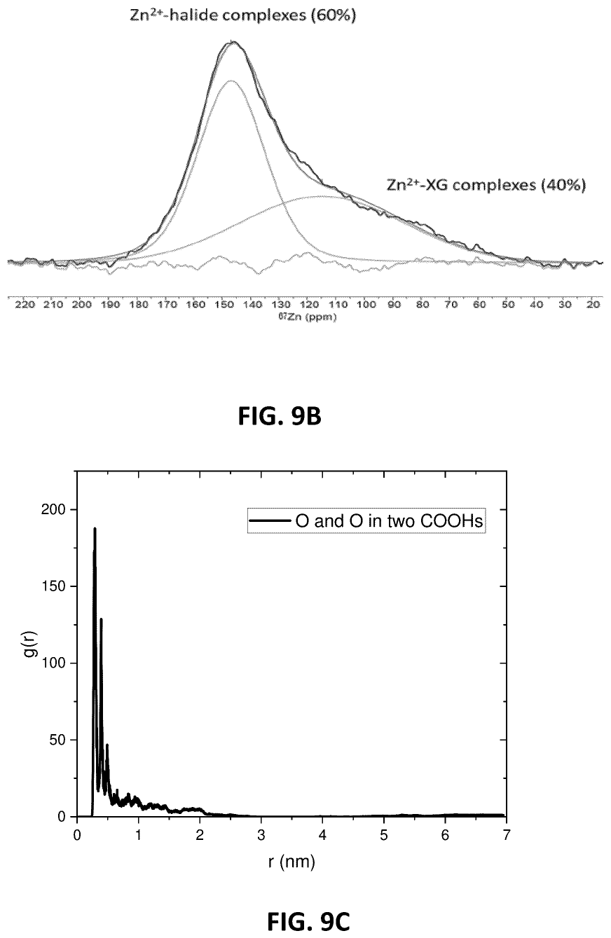

CMD calculations showed that the water diffusion rate in the 7.5M KI and 3.75M ZnCl₂ electrolyte with or without polymer (FIGS. 4B and 4C) is much faster than other ions, showing that free water molecules still exist in the gel electrolyte. The water diffusion rate is slower in the electrolyte with polymer (FIGS. 4C and 8) due to strong bonding between water molecule and the hydrophilic groups (hydroxyl or carboxyl group) in the polymer (FIG. 9A). The slower water diffusion rate in the electrolyte with polymer can mitigate the hydrogen evolution reaction at the negative side although the pH of the gel electrode is around 4.1. The existence of free water molecule in gel electrode can efficiently support the transport of the charge carrier ions to finish charge/discharge process. In addition, the conversion between ions and solid (I⁻/I₂ at the positive electrode and Zn²⁺/Zn at the negative electrode) during charge process can release more water that can further promote the ion diffusion.

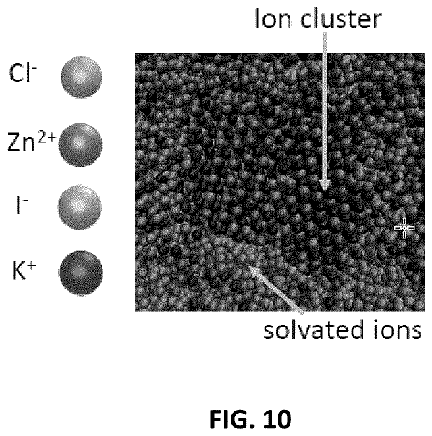

The cations or anions coordination other than cations and water coordination in the electrolyte comprising 3.5 M ZnCl₂+7.5 M KI in H₂O was further demonstrated by the existence of ion cluster in the electrolyte, wherein atoms are periodically distributed like crystal (FIG. 10). The main composition of cluster (FIGS. 4D-4G) is KI and a small amount of KCl and ZnI₂. Radial distribution function analysis in CMD simulations indicates that the size of the cluster in the electrolyte without polymer is around 2 nm, and is around 1.5 nm in the electrolyte with polymer. The smaller cluster size may be due to the strong bonding between polymer and ions and water, as well as the long chain in polymer, which may break the ion cluster into smaller sizes. The carboxylate ions in XG (XG-COO) replaces some halide to coordinate with Zn²⁺ (FIGS. 5 and 9B), the extra broadness of the ⁶⁷Zn NMR signal may be caused by 1) structural heterogeneity of XG-Zn²⁺ coordination, and 2) less mobility of XG compared to halide ions.

More interestingly, the decreased distance between two oxygens in the carboxyl group of the polymers suggests that Zn²⁺ ion bridges these two oxygens, indicating a strong bonding between Zn²⁺ and carboxyl (FIG. 9C). The strong bonding between Zn²⁺ and the polymer, and the faster K⁺ ion diffusion rate (faster than Zn²⁺, FIG. 4C) indicate that K⁺ instead of Zn²⁺ will be the charge carrier to transport through the cation exchange membrane in the gel battery.

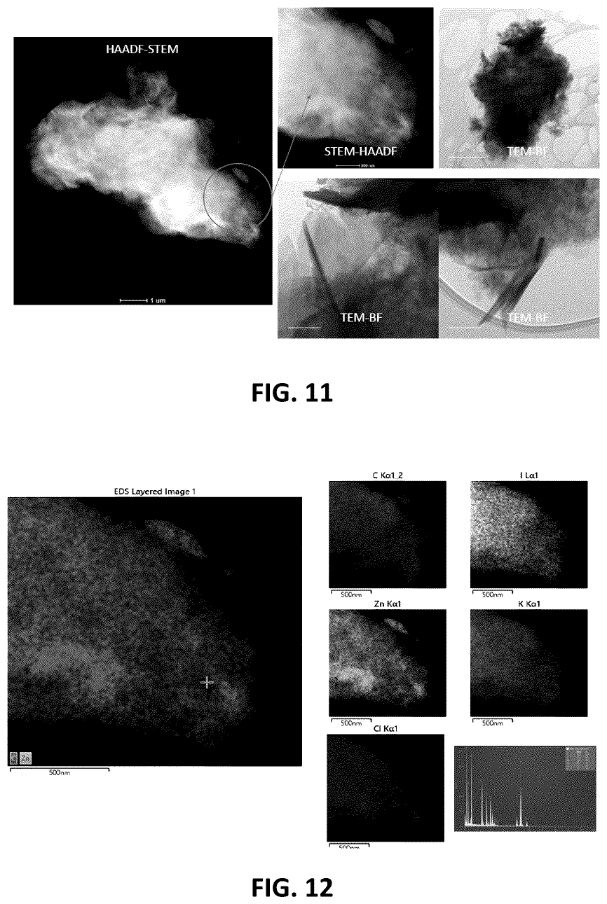

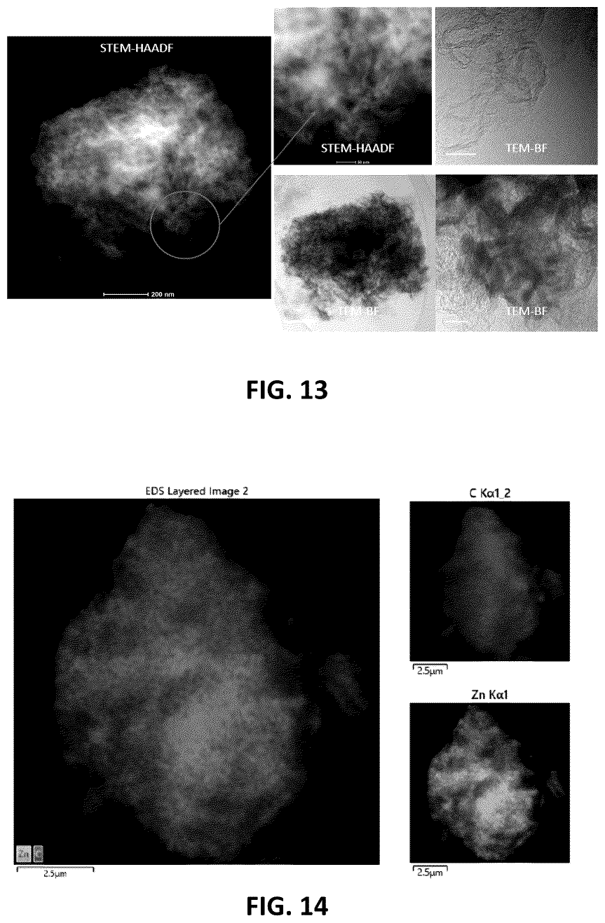

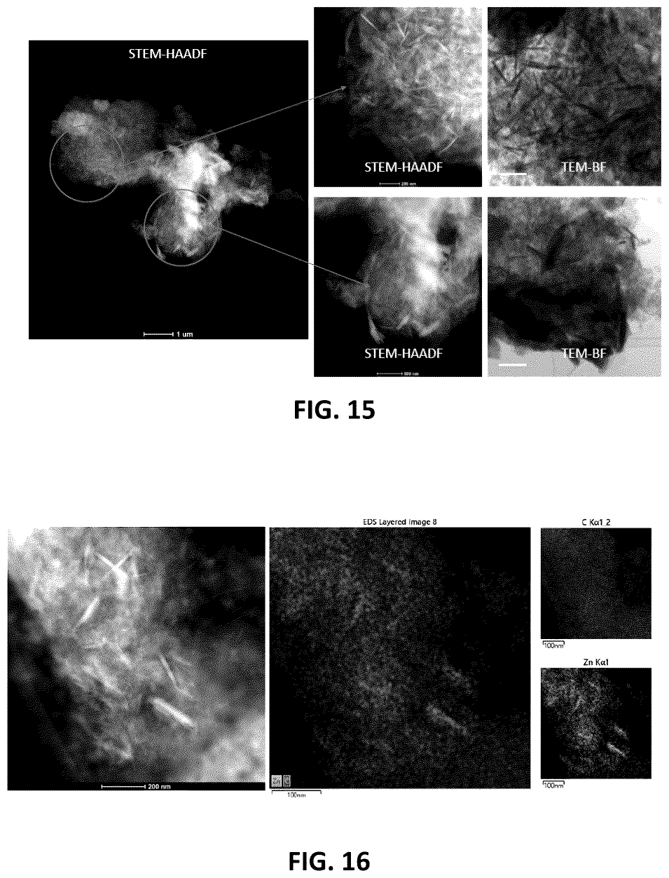

The presence of polymer not only affects the coordination of ions at the atomic level but also influences the microstructure of a gel electrode. In a gel electrode comprising 3.5 M ZnCl₂+7.5 M KI+XG+carbon back in H₂O, carbon black powders were wrapped by the polymer in the gel electrode, forming big particles in the size of ˜10 um, as shown in FIGS. 11-16. The formation of big particles can lower the contact resistance of gel electrodes and enhance the electron transfer during the charge/discharge process. The porous structure of carbon powder also led to smooth and porous Zn, such that Zn could be plated on the whole carbon electrode, although a few of Zn needle (˜200-300 nm) on carbon powder could be observed at the beginning of the Zn plating process (SoC ˜20%) (FIGS. 11 and 12). When SoC was increased to 100%, the smooth and porous Zn could still be observed, and at the same time, a couple of Zn needles in the size of ˜200-300 nm were uniformly plated on the carbon powder (FIGS. 13 and 14). No change in the size of the Zn needles could be observed even at high SoC. Due to the strong Zn²⁺ ions and polymer bonding and the wrapping of carbon powder by polymer, Zn²⁺ ions in a gel electrode will be plated on carbon powder through the hopping mechanism instead of a typical diffusion mechanism in the traditional diluted aqueous electrolyte. Therefore, Zn will be confined (or sandwiched) between polymer coating and carbon powder, preventing the formation of Zn dendrite on carbon powder. The orientation of Zn needle is in parallel with the surface of carbon powder. The accumulation of Zn particles on the carbon powder was also observed. The possible reasons are: 1) Zn²⁺ prefer plating on the surface of carbon, which is rich of carboxyl group; 2) Zn plating prefer the position where electrons can easily transfer during a charge/discharge process.

### Example 5

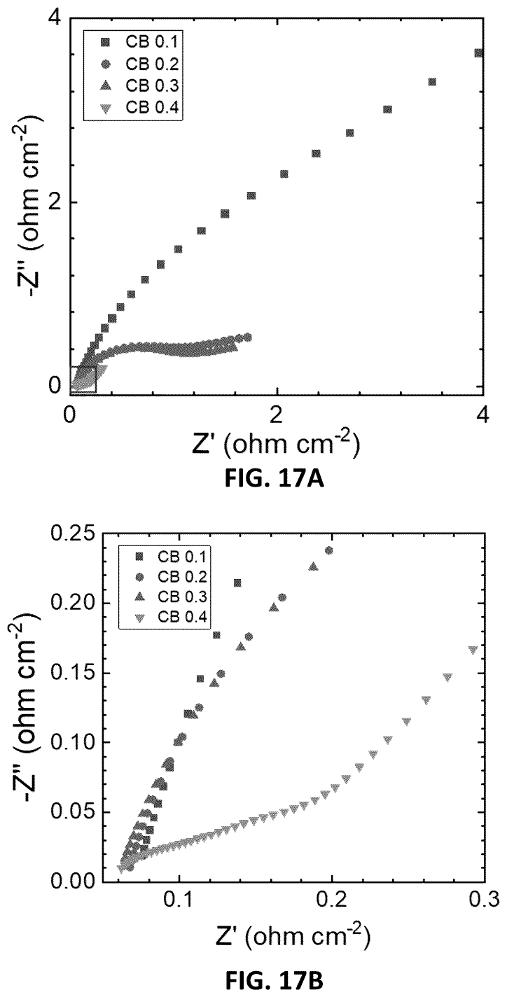

This Example describes the results of various performance testing conducted on the electrodes and cells according to aspects of the present disclosure. The electron/ion transportation in Zn—I gel electrodes of various carbon black concentrations was investigated using EIS (FIGS. 17A and 17B). The charge transfer resistance in mid frequency region decreases as the carbon black content increases. The charge transfer resistance in the CB 0.1 gel electrode approaches infinite, indicating an impossibility of charge transfer, so the CB 0.1 gel electrode was not used for further cell performance testing.

CB 0.2 and CB 0.3 have smaller charge transfer resistance, so that conductive material over 0.02 g ml⁻¹ can percolate to allow electrons to travel much faster and provide electrons to the electrode surface. CB 0.4 has very small charge transfer resistance, similar to a capacitor (FIG. 17B). High carbon contents can minimize interface resistance, as well as ohmic resistance (the total resistance of ionic resistance of electrolyte, intrinsic resistance of substrate, and contact resistance between the active material and the current collector) (FIG. 17B). CB 0.4 has the lowest ohmic resistance (˜0.06 ohm cm⁻²), followed by CB 0.3, then CB 0.2. The smaller slope of the CB 0.4 plot indicates slower ion diffusion in CB 0.4 compared to CB 0.2 and CB 0.3. This is due to higher viscosity and tortuosity in higher carbon concentration gel electrodes. Though slower for ion diffusion, the ohmic resistance of CB 0.4 is smaller because of the much smaller contact resistance with the current collector and substrate in electrodes with high conductive material concentration. Other conductive material, such as graphene sheet, reduced graphene oxide, carbon fiber, carbon nanofiber, carbon nanotube, or MXene, can be used to achieve similar functions and features as carbon black in the gel electrode system.

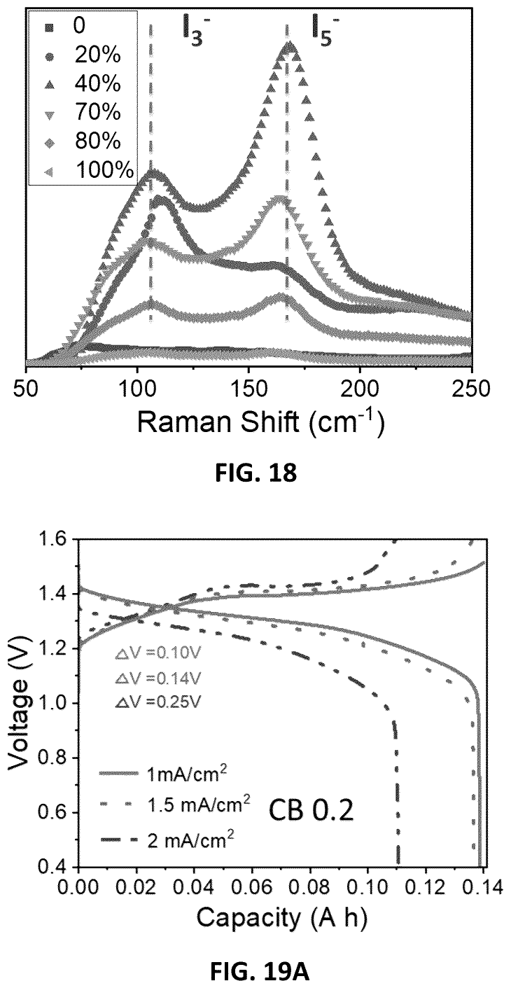

FIG. 18 shows the ex situ Raman spectra of the positive gel electrode of the cell obtained at different SoCs (that is 0, 20, 40, 70, 80 and 100%). The Raman spectrum at 0% SoC shows three distinctive bands at 122, 138 and 160 cm⁻¹. These three bands are assigned to [ZnI₄]²⁻, [ZnI₃]⁻, and [ZnI₂] complexes existing in the gel electrode. The Raman peaks of the charged gel electrode located at 110 cm⁻¹ and 160 cm⁻¹ are associated with polyiodides I₃⁻ and I₅⁻, respectively. As shown in FIG. 18, the intensity of the bands at 110 cm 1 and 160 cm⁻¹ increases during the initial charging period. At ˜60% SoC, the intensity of the band at 110 cm⁻¹ decreases while the intensity of the band at 160 cm⁻¹ significantly increases, as compared to the bands at 20% SoC. This indicates that the formation of 15 species increased. At 80% and 100% SoCs, the intensity of the bands at 110 cm⁻¹ and 160 cm⁻¹ significantly decreases due to the formation of I₂. Therefore, Raman spectra of the positive gel electrode at different SoCs demonstrate that the polyiodides in gel electrode decompose to I₂.

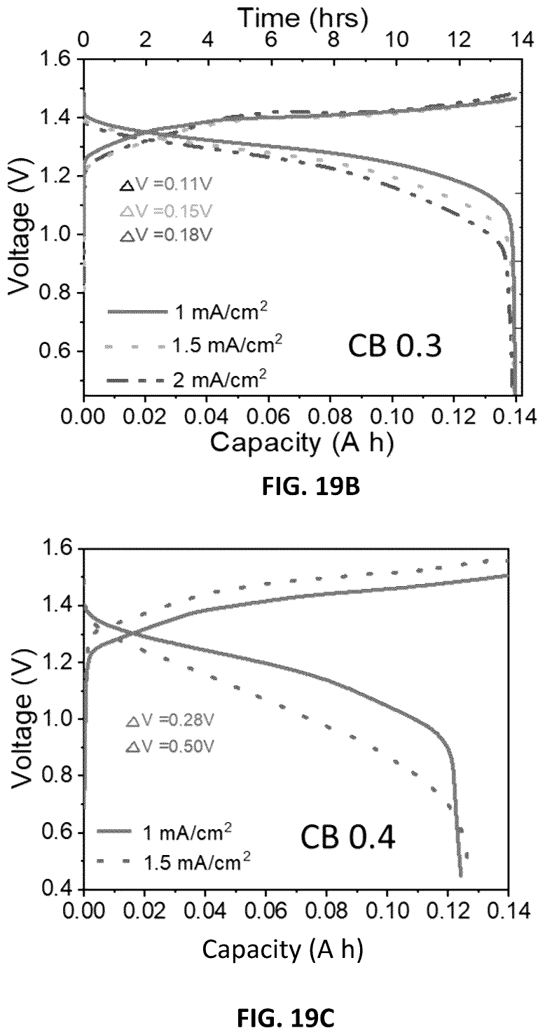

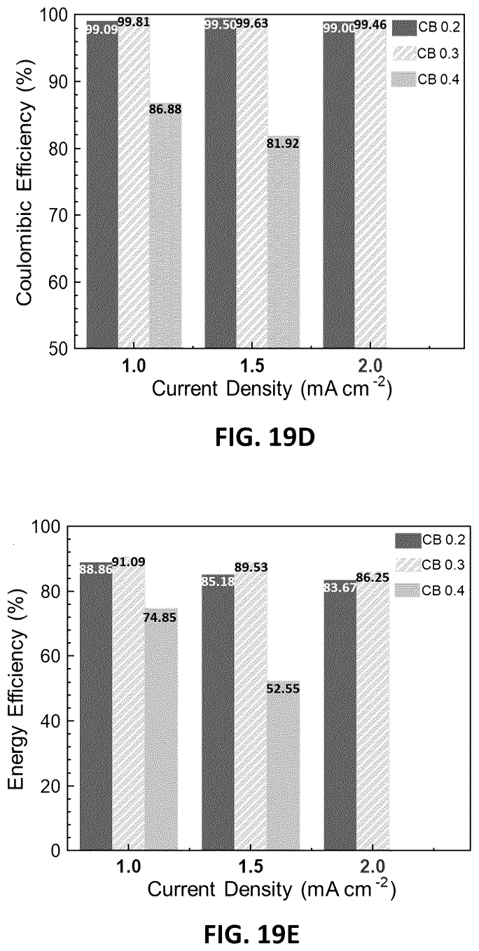

The performance of cells made with symmetric CB 0.2, CB 0.3, or CB 0.4 gel electrodes was investigated at various current densities: 1, 1.5, and 2 mA cm⁻². All the cells were tested under 0.4 V to 1.6 V with capacity limited to 0.14 Ah. Capacities in CB 0.2 (FIG. 19A) and CB 0.3 (FIG. 19B) cells at low current densities (1 mA cm⁻² and 1.5 mA cm⁻²) almost achieved 0.14 Ah, while capacity of CB 0.4 cell was around 0.12 Ah at low current densities. CB 0.4 cell exhibited high polarization (difference between voltage) without plateau (FIG. 19C) while the polarizations in CB 0.2 (FIG. 19A) and CB 0.3 (FIG. 19B) cells were relatively low and similar at low current densities (0.10 V and 0.11 V at 1 mA cm⁻²; and 0.14 V and 0.15 V at 1.5 mA cm⁻²). CB 0.3 cell has ˜70% of smaller polarization at high current density as compared to CB 0.4 (0.18 V for CB 0.3 and 0.5 V for CB 0.4). This polarization difference indicates that CB 0.4 cell suffered from lack of ions even at low current density. Although the capacity of CB 0.2 cell dropped to 0.12 Ah at high current density, this is likely to be caused by the electroconductivity issue, as evidenced by the voltage drop at the initial stage of the discharge process, corresponding to an internal resistance drop.

The EIS results in FIG. 17 and the voltage-capacity profiles in FIG. 19A-19C together show that the balance between electron conductivity and ionic conductivity in CB 0.3 is the best condition for the Zn—I gel electrode. In addition to the high capacity, the Coulombic efficiency (CE) at each current density (FIG. 19D) also support that CB 0.3 represents the best condition: CB 0.3 cell has a CE of almost 99.5% at the high current density condition, 2 mA cm⁻² (FIG. 19D). Even more importantly, the CE slightly increased as the current density decreased, and the highest CE of ˜99.81% could be achieved at 1 mA cm⁻² current density. Zn—I₂ gel electrode-containing cells can achieve high CE at different current density possibly because (1) the negatively charged sulfonate groups in the Nation® membrane suppress the crossover of triiodide anions via the Donnan exclusion; and (2) reactions of I₂/I⁻ at positive electrode and Zn²⁺/Zn at the negative electrode are highly reversible. In traditional RFBs, e.g., vanadium RFB and Fe/Cr RFB, various acids are used to support the electrolyte to increase electrical conductivity of the electrolyte and provide proton charge carriers during the charge/discharge process. However, the simultaneous transport of the active cations, e.g., V, Fe and Cr cations, together with proton charge carriers can result in serious crossover issues, leading to a low CE (˜95%-96%) and energy losses from self-discharge reactions. The strong Zn²⁺-polymer bonding and faster diffusion rate of K⁺ can mitigate the competition of transport between Zn²⁺ and K⁺ charge carrier. At the same time, together with lower diffusion rate of Zn²⁺ in the gel electrolyte and high cation selectivity of the potassium formed Nafion® membrane against iodide/triiodide anions transport, the Zn—I₂ gel battery delivers a much-improved CE value. It is noted here that only Zn²⁺ in the negative electrode and the iodine species can make the capacity contribution because 1) strong Zn²⁺-polymer bonding limits zinc diffusion between the two electrodes; 2) the crossover of iodide and triiodide anions are blocked by negatively charged sulfonate groups in the Nation® membrane.

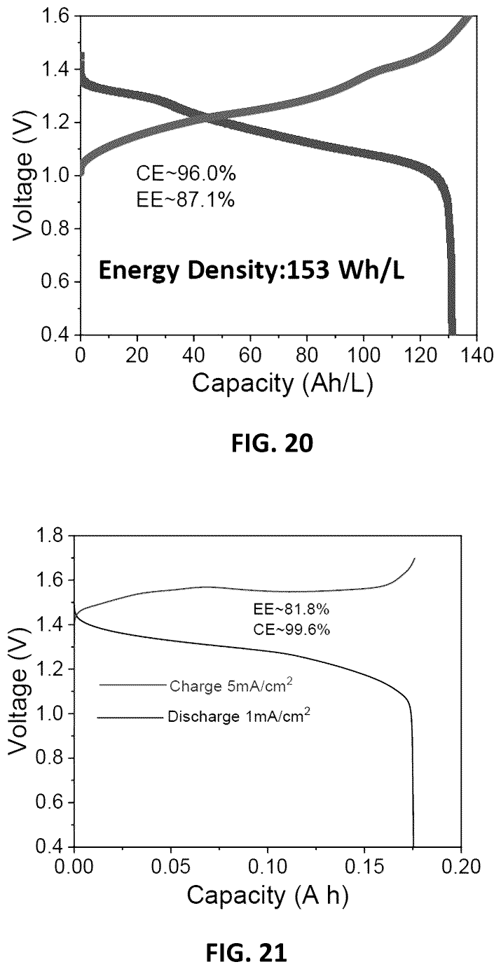

Therefore, the gel battery with 7.5 M ZnCl₂ gel as the negative electrode was fabricated to further increase volumetric energy density. The Zn—I₂ gel battery with 7.5 M ZnCl₂ as the negative electrode could reach a discharge energy density of ˜153 Wh/L (FIG. 20), which is 5 times higher than commercialized vanadium RFB, and is comparable with Zn—I₂ flow battery.

Also, the low polarization in CB 0.3 also contributed to the high energy efficiency (EE) over 91% at lower current density and over 86% at higher current density (FIG. 19E). It is as estimated that EE decreased as current density increased. High CE, EE and voltage efficiency (VE) also demonstrate that the carbon powder can form conductive network to efficiently support the electron transfer during electrode reaction.

In addition, batteries designed for asymmetric charge and discharge have useful applications. For example, in renewable energy storage, fast charging can quickly store excess energy, while slow discharging can provide a steady supply of power during periods of low energy production. An asymmetry testing (charge at 5 mA/cm² and discharge at 1 mA/cm²) was performed for a gel battery with symmetric positive and negative electrodes, both comprising 3.5 M ZnCl₂+7.5 M KI+XG+carbon in H₂O (FIG. 21). High EE of ˜81.8% and CE of ˜99.6% could be achieved.

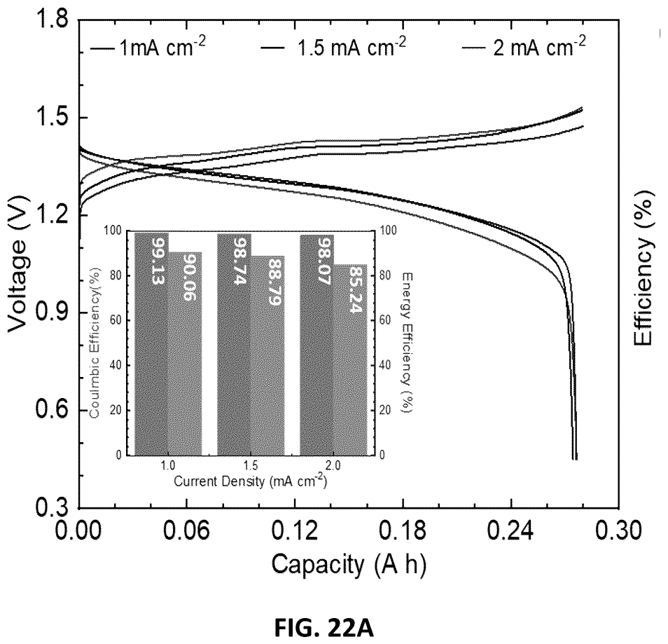

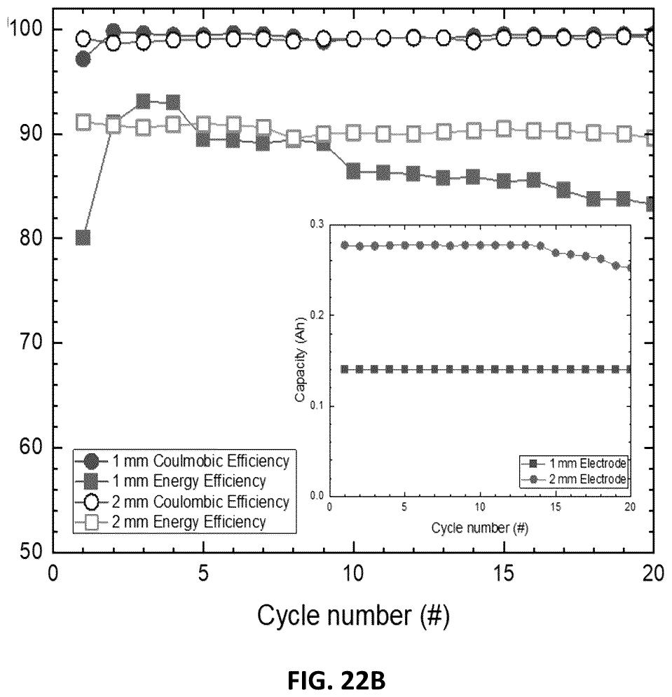

To achieve larger capacity, a thicker gel electrode was fabricated using 2 mm gasket with CB 0.3 gel, and a symmetric cell formed by the electrodes was tested. Ideally, the twice thicker electrode would have twice larger total capacity because it has twice the amount of the active material. However, the thicker electrode also has a twice longer ionic pathway so that it may suffer from a lack of ions and high concentration polarization, and thus has a capacity less than ideal. The CB 0.3 gel electrode was selected because of high enough carbon black concentration for percolation but not too condensed for ion penetration. The 2 mm electrode cell achieved 0.28 Ah capacity, twice the capacity of the 1 mm electrode cell, under all current density tested (1, 1.5, and 2 mA cm², FIG. 22A). The 2 mm electrode has a CE of 99.13% and EE of 90.06% at 1 mA cm⁻²; a CE of 98.74% and EE of 88.79% at 1.5 mA cm⁻²; and a CE of 98.07% and EE of 85.24% at 2 mA cm⁻².

Further, the 2 mm electrode cell had a stable CE and EE for 20 cycles at 1 mA cm⁻², with almost twice the capacity of the 1 mm electrode cell (FIG. 22B). The stable cycling performance and increase in capacity suggest a high potential of proportionally increasing capacity with electrodes much thicker than 2 mm.

The charge and discharge experiments for the above gel electrode-containing cell testing was designed to have capacity limits (˜67% of theoretical capacity), only allowing the redox reaction of iodide/triiodide anions at the positive electrode side, while avoiding the formation of solid 12 precipitate on the surface of carbon powder.

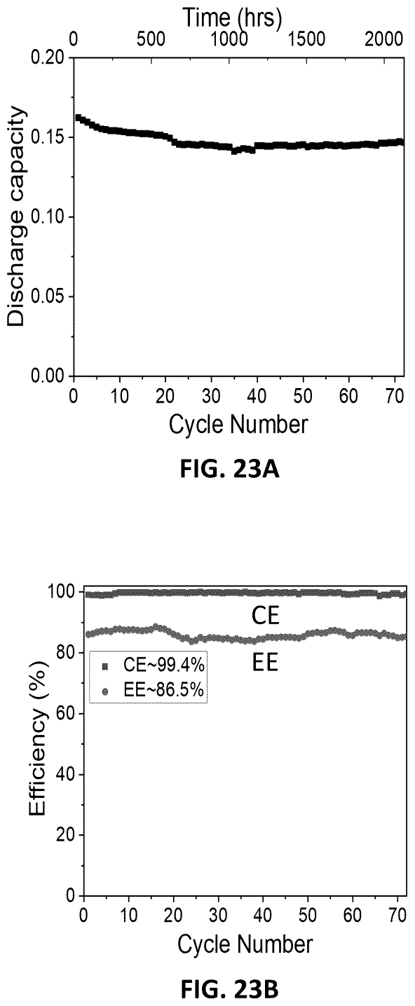

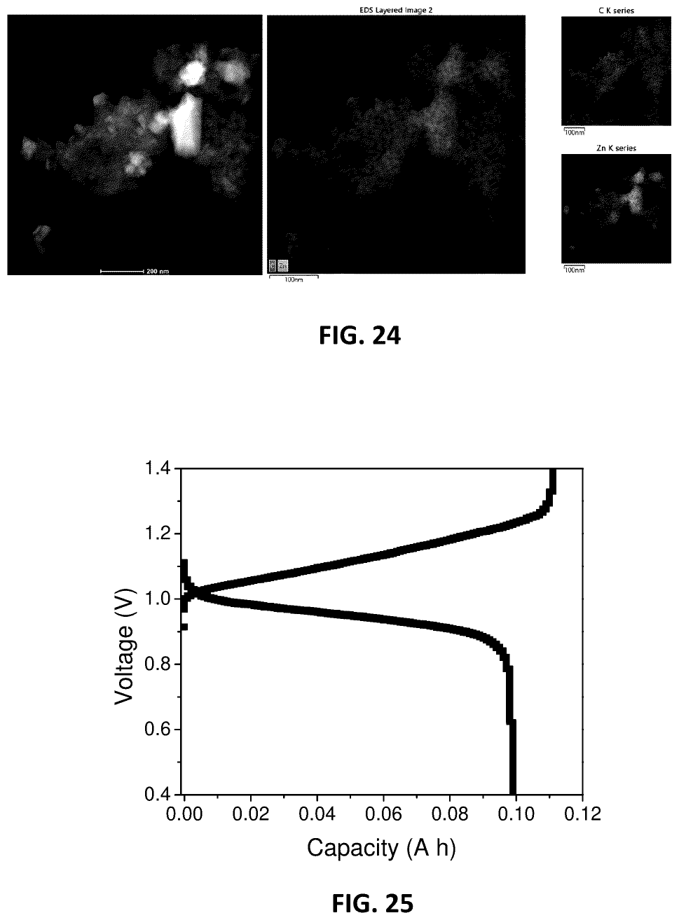

FIG. 23A shows discharge capacity of a symmetric cell with 1 mm gel positive and negative electrodes, both comprising 3.5 M ZnCl₂+7.5 M KI+XG+carbon in H₂O, the cell having a theoretical capacity of ˜0.2 Ah. At 1 mA/cm² current density (the typical current density for Zn/MnO₂ batteries), each charge and discharge cycle for the cell needs ˜30 hrs due to high area capacity of ˜15 mAh/cm². The CE remained around 99.4% during all cycles tested. The EE remained at ˜88% for the first 20 cycles at 1 mA/cm², and only slightly decreased to ˜86.5% in the subsequent cycles (FIG. 23B). During the initial cycle, the delivered discharge capacity was 0.162 Ah. Subsequently, after 20 cycles, this capacity slightly reduced to 0.145 Ah, and remained consistent for the following 50 cycles. This remarkable performance showcases the exceptional cycle stability of Zn—I₂ gel battery. After cyclic testing, the color change (black to white) at the negative electrode clearly demonstrates that the Zn-on-Zn foil can gradually transfer to the carbon electrode (and mainly aggregate along the edge of the carbon powder) and subsequently enhance the electronic conductivity of the electrode and lower the resistance of the battery (FIG. 24). This example shows that an LDES battery can be successfully cycled for 70 cycles and ˜100 days.

### Example 6

This example describes the results of cell performance testing conducted on the cells according to aspects of the present disclosure using a Cr/Fe gel electrode-containing cell. The freshly prepared negative gel electrode comprised 4M CrCl₃, 3M HCl, 40 g/L PVA, 30 g/L carbon powder, and 28 M water. The freshly prepared positive gel electrode comprised 4M FeCl₂, 5M HCl, 40 g/L PVA, 30 g/L carbon powder, and 28 M water. The two electrodes were separated by a Nafion® membrane. FIG. 25 shows a voltage-capacity plot for the cell when charged at 10 mA/cm² and discharged at 5 mA/cm². CE of this cell is 89%. This cell configuration exhibited an energy density of 64.9 Wh/L and provided a voltage of 1.21 V when containing 5-6 moles of Fe ions and 3-4 moles of Cr ions.

### Example 7

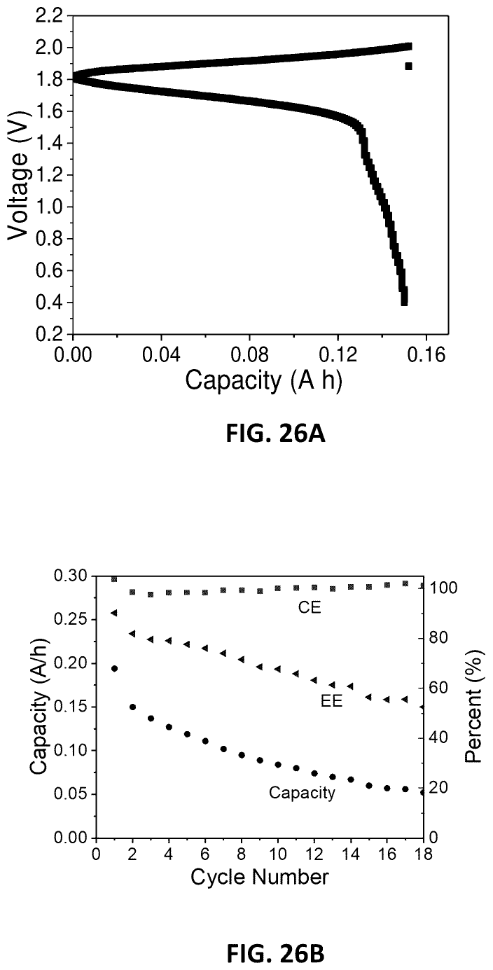

This example describes the results of cell performance testing conducted on the cells according to aspects of the present disclosure using a Cr/Mn gel electrode-containing cell. The freshly prepared negative gel electrode comprised 4M CrCl₃, 0.5M H₂SO₄, 40 g/L PVA, 30 g/L carbon powder, and 28 M water. The freshly prepared positive gel electrode comprised 3M MnSO₄, 1M H₂SO₄, 40 g/L PVA, 30 g/L carbon powder, and 28 M water. The two electrodes were separated by a Nation® membrane. FIG. 26A shows a voltage-capacity plot for the cell when charged at 10 mA/cm² and discharged at 5 mA/cm² at. FIG. 26B shows the capacity, CE, and EE of this cell for 18 charge-discharge cycles. The CE of this cell remained at 100% throughout the 18 cycles. Increasing acid concentration can increase ionic conductivity and increase EE. This cell configuration exhibited an energy density of 108.1 Wh/L and provided a voltage of 1.68 V when containing 6 moles of Mn ions and 3-4 moles of Cr ions.

### Example 8

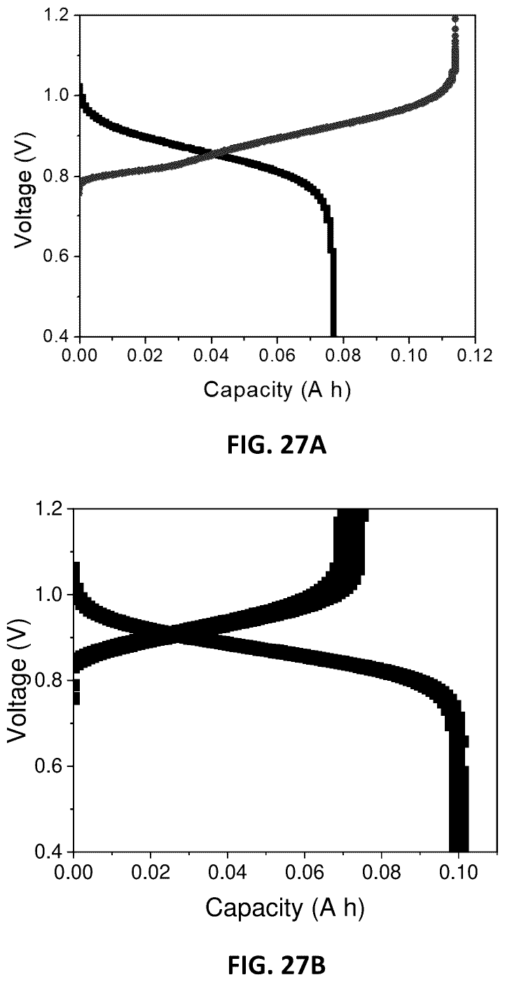

This example describes the results of cell performance testing conducted on the cells according to aspects of the present disclosure using a Fe/V gel electrode-containing cell. The freshly prepared negative gel electrode comprised 3M VOSO₄, 4M HCl, 80 g/L PVA, 30 g/L carbon powder, and 28 M water. The freshly prepared positive gel electrode comprised 3M FeCl₂, 4M H₂SO₄, 80 g/L PVA, 30 g/L carbon powder, and 28 M water. The two electrodes were separated by a Nafion® membrane. FIG. 27A shows a voltage-capacity plot for the cell when charged at 10 mA/cm² and discharged at 5 mA/cm². FIG. 27B shows a voltage-capacity plot for the cell when charged at 10 mA/cm² and discharged at 2.5 mA/cm².

### Example 9

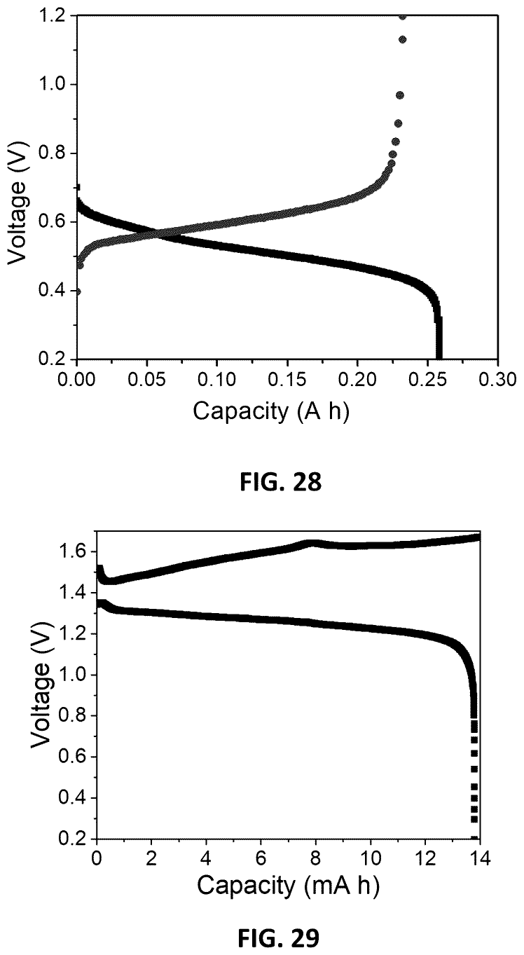

This example describes the results of cell performance testing conducted on the cells according to aspects of the present disclosure using a hydrogen-iron gel electrode-containing cell. The negative electrode was a Pt/C coated hydrogen electrode. The freshly prepared positive gel electrode comprised 3M FeCl₃, 4M H₂SO₄, 80 g/L PVA, 30 g/L carbon powder, and 28 M water. The two electrodes were separated by a Nafion® membrane. FIG. 28 shows a voltage-capacity plot for the cell when charged at 5 mA/cm² and discharged at 5 mA/cm². This cell configuration exhibited high CE, and had an energy density of 123.8 Wh/L and can provide a voltage of 0.77 V when containing 5 to 6 moles of Fe ions.

### Example 10

This example describes the results of cell performance testing conducted on the cells according to aspects of the present disclosure using a hydrogen-manganese gel electrode-containing cell. The negative electrode was a Pt/C coated hydrogen electrode. The freshly prepared positive gel electrode comprised 5-6M MnSO₄, 1-4 M H₂SO₄, 80 g/L PVA, 30 g/L carbon powder, and 0.5 L water. The two electrodes were separated by a Nation® membrane. FIG. 29 shows a voltage-capacity plot for the cell when charged at 5 mA/cm² and discharged at 5 mA/cm². This cell configuration exhibited high CE, and had an energy density of 398.8 Wh/L and can provide a voltage of 1.24 V when containing 5 to 6 moles of Mn ions.

### Example 11

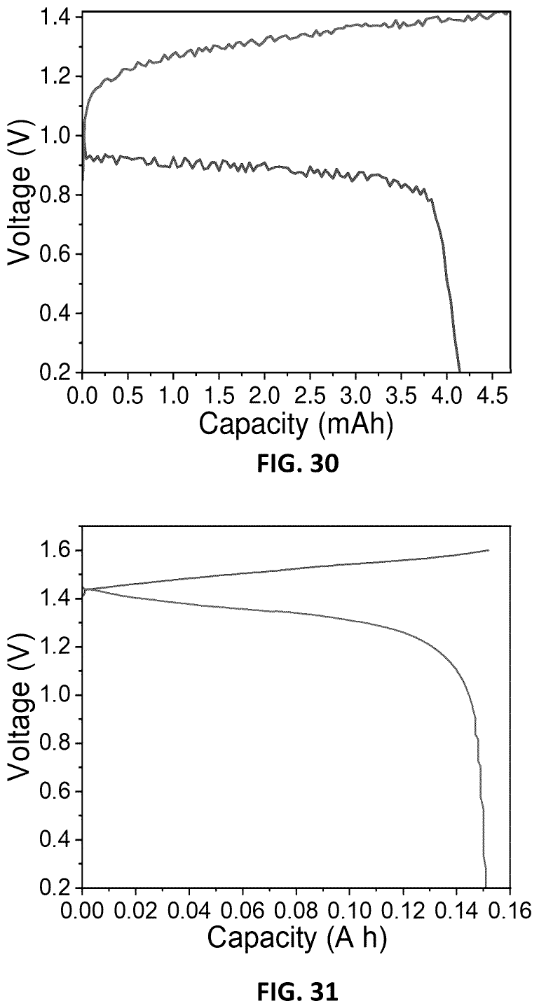

This example describes the results of cell performance testing conducted on cells according to aspects of the present disclosure, particularly a sulfur-iron gel electrode-containing cell. The freshly prepared negative gel electrode comprises 1.5 M Na₂S₂, 0.5 M NaCl, 80 g/L PVA, 30 g/L carbon powder, and 0.6 L water. The freshly prepared positive gel electrode comprises 0.4 M K₄Fe(CN)₆, 2M NaCl, 80 g/L PVA, 30 g/L carbon powder, and 0.6 L water. The two electrodes are separated by a Nation® membrane. FIG. 30 shows a voltage-capacity plot for the cell when charged at 1 mA/cm² and discharged at 1 mA/cm². This cell configuration exhibited good CE of ˜87%, and has a voltage plateau at ˜0.9 V.

### Example 12

This example describes the results of cell performance testing conducted on the cells according to aspects of the present disclosure using a titanium-manganese gel electrode-containing cell. The freshly prepared negative gel electrode comprised 1.5 M TiOSO₄, 3M H₂SO₄, 80 g/L PVA, 30 g/L carbon powder, and 0.6 L water. The freshly prepared positive gel electrode comprised 1.5M MnSO₄, 3M H₂SO₄, 80 g/L PVA, 30 g/L carbon powder, and 0.6 L water. The two electrodes were separated by a Nation® membrane. FIG. 31 shows a voltage-capacity plot for the cell when charged at 5 mA/cm² and discharged at 5 mA/cm². This cell configuration exhibited high CE, and had a voltage plateau at ˜1.35 V.

### Example 13

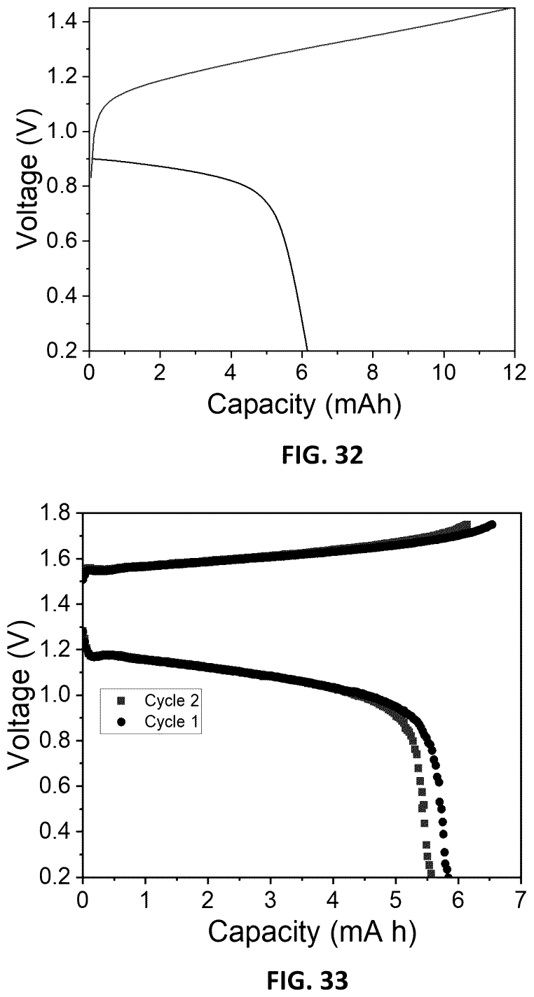

This example describes the results of cell performance testing conducted on the cells according to aspects of the present disclosure, particularly a sulfur-iodine gel electrode-containing cell. The freshly prepared negative gel electrode comprises 1.5 M Na₂S₂, 0.5 M NaCl, 80 g/L PVA, 30 g/L carbon powder and 0.6 L water. The freshly prepared positive gel electrode comprises 2 M KI, 80 g/L PVA, 30 g/L carbon powder, and 0.6 L water. The two electrodes are separated by a Nation® membrane. FIG. 32 shows a voltage-capacity plot for the cell when charged at 1 mA/cm² and discharged at 1 mA/cm². This cell had a voltage plateau at ˜0.9 V.

### Example 14

This example describes the results of cell performance testing conducted on the cells according to aspects of the present disclosure using a V/V gel electrode-containing cell. The freshly prepared negative gel electrode comprised 2 M V₂(SO₄)₃, 3M H₂SO₄, 80 g/L PVA, 30 g/L carbon powder, and 0.6 L water. The freshly prepared positive gel electrode comprised 2M VOSO₄, 3M H₂SO₄, 80 g/L PVA, 30 g/L carbon powder, and 0.6 L water. The two electrodes were separated by a Nation® membrane. FIG. 33 shows a voltage-capacity plot for the cell when charged at 10 mA/cm² and discharged at 10 mA/cm². This cell configuration exhibited high CE, and had a voltage plateau at ˜1.1 V.

### Example 15

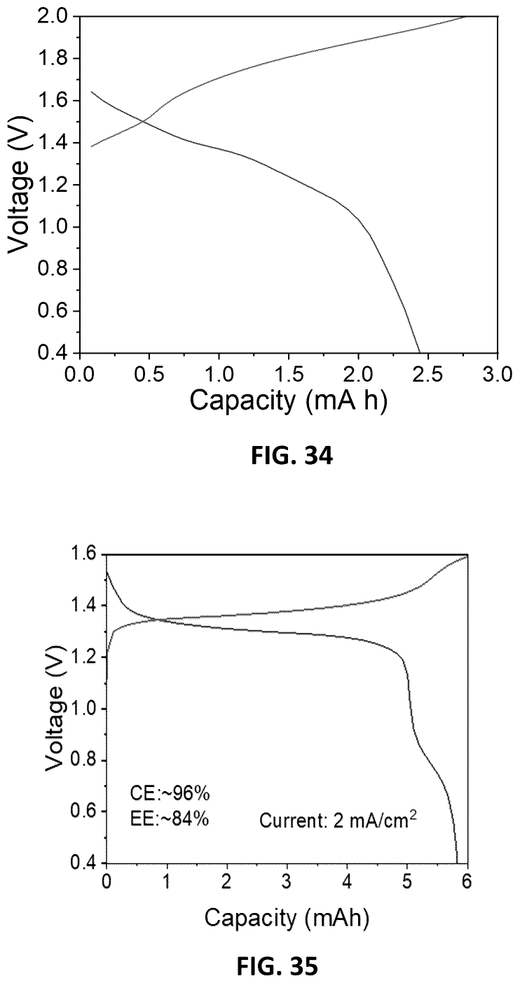

This example describes the results of cell performance testing conducted on the cells according to aspects of the present disclosure using a Zn—MnO₂ gel electrode-containing cell. The freshly prepared negative gel electrode comprised Zn foil, 1M ZnSO₄, 80 g/L PVA, 30 g/L carbon powder, and 0.6 L water. The freshly prepared positive gel electrode comprised 1M ZnSO₄, 80 g/L PVA, 30 g/L carbon powder, 240 g/L MnO₂, and 0.6 L water. The two electrodes were separated by Celgard separator. FIG. 34 shows a voltage-capacity plot for the cell when charged at 5 mA/cm² and discharged at 5 mA/cm².

### Example 16

In this example, a gel electrode-containing cell utilizing organic active species was prepared. The freshly prepared negative gel electrode comprises 1 M ZnCl₂, 25 g/L XG, 30 g/L carbon powder, and 0.6 L water. The freshly prepared positive gel electrode comprises 1 M TEMPO, 25 g/L XG, 30 g/L carbon powder, and 0.6 L water. FIG. 35 shows a voltage-capacity plot for the cell when charged at 2 mA/cm² and discharged at 2 mA/cm². This cell exhibits a CE of 96% and an EE of 84%.

### Example 17

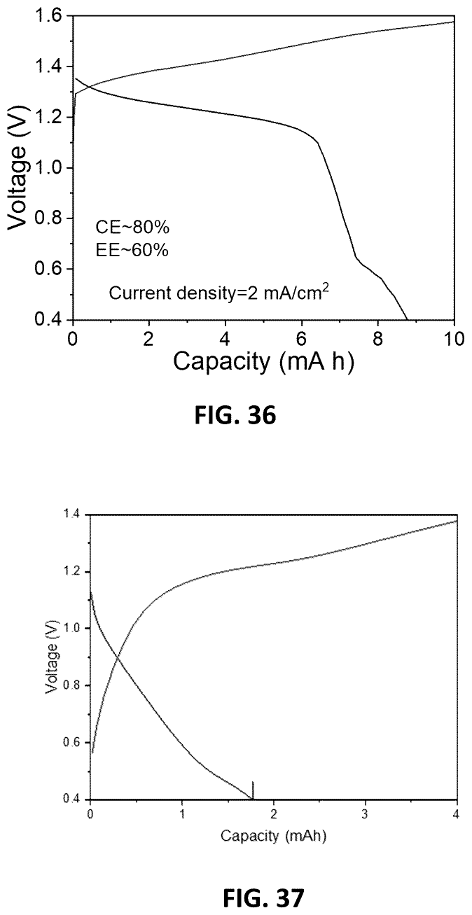

In this example, a gel electrode-containing cell utilizing organic active species was prepared. The freshly prepared negative electrode comprised 1 M ZnCl₂, 20 g/L XG, 30 g/L carbon powder, and 42 M water. The freshly prepared positive gel electrode comprised 0.5 M ferrocene, 20 g/L XG, 30 g/L carbon powder, and 42 M water. FIG. 36 shows a voltage-capacity plot for the cell when charged at 2 mA/cm² and discharged at 2 mA/cm². This cell exhibited a CE of 80% and an EE of 60%.

### Example 18

In this example, a gel electrode-containing cell utilizing organic active species was prepared. The freshly prepared negative electrode comprised 0.5 M disulfonated fluorenone, 20 g/L XG, 30 g/L carbon powder, and 42 M water. The freshly prepared positive gel electrode comprised 0.5 M K₄Fe(CN)₆, 20 g/L XG, 30 g/L carbon powder, and 42 M water. FIG. 37 shows a voltage-capacity plot for the cell when charged at 2 mA/cm² and discharged at 2 mA/cm².

### Example 19

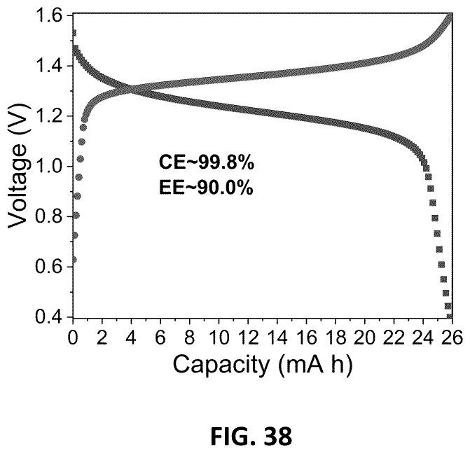

In this example, a gel electrode-containing cell utilizing an electroactive polymer as the electroactive material was prepared, wherein the electroactive polymer comprises one or more electroactive monomers linked to a backbone polymer. TEMPO was linked to PVA, forming PVA linked TEMPO, by a crosslinking reaction among 30 g/L PVA, 50 g/L TEMPO, and 50 g/L glutaraldehyde with 30 g 37% HCl used as a catalyst for the reaction. The freshly prepared positive gel electrode comprises about 130 g/L PVA linked TEMPO, 25 g/L XG, 30 g/L carbon powder, and 0.6 L water. This gel electrode was then washed by fresh water to adjust pH to about 7. The freshly prepared negative gel electrode comprises 1 M ZnCl₂, 25 g/L XG, 30 g/L carbon powder, and 0.6 L water. FIG. 38 shows a voltage-capacity plot for the cell when charged at 1 mA/cm² and discharged at 1 mA/cm². This cell exhibits an extremely high CE of nearly 100% and an EE of 90%. Without being limited to a single operating theory, it currently is believed that this is likely due to the ability of the PVA linked TEMPO to prevent crossover of TEMPO to the negative side.

### Example 20

### Preparation of Zn—I Gel Electrolyte and Zn—I Symmetry Gel Electrode

Zn—I gel electrolytes were prepared with various compositions as summarized in Table 2. Zn—I gel electrodes for both anode and cathode were prepared with various compositions as summarized in Table 2. 10.22 g of zinc chloride (ZnCl₂) for cation sources, and 25 g of potassium iodide (KI) for anion source were added in 10 ml of water. 0.45 g of xanthan gum (XG; which can be replaced with a hydrophilic synthetic polymer (e.g., polyvinyl alcohol or polyvinyl acetate) or carbohydrate polymers (e.g., carboxyl methyl cellulose, or gelatin)) was added to the aqueous electrolyte to increase viscosity to hold components. The corresponding amount of conducting agents in Table 4, carbon black (which can be replaced with graphite powder, and carbon nanotubes, etc.), was added in the last step and stirred overnight to obtain a homogenous gel electrode. The final volume of the gel electrode approached 20 ml by swelling of polymer binders, and the final concentration of ions was 3.75 M for ZnCl₂ and 7.5 M for KI.

TABLE 2
Summarized Composition of Zn—I electrolyte
(polymer: 0.45 g XG; water: 10 ml)

| No. | Composition |
|---|---|
| 1 | 10 g ZnCl₂ + polymer |
| 2 | 5 g ZnCl₂ + polymer |
| 3 | 2.5 g ZnCl₂ + polymer |
| 4 | 1.25 g ZnCl₂ + polymer |
| 5 | 12.5 g KI + polymer |
| 6 | 6.3 g KI + polymer |
| 7 | 3.1 g KI + polymer |
| 8 | 25 g KI + 10 g ZnCl₂ + polymer |
| 9 | 12.5 g KI + 5 g ZnCl₂ + polymer |
| 10 | 6.2 g KI + 2.5 g ZnCl₂ + polymer |
| 11 | 3.1 g KI + 1.25 g ZnCl₂ + polymer |
| 12 | 25 g KI + polymer |

### Fabrication of Zn—I Symmetry Gel Electrode Cells

All the testing was done with lab-made prototypes of closed cells. To assemble the cells, the 1 mm rubber gasket with 10 cm² inner circular space was placed on a flat graphite plane with 1 mm thickness of Zinc foil as an anode and current collector. Gaskets can be stacked, or their thickness varied, to conform with the thickness of a desired gel electrode (with 1 mm as the default thickness). The well formed by the gaskets were filled with gel electrode compositions. The well with gel electrolyte was covered with sodium-formed Nafion® ion-selective membrane (N211) and another gasket layer was placed on them with fine alignments. The second well was also filled with gel electrolyte and closed with the flat graphite block cathode side current collector. The sandwiched graphite block cell was fully enclosed using mechanical pressurization without leakage.

### Characterization

Transition electron microscopy (TEM) images for the samples with different state of charge (SOC) were conducted on FEI Titan at 300 kV. The quantitative of ⁶⁷Zn, ³⁹K and ¹H NMR spectra were recorded with single-pulse measurements at room temperature using 5-mm NMR tubes with a Varian liquid probe. The parent 3.75 M ZnCl₂ and saturated KI aqueous solution is used as reference (δᵢₛₒ=0 p.p.m.) to effectively monitor the chemical shift evolution with the charge/discharge process. Raman spectra were recorded with a Horiba LabRam HR Evolution spectrometer coupled with an inverted optical microscope (Nikon Ti-E) with a 40× objective and a 632.8-nm HeNe laser light source. A quartz cell was used for the Raman measurements. The viscosity of the sample was measured using an Anton Paar rheometer (MCR-102e; Ashland, VA, USA). DG26.7 SS measuring system coupled with a C-PTD200 cell was used. A Peltier system built in the rheometer was employed to control the temperature at 23C+/−0.2C. The shear rate range applied was from 0.1 to 100 s⁻¹. To ensure measurement quality, a performance check was conducted to the rheometer and measuring system using a certified viscosity standard S60 (Cannon Instrument Co., State College, PA, USA) before the sample measurements.

### Electrochemical and Battery Testing

The ion conductivity in Zn—I gel electrolyte and the electronic conductivity in Zn—I gel electrodes in various carbon black concentrations was investigated using electrochemical impedance spectroscopy (EIS). The galvanostatic charge/discharge was carried out in the voltage range of 0.45 to 1.55 V on an Arbin battery tester.

### AIMD Simulation

Ab initio molecular dynamics (AIMD) simulations were carried out by Vienna Ab initio Simulation Package (VASP). Electron-ion interactions were described by the projector-augmented wave (PAW) pseudopotentials with the cutoff energy of 400 eV. The exchange-correlation functional was represented using the Perdew-Burke-Ernzerhof generalized gradient approximation (GGA-PBE). The exchange-correlation functional with a Gaussian smearing width term of 0.05 eV was used. The convergence criterion for electronic self-consistent iteration was set to 1×10⁻⁵ eV. Long-range dispersion interaction was corrected by DFT-D3 method. The solvation structure of ZnCl₂+KI electrolyte was investigated using AIMD simulation in the canonical ensemble at 298 K. There are 15 ZnCl₂, 30 KI and 100 water molecules in the system. The density is set to experimental density. The constant temperature of the AIMD simulation systems was controlled using the Nose thermostat method with a Nose-mass parameter of 0.1. A time step of 0.5 fs was used in AIMD simulation. The gamma point sampling was used for the Brillouin zone. The ions and molecules were randomly inserted into the simulation box at initial state. The classical molecular dynamics (CMD) simulation was performed for 5 ns with Chemistry at Harvard Macromolecular Mechanics (CHARMM) force field. The transferable intermolecular potential 3P (TIP3P) water model was employed for water molecule. The system was pre-equilibrated for 5 ps and the production simulation time was 10 ps. The snapshots were generated by Visual Molecular Dynamics (VMD) software.

### CMD Simulation

Classical molecular dynamics (CMD) simulations were also performed to investigate the solvation structures and interactions in electrolytes with polymer. Two systems, i.e., ZnCl₂+KI solution and ZnCl₂+KI+xanthan gum (XG)polymer solution, were studied. The interaction parameters of salt (Zn, Cl and K ions), solvent (water) and XG polymer were obtained from Chemistry at Harvard Macromolecular Mechanics (CHARMM) force field. The parameter of iodine ion was obtained from Orabi's work. The number of repeat units is set to five for XG polymer in the simulation. As some of the function groups on the side chain of XG polymer are uncertain, only one carboxyl group was included on the side chain in the XG polymer model. According to the pH value in experiment, the carboxyl group was deprotonated, and additional K ions were added to keep the system neutral. The TIP3P water model was employed for water molecule.

All the CMD simulations were carried out with the GROningen MAchine for Chemical Simulations (GROMACS) simulation package. For the system with XG polymer, the polymer chains were separated in the simulation box. Then the solvent molecules and ions are randomly inserted into the simulation box according to the molar ratio in experiment. The steepest descent method was used to minimize the energy of the systems. The systems were pre-equilibrated in isothermal-isobaric (NPT) ensemble with 200 ns at 298K and 1 bar. The temperature and pressure were controlled by V-rescale thermostat and Berendsen barostat with a time constant of 0.2 and 1 ps. Then 400 ns (for no polymer system) and 1000 ns (for polymer system) production simulations were performed at 298K in canonical (NVT) ensemble. The temperature is controlled by the Nose-Hoover themostat with a time constant of 0.6 and 6 ps. The cutoff of the Lennard-Jones potential is 1.2 nm. The particle mesh Ewald method with a Fourier spacing of 0.15 nm and a 1.2 nm real-space cutoff are used for calculating electrostatic interactions. Periodic boundary conditions were used in all three directions. The time step is 2 fs. The bonds between H and other atoms were constrained by the LINCS algorithm.

### Results

An aqueous polymeric framework gel (PFG) battery was designed for LDES, in which the highly soluble redox-active materials are housed in a polymeric framework dispersed with carbon materials. The polymeric framework affords two critical functionalities in achieving LDES by offering two key functionalities. First, it forms a scaffold that supports localized, diluted electrolyte channels throughout the electrode's entire thickness. Second, the scaffold provides excellent structural flexibility and elasticity, allowing it to accommodate volume changes, phase transitions, and mechanical stresses caused by reversible redox reactions.

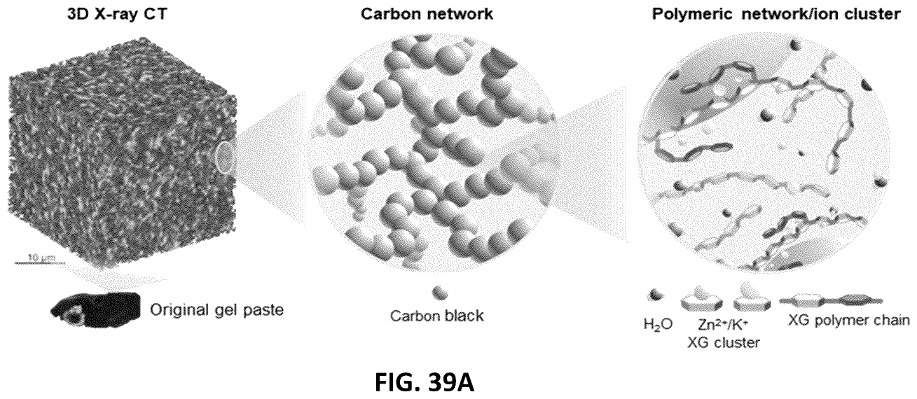

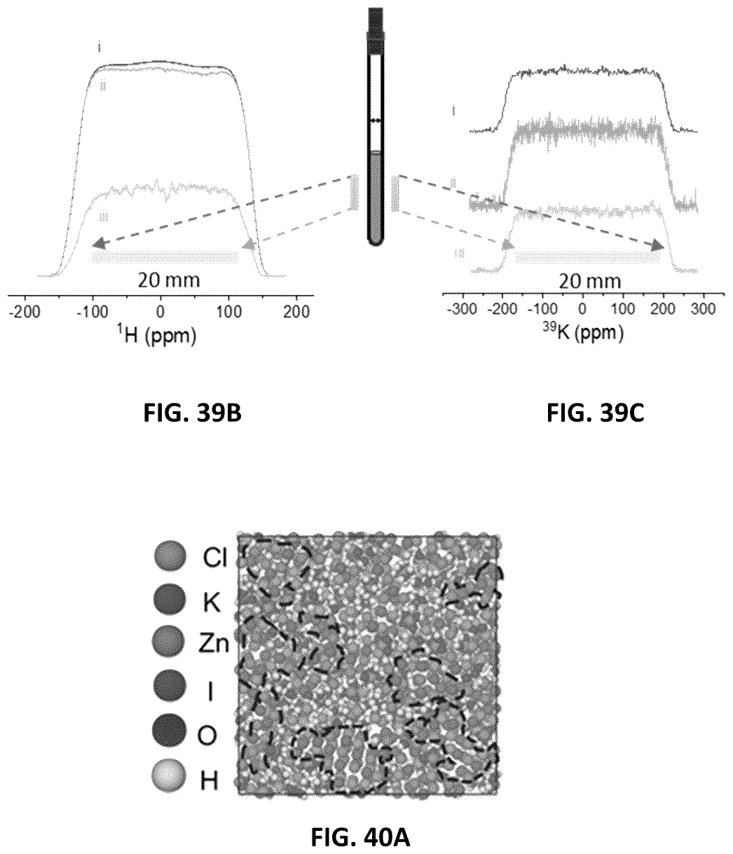

The design of the PFG battery is schematically shown in FIG. 39A, which is in symmetrical configuration, comprising zinc chloride, potassium iodide or potassium bromide, carbon black, and polymer, such as xanthan gum (XG). The demonstrated cell (1 mm thick electrode, ˜16.2 mAh/cm²) stably operated for 90 days with 0.15%/cycle capacity decay, with each cycle of ˜32-hour duration. The demonstrated thick electrode (2 mm thick electrode, ˜28 mA h/cm²) can significantly improve the electrode active material loading by minimizing the inactive component (e.g. current connector) ratio. It has been demonstrated that the current connector used in the gel battery of the present disclosure requires only about one-third of the conductor needed for a commercial LFP battery.

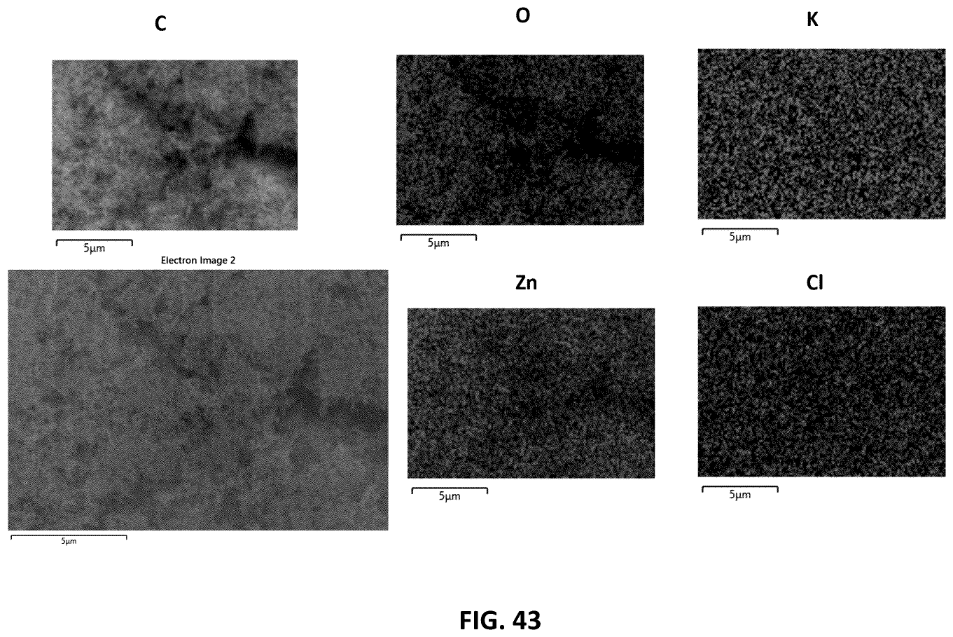

A homogeneous three-dimensional polymetric hydrogel framework is created using xanthan gum (XG), an environmentally friendly polysaccharide commonly used as a food additive. As proof of concept, the formulated redox active gel electrode in this study comprises 7.5 M KI and 3.75 M ZnCl₂ as active species for the anode and cathode, respectively. Additionally, the formulation includes a specified amount of carbon black (CB), 10 g water, and 0.45 g XG as the framework of the electrode, projecting energy density of ˜240 Wh/L based on the volume of cathode (FIG. 39A, left image). Hydroxyl groups and carbonyl groups from XG (XG structure shown in FIG. 9A) interact with water via H-bonding to form the hydration shell layer. Osmotic pressure from the water between the outer and inner hydration shells equilibrates with the elastic retraction force from the biopolymer chains to physically maintain the gel form, resulting in stable and homogenous distribution of the carbon particles within the hydrogel body and large water uptake in the PFG (FIG. 39A). Micro-scale CB particles are tangled with biopolymer chain, countering gravitational force for a uniform distribution (FIG. 39A, right image). 3D reconstructed CT image (FIG. 39A, left image) further confirmed a uniform distribution of carbon particle network, ensuring PFG electronic conductivity. The homogeneity of the constructed PFG electrode was experimentally analyzed by the Nuclear Magnetic Resonance (NMR) mapping (FIGS. 39B and 39C) and Cryo-plasma focused ion beam (FIB)-SEM-EDX mapping (FIG. 43), in which carbon, ions, and oxygen from water or polymer are uniformly mixed to obtain a homogeneous gel electrode. The NMR intensities of 1H (FIG. 39B) and ³⁹K (FIG. 39C) shift are almost constant along the wall of the NMR tube (scale: 20 mm) for each sample, also indicating that the electrolyte and water are uniformly distributed in the gel electrode.

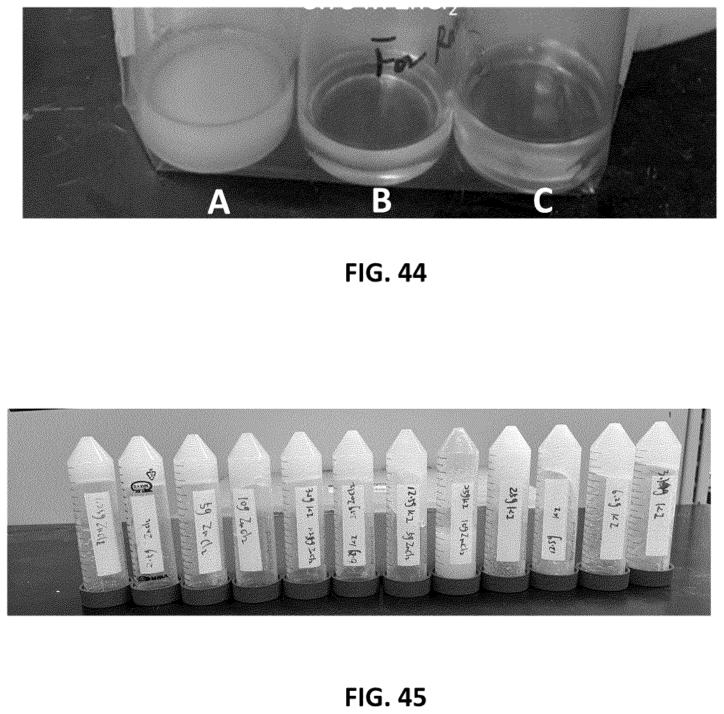

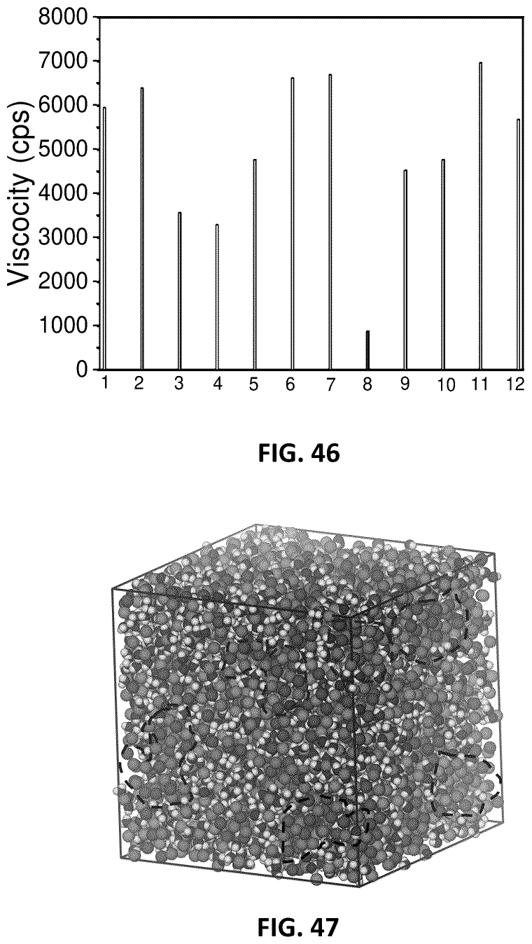

The electrolyte composition provides the pathway for ion diffusion but also significantly influences the electrochemical reactions for redox-active species. The redox active species in the demonstrated gel electrode are KI and ZnCl₂. On the same comparison scale, 25 g of KI cannot fully dissolve in 10 g of water (KI solubility at 25° C.: ˜15 g/10 g water), while an interesting phenomenon was observed that a mixture of 25 g KI, 10.2 g ZnCl₂, and 10 g water can achieve a homogenous aqueous solution state (FIG. 44). The same phenomenon of mixed salt effect was also observed in water and XG hydrogel sample (FIG. 45). More interestingly, with 0.45 g of XG and 10 g of water, a typical free-standing hydrogel can be obtained with the addition of either 25 g of KI or 10.2 g ZnCl₂. Yet when both 10.2 g of ZnCl₂ and 25 g of KI are added, the formulated gel electrolyte became more fluidic (FIG. 45). The viscosity of gel electrolyte (10 g of ZnCl₂, 25 g of KI, 10 g water, and 0.45 g XG polymer) decreased to ˜885 cp (FIG. 46), significantly lower than ZnCl₂ (˜6000 cp) or KI (˜5800 cp) hydrogel, respectively. Generally, the solubilization state of inorganic salt depends on available water coordination. Such unusual behavior of highly concentrated salt composition with sufficient fluidity, either in solution or in gel format, suggests that less water coordination is needed to reach the fluidic state. Mathematically, forced ion cluster/complex formation reserves coordination water.

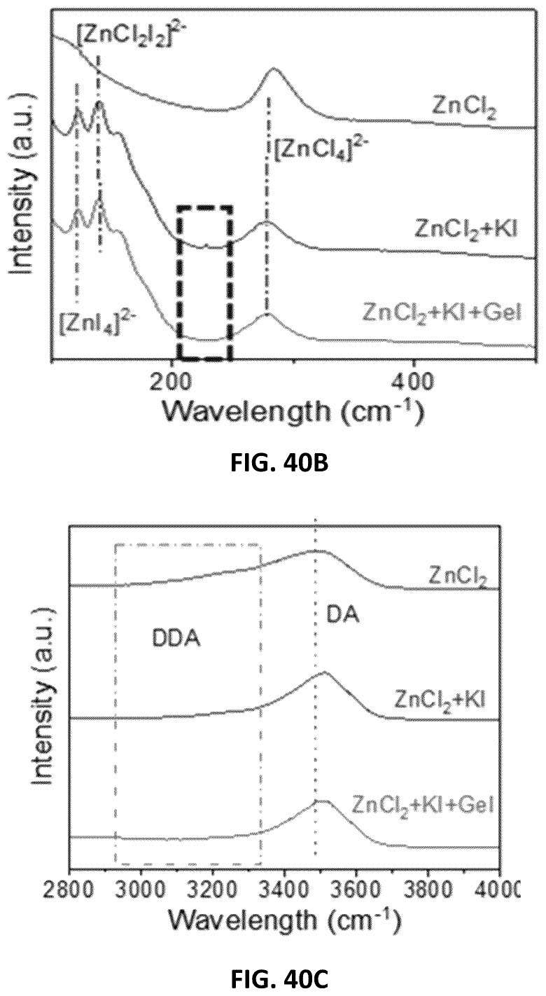

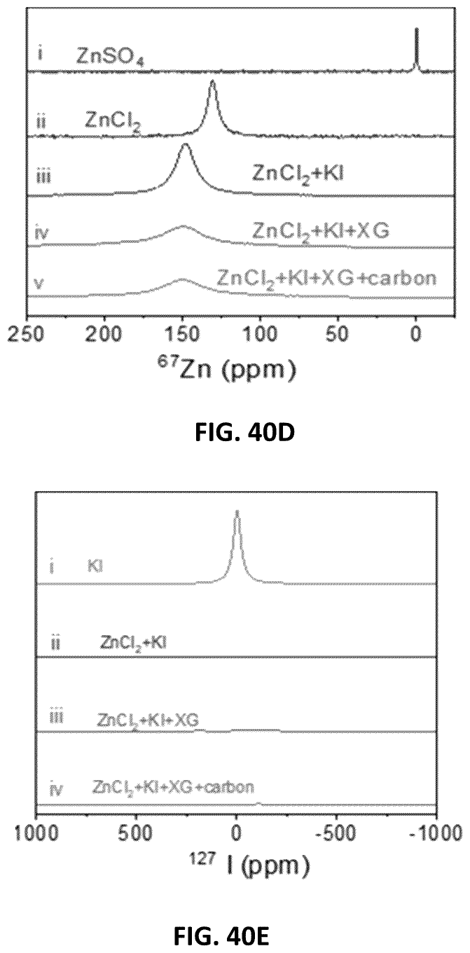

Therefore, simulation and experimental characterization were performed to confirm such ion cluster/complex formation, on both concentrated salt solution and the gel electrode with the same composition. In FIG. 40A and FIG. 47, an ordered structure formed with Zn, and K cations, and Cl, and I anions can be observed in the solution after 400 ns classic molecular dynamics (CMD) simulation. The halogen participated cluster was also observed in AIMD simulation. By statistical analysis of these formed clusters (circled in FIG. 40A) and solvated ions, each K⁺ has an average coordination number of 2.5 for I⁻, 1.5 for Cl⁻, and only 2.25 for water, in contrast to typical octahedral structure for K⁺ requiring 6 water molecules in dilute solution. Similarly, each Zn²⁺ has an average coordination number of 0.5 for I⁻, 1.75 for Cl⁻, and only 1.75 for water, as opposed to a typical solvation structure for Zn²⁺ requiring 6 waters in dilute solution, confirming the formation of K—Zn-halogen-water cluster and Zn-halogen complex.

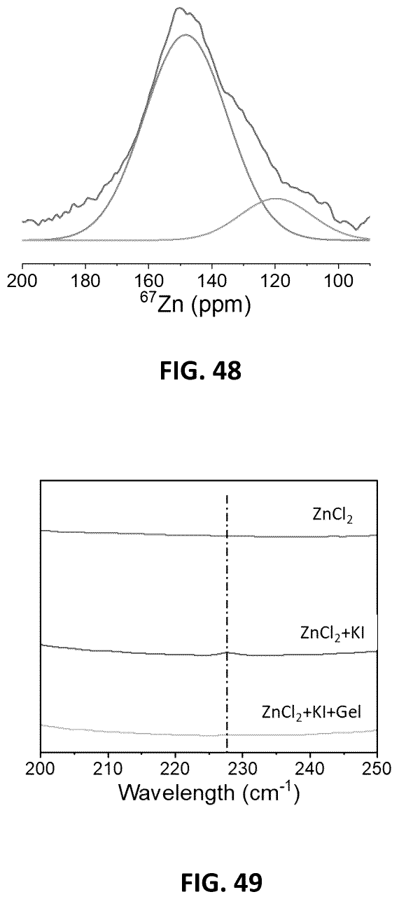

Such K—Zn-halogen-water cluster/Zn-halogen complex was experimentally confirmed with ⁶⁷Zn NMR and ¹²⁷I NMR, as well as Raman. [ZnCl₄]²⁻, [ZnCl₂I₂]²⁻, and [ZnI₄]²⁻ complex were observed at 290 cm⁻¹, 139 cm⁻¹ and 128 cm⁻¹ in Raman spectroscopy (FIG. 40B), respectively, from both 3.75 M ZnCl₂/7.5 M KI salt solution and gel electrolyte, further confirming the formation of the Zn-halogen complex. In addition, compared to 3.75 M ZnCl₂, only a small fraction of DDA (double donor-single acceptor, only existing in the hydrogen-bond network of free water cluster) peaking around 3200 cm⁻¹ and enhanced DA (single donor-single acceptor) peaking around 3500 cm⁻¹ could be observed (FIG. 40C) in both 3.75 M ZnCl₂/7.5 M KI salt solution and gel electrolyte, suggesting that most of water in 3.75 M ZnCl₂/7.5 M KI salt solution and gel electrolyte was confined in the salts. Shown in FIG. 40D, fully solvated Zn²⁺ is referenced at 0 ppm with ZnSO₄ baseline. Zn—Cl-water complex was observed at 135 ppm in 3.5 M ZnCl₂ control sample. While in the 3.75 M ZnCl₂/7.5 M KI salt solution, Zn chemical shift resided at ˜150 ppm, potentially caused by the oligomerization of the complex (reservation of coordination water), forming a larger size cluster. While with the presence of XG in 3.75 M ZnCl₂/7.5 M KI salt solution, the Zn-halogen-water cluster/complex was observed at 145 ppm, indicating that the addition of XG can reduce the cluster size. A shoulder peak at a higher field region (120 ppm) (FIG. 48) was also observed, which was attributed to anchored Zn through cluster/complex-polymer interaction. The cluster/complex-polymer interaction was also demonstrated by the absent small peak of [ZnI₂(OH)₂]²⁻ at 280 cm⁻¹ (FIG. 49) in 3.75 M ZnCl₂/7.5 M KI gel electrolyte compared to 3.75 M ZnCl₂/7.5 M KI salt solution as OH⁻, coordinated with Zn²⁺ in [ZnI₂(OH)₂]²⁻, can be replaced by oxygen from XG polymer chain. By peak deconvolution of ⁶⁷Zn NMR spectra (FIG. 48), the peak associated with the anchored Zn consisted of around 10%±5% of the overall population of Zn. A high binding energy (−42.88 kcal/mol) between Zn²⁺ and carboxylate on polymer was obtained by density functional theory (DFT) (Table 3), corroborated with the observed “immobilized” Zn cluster/complex. ¹²⁷I NMR results also support the formation of the K—Zn-halogen-water cluster. Shown in FIG. 40E, in pure KI solution, solvated I can be observed as a sharp peak. While in the ZnCl₂/KI highly concentrated solution, I⁻ ion was dynamically exchanging between K—Zn-halogen clusters, causing the I signal to broaden down to the baseline. This observation illustrated a dynamic movement of ions in the clusters, exerting a similar effect to the high-entropy electrolyte.

TABLE 3
Binding energy for among different ions

| Binding energy (kcal/mol) | K⁺ | Zn²⁺ |
|---|---|---|
| H₂O | −49.11 | −114.56 |
| Cl⁻ | −31.76 | −135.19 |
| I⁻ | −36.71 | −119.9 |
| OH (D-mannose) | | |
| COO⁻ (Ac⁻) | −11.27 | −42.88 |

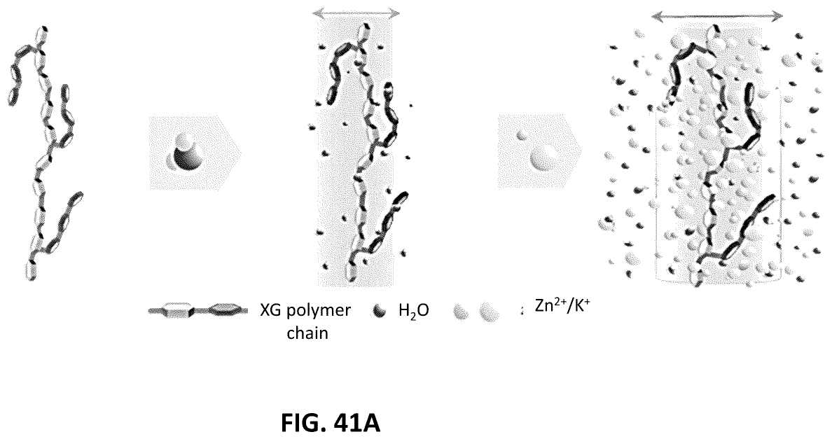

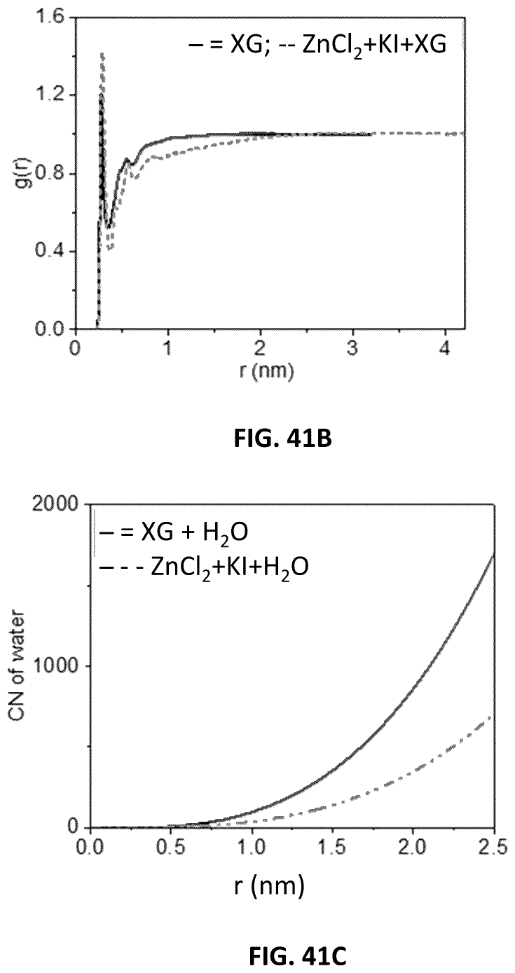

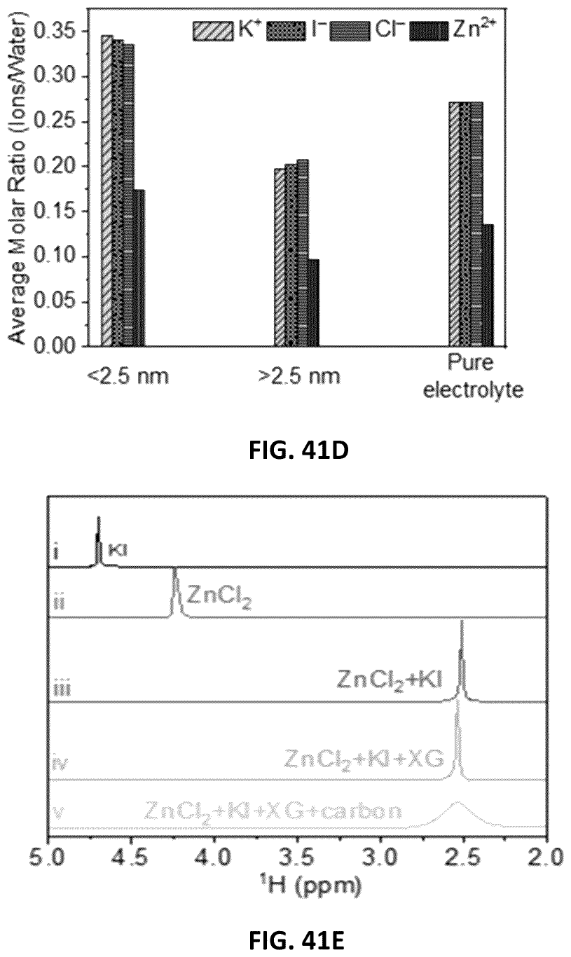

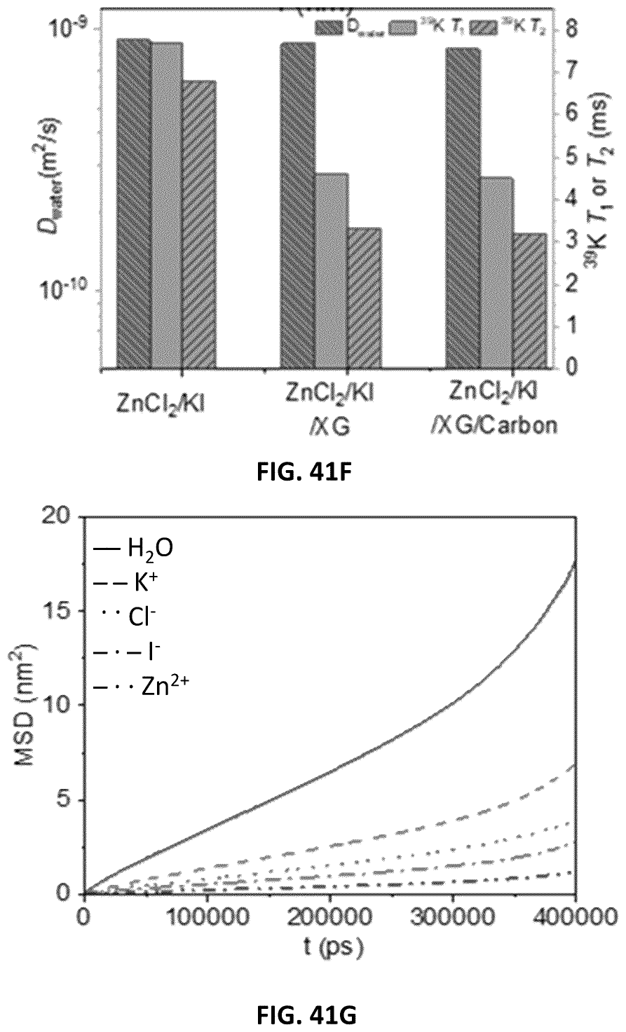

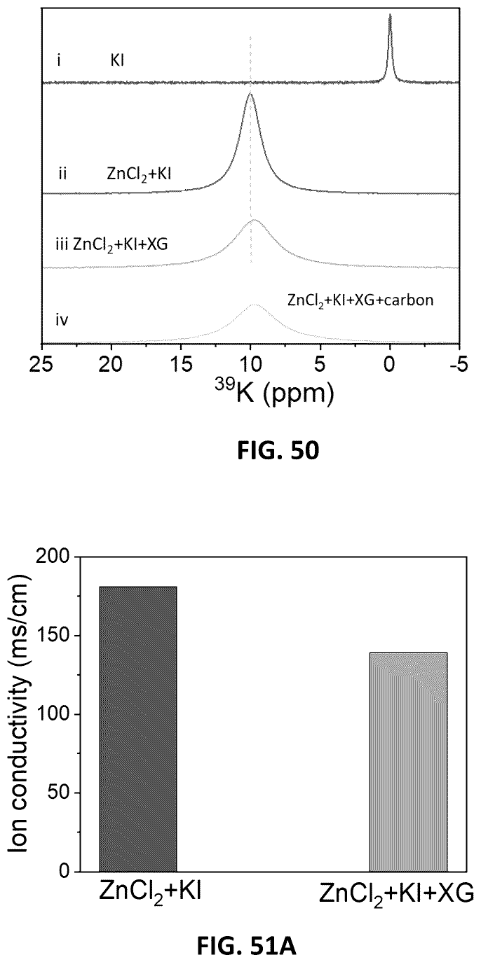

Chaotropes are a class of ions, e.g., I⁻, that have less interaction with water compared to water with itself based on the Hofmeister series. Super-chaotrope e.g., polyoxometalates, due to larger cluster size and smaller charge density, tend to absorb onto polar surfaces. Similarly, the dynamic exchanging ion clusters can be chaotropic in the hydrogel. Such chaotropic K—Zn-halogen-water clusters are polarizable and tend to adsorb onto polar surfaces of XG polymer. By the above-mentioned ⁶⁷Zn NMR, around 10% of the population of Zn was observed interacting with the polymer. Furthermore, by analyzing ³⁹K NMR (FIG. 50), a significant change was observed for the gel electrolyte as compared to the baseline concentrated salt solution. A 0.4 ppm low-frequency shift of K⁺ and line broadening also suggests the interaction between ion cluster and polymer chain, which would release the coordination water from ion clusters. To elucidate the effects of the absorbance of large ion clusters onto the polymer surface, CMD was adopted to simulate water and ions clusters behaviors before and after mixing high-viscosity XG polymer water gel with 3.75 M ZnCl₂ and 7.5 M KI (FIG. 41A), and radial distribution function values (FIG. 41B) for O_{polymer}-O_{water} was firstly simulated by CMD. Shown in FIG. 41B, the thickness of the hydration shell (the largest distance between O_{polymer}-O_{water}) is ˜1 nm for XG and water (FIG. 41A, middle image) and 2.5 nm for XG, 3.75 M ZnCl₂ and 7.5 M KI (FIG. 41A, right image), respectively. For the salt containing gel electrolyte, the number of water molecules (FIG. 41C) within the hydration shell (2.5 nm radius) around the polymer chain is approximately 700, whereas for the hydrogel without 3.75 M ZnCl₂ and 7.5 M KI, it is almost 1700 in the same range of 2.5 nm radius, clearly showing that K—Zn-halogen-water cluster has a higher preference for coordinating the polymeric chain. The average ion-water-concentration ratio (FIG. 41D) inside the hydration shell (<2.5 nm) of the polymer chain is ˜0.34 for K⁺, Cl⁻ and I⁻ as well as ˜0.17 for Zn²⁺, which is higher than pure 3.75 M ZnCl₂ and 7.5 M KI solution (˜0.27 for K⁺, Cl⁻ and I⁻; 0.135 for Zn²⁺). Consequently, the electrolyte with a lower average ion-water-concentration ratio can be formed outside of the hydration shells of the polymer (>2.5 nm) (˜0.20 for K⁺, Cl⁻ and I⁻; 0.1 for Zn²⁺). In summary, the absorbance of large ion clusters onto the polymer surface causes the release of some water from the hydration shell of the polymer and the coordination water of the ion clusters, and an observed ¹H NMR high-frequency shift also supports such release of coordination water to dilute the electrolyte outside the hydration shell (FIG. 41E). The concentration gradient near the hydration shell of polymer (FIGS. 41A, right image; and 41D) clearly suggest that the polymeric chain is essentially a “diluent”, which provides coordination with ion clusters and releases coordination water. The net effect leads to a more fluid-like behavior of the formulated electrolyte with more free water, resulting in the formation of “localized diluted electrolyte” (LDE) (compositional analogy but functionally reverse to the “localized high concentration electrolyte”).

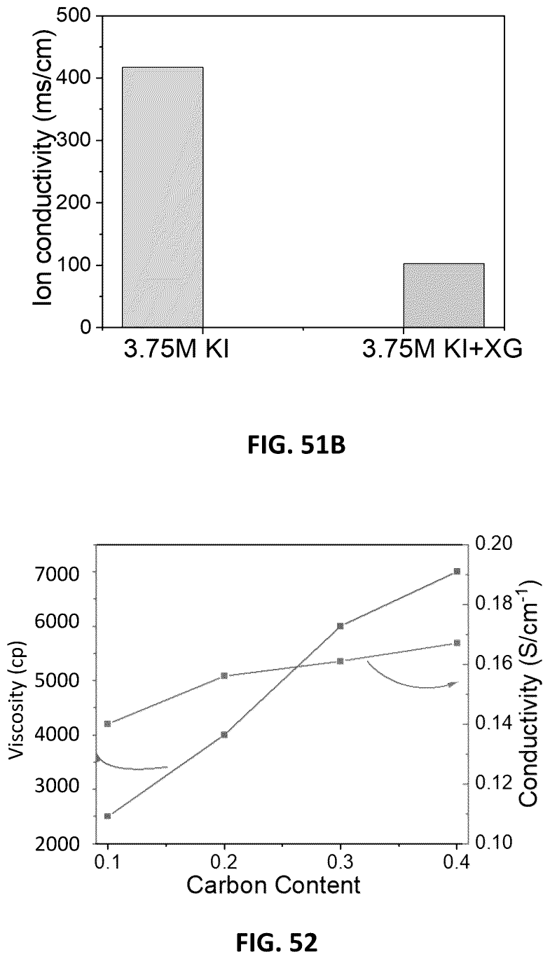

The gel electrolyte with such LDE effects is estimated to achieve intriguingly fast water diffusion and ion conductivity even on par with pure solution phase electrolyte, as elaborated below. The water outer the hydration shell acts as the water channel (FIG. 41A, right image) for ion transport inside the polymeric framework. As shown in FIG. 41F, the highly concentrated salt solution is used as baseline (diffusion coefficient number 9.08×10⁻¹⁰ m²/s). Surprisingly, the formulated gel electrolyte exhibited water diffusivity on par with a concentrated salt solution. With XG in formulation, the water diffusion coefficient was measured at 8.77×10⁻¹⁰ m²/s. Even with CB, water diffusion coefficient still achieved 8.36×10⁻¹⁰ m²/s. This highly free water channel sets the stage for an electrochemical reaction on the same scale as in solution-phase, which is crucial for thick electrodes. The measured ion conductivity (FIGS. 51A and 51B) of the formulated gel electrolyte was ˜139 ms/cm, comparable to the concentrated salt solution (˜181 ms/cm). For the 3.75M/L KI gel electrolyte without LDE effect, the ion conductivity significantly decreased from 417 ms/cm for 3.75M/L KI salt solution to ˜103 ms/cm. The comparable ion conductivity strongly indicated that LDE effects can enable the gel electrolyte to achieve a high ion conductivity similar to that of the pure solution phase electrolyte.

In addition to the free water channel in the diluted region, the dynamically exchanging ion clusters with high entropy also contribute to fast ion transport. In the system, the ions are dynamically exchanging between clusters and solvated ions (FIG. 40A), introducing disorder to the system. The increased disorder results in weak water coordination with ions/ion clusters, thus decreased reorganization and enhance ion transport. By DFT calculation, Zn²⁺ has a much strong bonding with carboxylate (Table 3) and the concentration of K⁺ is twice than that of Zn²⁺. Thus, K⁺ was attributed as the major charge carrier for electrochemical redox reaction due to its faster ion diffusion (FIG. 41G). The fast water diffusion compared to ion diffusion further confirm the LDE effects, which support high ion conductivity in gel electrolyte, while the lowest Zn²⁺ ion diffusion also confirm that Zn²⁺ was immobilized on the polymer chain through the interaction between Zn cluster/complex and polymer chain, which corroborated with the NMR results (FIG. 40D).

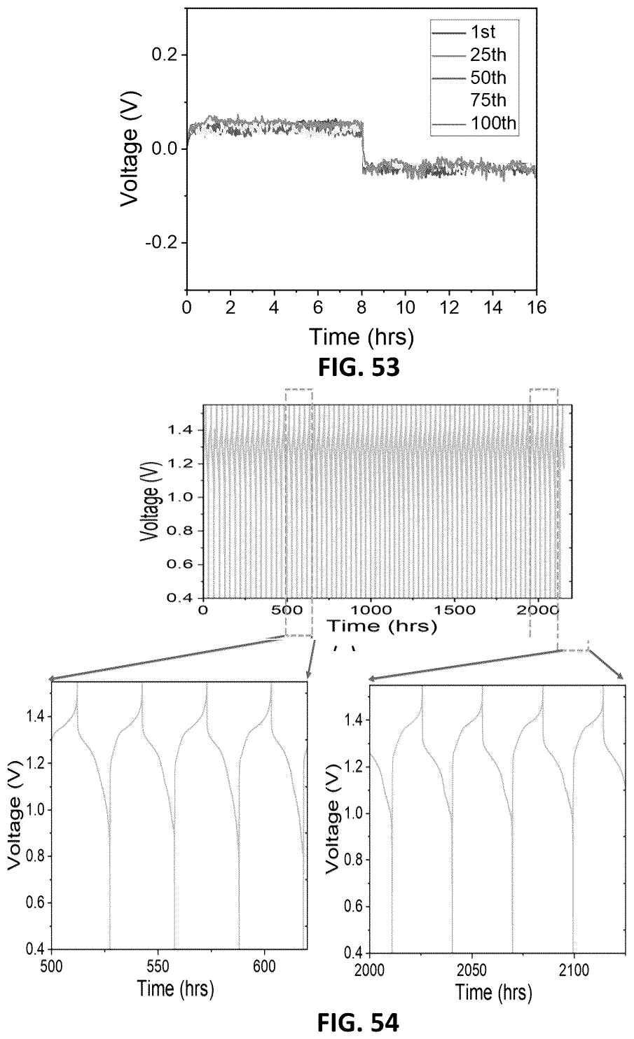

The PFG composition (e.g., CB content, Table 4) was optimized to reach an optimal balance between electronic conductivity and ionic conductivity. With increased CB content, the monolithic 3D PFG electrode exhibited increased electronic conductivity (FIG. 52), while when the carbon content increased to 0.4 g carbon/10 ml, the gel electrode reached the highest electronic conductivity of ˜0.167 S/cm⁻¹, which is comparable with LiCoO₂/Super P carbon composite. While mass transfer decreased due to the tortuosity introduced by CB into the bi-continuous polymeric farmwork, which ultimately segregates the free water channel, leading to lower ionic conductivity and increased viscosity (FIG. 52). At the low frequency regime in EIS, a smaller slope with CB at 0.4 g carbon/10 ml was observed, confirming slower active species mass transfer. PFG with CB at 0.3 g carbon/10 ml delivered optimal performance, with 91% EE at 1 mA/cm² and 86% EE at 2 mA/cm², respectively. An extremely low overpotential of ˜50 mV was observed for zinc plating/string in zinc symmetric cell testing with an electrode thickness of 1 mm (FIG. 53), confirming the effectiveness of the LDE effect on supporting fast ion transport thus decreasing cell polarization. It is interesting that PFG electrode with CB at 0.3 g carbon/10 ml still delivered as high as ˜99.5% CE at the current density of 2 mA/cm². The CE of ˜99.81% at 1 mA/cm² is higher than conventional Zn—I₂ flow battery and Zn—MnO₂ static battery.

TABLE 4
Summarized Composition of Zn—I electrode (total
volume is of gel electrode: about20 ml; salt concentration:
about 3.75M ZnCl₂ and about 7.5M KI)

| | | | | Conducting | |
|---|---|---|---|---|---|
| | | | | agents | |
| | Ion Source | | Binder | Carbon | Electrolyte |
| Sample# | ZnCl₂ (g) | KI (g) | XG (g) | Black (g) | Water (ml) |
| CB_0.1 | 10.22 | 25 | 0.45 | 0.1 | 10 |
| CB_0.2 | 10.22 | 25 | 0.45 | 0.2 | 10 |
| CB_0.3 | 10.22 | 25 | 0.45 | 0.3 | 10 |
| CB_0.4 | 10.22 | 25 | 0.45 | 0.4 | 10 |

Capacities in CB 0.2 and CB 0.3 at low current densities (1 mA cm⁻² and 1.5 mA cm⁻²) achieved almost 0.14 Ah while capacity of CB 0.4 dropped to 0.12 Ah despite in low current densities (1 mA cm⁻²). The big difference in voltage plots was high polarization without plateau in CB 0.4 while the polarization in CB 0.2 and CB 0.3 were similar in low current densities (0.1˜0.11 V at 1 mA cm⁻² and 0.14 V and 0.15 V at 1.5 mA cm⁻²), and CB 0.3 had ˜70% of smaller polarization at high current density (0.18 V in CB 0.3 and 0.25 V in CB 0.2). This polarization difference indicated that the CB 0.4 suffered from the lack of ions though low current density, was further disabled to run in high current, 2 mA cm⁻². While capacity of CB 0.2 dropped to 0.12 Ah at high current density as well, this seemed to be due to the electro conductivity issue, supported by voltage drop at initial stage of discharge process, corresponding to internal resistance drop.

The charge transfer resistance in mid frequency region decreased as the carbon black contents increased. The charge transfer resistance in CB 0.1 gel electrode (represented by squares) could be considered infinite, indicating the impossibility to charge transfer so this CB 0.1 gel electrode was not tested further for cell performance. CB 0.2 (represented by circles) and CB 0.3 (represented by triangles) had smaller charge transfer resistance so conducting agent over 0.02 g ml⁻¹ could percolate to allow electrons to travel along much faster and provide electrons to the electrode surface despite their mobile phase electrode. The largest conducting agent condition, CB04, had very small charge transfer resistance, similar to capacitor behavior in the enlarged plot (represented by inverse triangles). High carbon contents allow interface resistance to minimize as well as the ohmic resistance, which is the total resistance of ionic resistance of electrolyte, intrinsic resistance of substrate, and contact resistance between the active material and the current collector. The highest carbon content, CB 0.4 had the lowest ohmic resistance (˜0.06 ohm cm⁻²), followed by CB 0.3, and CB 0.2. The lower slope in CB 0.4 indicates slower ion diffusion compared to CB 0.2 and CB 0.3 due to higher viscosity and tortuosity in higher concentration gel electrodes. Though slower in ion diffusion, the ohmic resistance was smaller because of the much smaller contact resistance with the current collector and substrate in high conducting agent concentration. It is expected that the other conducting agents, such as graphene sheet, reduced graphene oxide, carbon nanotubes or MXene, would have similar roles and features in the gel electrode system. Electronic conductivity of gel electrode is measured using EIS. As the carbon content increased from 0.2 g carbon/10 ml to 0.4 g carbon/10 ml, the electronic conductivity of the gel electrode increased, while viscosity also increased to ˜7000 cp.

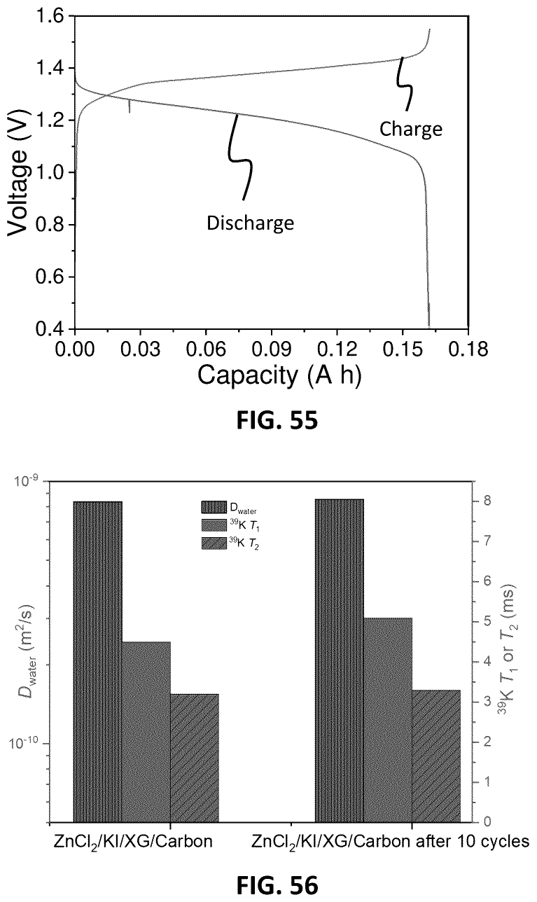

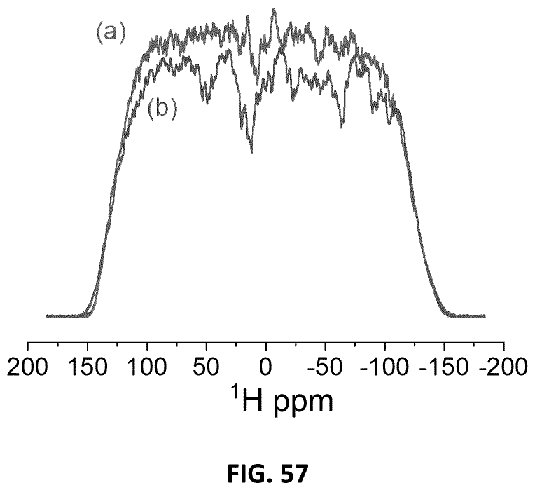

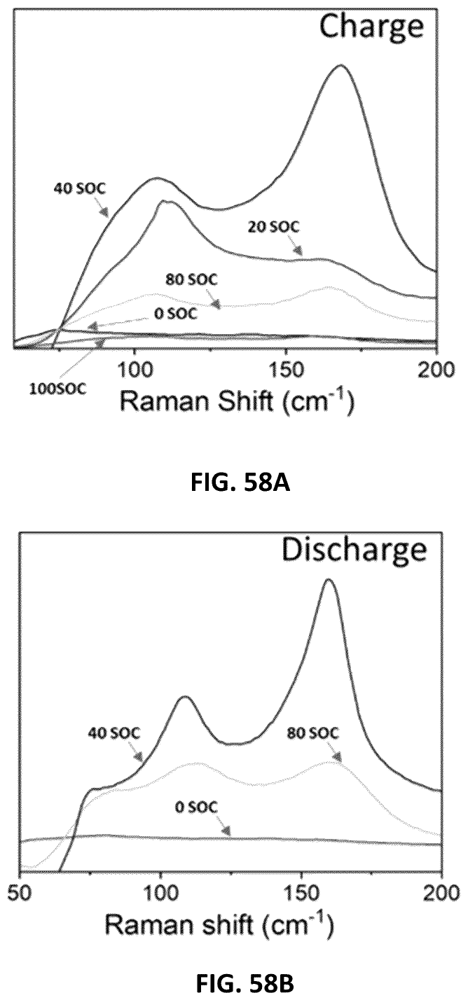

FIG. 54 shows the long-term cycling test of a 1-mm PFG electrode. Under galvanostatic cycling of 1 mA/cm² (a typical current density for Zinc/MnO₂ batteries), each charge/discharge cycle for the PFG battery takes ˜32.4 hrs due to an extradentary area capacity of ˜16.2 mAh/cm² (FIG. 55). The cell maintained around an average of 99.4% CE and 86.5% EE during 2000 hrs (˜90 days) of testing. The first discharge capacity utilization reached 90% of theoretical capacity. The cell exhibited 0.15%/cycle capacity decay across 90-day operation, with each cycle duration of >30 hours. The PFG electrode was ex-situ examined with CB 0.3 g carbon/10 ml after 10 cycles (˜13 days) with NMR (FIGS. 56 and 57). The near-identical NMR spectra confirmed the structure integrity and stability of the electrode and water channel. The superior cell stability can also benefit from PFG regulation on Zn deposition. As shown in FIG. 39A, the PFG electrode has a bi-continuous porous structure, with CB particles homogeneously dispersed in the system. Shown in FIG. 24, Zn particles formed along CB particle surface instead of dendrite-type deposition after cyclic test. Similar behaviors of Zn deposition plates, more parallel to the carbon surface, could be observed as the state of charge (SOC) increased to 100% during the first charge process (FIG. 16). Within the framework electrode, CB particles are the only electronically conducting constitute. The Zn deposition thus is confined on the surface of CB particles, which are homogeneously dispersed by a soft polymer framework. A similar effect on dendrite-free zinc deposition was also reported by Pan et al., using PEO polymer as an additive. The CB/polymer surface-directed deposition prevents the formation of zinc dendrites, thus resulting in a high CE and improved electrode stability. The high CE and long-term durability will be also benefit from the highly reversible reaction of I⁰/I⁻. For the redox reaction of I⁰/I⁻ at the positive electrode, I³⁻ (˜110 cm⁻¹) and I⁵⁻ (˜160 cm⁻¹) are observed as redox intermediates (FIGS. 58A-58B). During the initial charging period, the intensity of I³⁻ and I⁵⁻ gradually increases but then decreases in the later stage. When the battery is charged to the upper voltage, the Raman peaks of I³⁻ and I⁵⁻ disappear, indicating the complete conversion of the generated polyiodides into I₂. During the discharge process, the disappearance of the Raman peaks corresponding to I³⁻ and I⁵⁻ at the end of discharge highlights the complete conversion of I₂/I⁻, further indicating that the redox reaction of I₂/I⁻ can successfully proceed with LDE.

FIGS. 58A and 58B show ex situ Raman spectra of I³⁻ and I⁵⁻ for the positive gel electrode at different SOCs during the charging process (FIG. 58A) and discharging process (FIG. 58B). The Raman peaks of charged gel electrodes located at 110 cm⁻¹ and 160 cm⁻¹ are associated with polyiodides I₃⁻ and I₅⁻, respectively. The intensity of polyiodides I₃⁻ and I₅⁻ increases at the initial charging period. When SOC increases to ˜40%, the intensity for the band at 110 cm⁻¹ belonging to triiodide anions decreased, while the intensity for the band at 160 cm⁻¹ significantly increased, indicating that the formation of I⁵⁻ species increased. As SOC further increased to 80% and 100%, the intensity of polyiodides I₃⁻ and I₅⁻ significantly decreased due to the formation of I₂. Therefore, Raman spectra of the positive gel electrode at different SOCs clearly demonstrates that the polyiodides in gel electrode decompose to I₂. The process of I₂ being reverted to I⁵⁻ and I³⁻ could be observed in the discharge process.

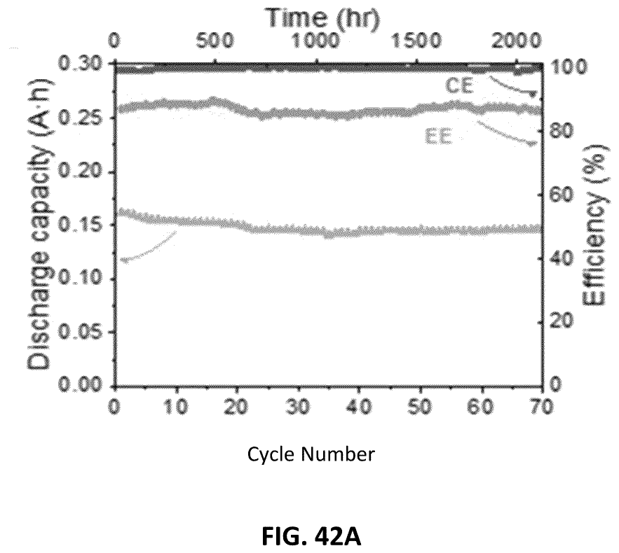

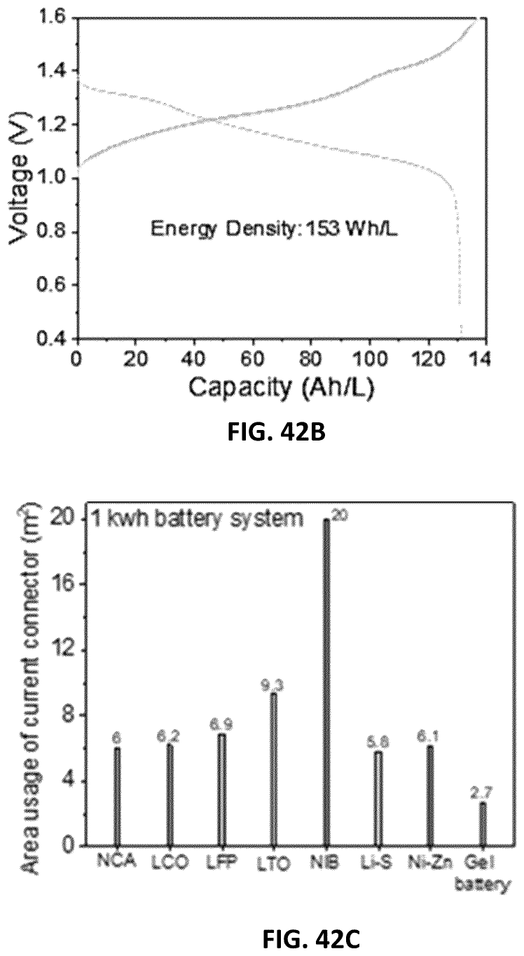

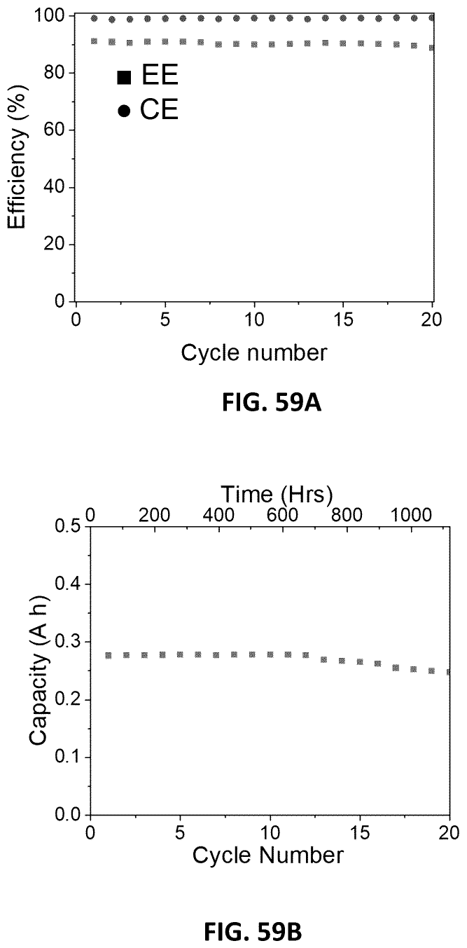

The LDE effect was further investigated by increasing the electrode thickness to 2 mm (30 times thicker than conventional Zn—MnO₂ static battery). With the same PFG electrode composition (CB 0.3 g carbon/10 ml) and under the same testing conditions (1, 1.5 and 2 mA cm⁻², FIG. 42A, and Table 5), the cell capacity was proved proportional to electrode thickness, validating the free water channel (FIG. 41A, right image) in LDE across the monolithic PFG electrode supporting fast ion transport even with extremely thick (2 mm) electrode. The cell exhibited 99.13% CE and 90.06% EE at 1 mA cm⁻², respectively (Table 5). The cell stably operated for ˜47 days (20 cycles) with a capacity decay of 0.35%/cycle, with each cycle duration of 56 hrs (FIGS. 59A and 59B). To push the energy density limit, a cell employing 0.5-mm PFG anode (7.5 M ZnCl₂) and 1-mm PFG cathode (7.5 M KI and 3.75 M ZnCl₂) was fabricated. Based on the measured discharge capacity, the Zn—I₂ gel battery reached ˜153 Wh/L (calculated based on the total volume of the anode and cathode) (FIG. 42B), which is comparable with Ni—Zn and lithium titanium oxide batteries.

TABLE 5
CE and EE comparison for gel electrode with
1 mm or 2 mm thickness at 1, 1.5 and 2 mA/cm²

| | | | | |
|---|---|---|---|---|
| Current | CE | CE | EE | EE |
| density | (1 mm) | (2 mm) | (1 mm) | (2 mm) |

| | | | | | |
|---|---|---|---|---|---|
| 1 | mA/cm² | 99.81 | 99.13 | 91.09 | 90.06 |
| 1.5 | mA/cm² | 99.63 | 98.74 | 89.53 | 88.79 |
| 2 | mA/cm² | 99.46 | 98.07 | 86.25 | 85.24 |

FIGS. 59A and 59B are plots that show cycling performance, coulombic efficiency (CE), energy efficiency (EE), and capacity, of 1 mm and 2 mm CB 0.3 gel electrode. The CB 0.3 gel electrode was selected because CB concentration is high enough for percolation but not too condensed for ion penetration. and achieved 0.28 Ah with 2 mm electrode, twice the capacity of 1 mm electrode at all current density tested (1, 1.5, and 2 mA cm⁻²). CE also reached 99.13% at 1 mA cm 2 and 98.07% at 2 mA cm 2 while EE slightly dropped from 90.06% at 1 mA cm⁻² to 88.79% 1.5 mA cm⁻² with larger polarization, but still maintained over 85.24% at 2 mA cm². FIG. 59B shows cycling performance for 2 mm electrode for 20 cycles at 1 mA cm⁻², demonstrating that the CE and EE were stable for 20 cycles with almost twice capacity of the 1 mm electrode.

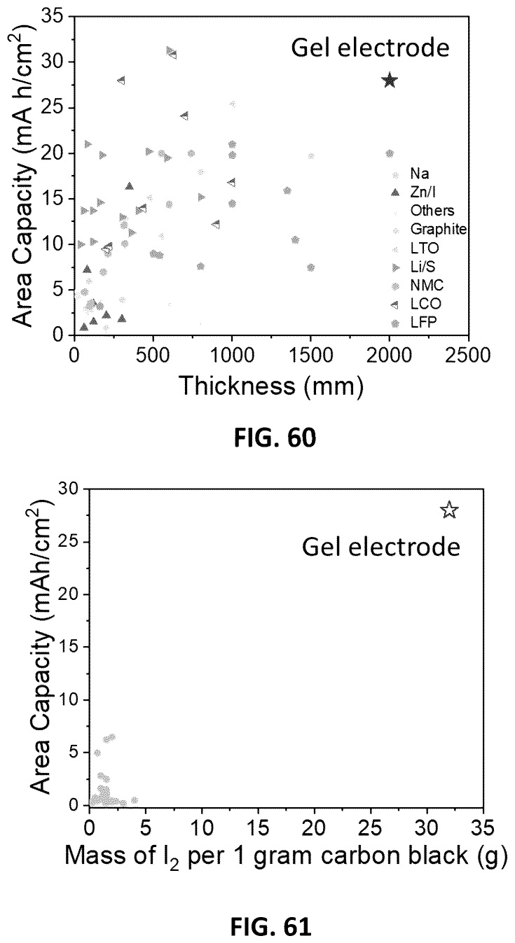

The gel battery not only showed a higher energy density but also exhibited a higher area capacity with a thicker electrode, even when compared to a lithium-ion battery. FIG. 60 summarizes the comparisons of the thickness and relate area capacity reported in the literatures. The thickness of the gel electrode is the thickest among all reported cases using low-cost carbon powder as conductive agent so far, which can significantly improve the electrode active material loading thus decreasing the inactive component ratio, e.g., current connector. FIG. 42C compares the area usage of current connector across different commercial rechargeable batteries with the same energy. The usage of current connector with the same energy is defined as the total energy for specific battery system divided by the area energy density, which can be estimated by Equation (5):

$$Area Energy density ( \frac{wh}{{cm}^{2}} ) = Area capacity ( A \frac{h}{{cm}^{2}} ) * average voltage ( V ) \qquad ( 5 )$$

Therefore, the area usage of current connector could be described by Equation (6):

$$Area usage of current connector ( {cm}^{2} ) = \frac{The total energy for specific battery system ( wh )}{Area Energy density ( \frac{wh}{{cm}^{2}} )} \qquad ( 6 )$$

The current connector for a 1 kw sodium ion battery (NIB) system needs ˜20 m² (Table 6) whereas the disclosed zinc iodine gel battery with a thickness of 2 mm, only requires 2.7 m², which is about 1/7 of the current conductor needed for a commercial NIB battery. However, the utilization of a Nation® membrane is observed to increase the overall expense of the battery system.

In summary, gel electrode comprising a polymeric framework scaffold with high mixed ion and electronic conductivity was successfully developed for Zn-based gel batteries. K—Zn-halogen-water cluster/Zn-complex, a unique composition structure in gel electrode, can be absorbed on polymer chain, resulting in the release of water and the dilution of localized electrolyte outside of the hydration shell of the polymer chain, which enables faster ion diffusion in gel electrode and allows the use of a thicker electrode. Besides, high entropy gel electrolyte maintains the fast ion exchange between cluster and free water channel, further supporting the fast ion diffusion. Based on fast ion diffusion and high electronic conductivity, the Zinc iodide gel battery with 2 mm electrode thickness delivers an extremely high area capacity of ˜28 mAh/cm² (the highest area capacity for Zinc iodide battery using carbon black as conduct agent, FIG. 61) at the full cell level, which enables lowering the usage of the current connector and other supplies.

TABLE 6
Summary of area capacity, average voltage, area energy density,
and area usage of current connector for different rechargeable batteries
Area energy density, and area usage of current connector is
calculated from Equation 5 and 6, respectively.

| | | | | Area |
|---|---|---|---|---|
| | | | Area | Usage of |
| | | | Energy | Current |
| | Area | Average | Density | Connector |
| | Capacity | Voltage | (mwh/cm²) | (m²) |
| | (mAh/cm²) | (V) | Equation 5 | Equation 6 |
| Gel Battery | 28 | 1.3 | 36.4 | 2.7 |
| NCA | 4.5 | 3.7 | 16.65 | 6.0 |
| LCO | 4.5 | 3.6 | 16.2 | 6.2 |
| LFP | 4.5 | 3.2 | 14.4 | 6.9 |
| LTO | 4.5 | 2.4 | 10.8 | 9.3 |
| NIB | 2 | 2.5 | 5 | 20.0 |
| Li—S | 8 | 2.15 | 17.2 | 5.8 |
| Ni—Zn | 10 | 1.65 | 16.5 | 6.1 |

In view of the many possible embodiments to which the principles of the present disclosure may be applied, it should be recognized that the illustrated embodiments are only examples of the present disclosure and should not be taken as limiting the scope. Rather, the scope of the invention is defined by the following claims. We therefore claim as our invention all that comes within the scope and spirit of these claims.

We claim:

1. A gel electrode, comprising:
a conductive material; and
an electrolyte comprising a polymer, an electroactive material, and a solvent;
wherein the polymer and the solvent form a gel, and wherein the conductive material and the electroactive material are dispersed in the gel.

2. The gel electrode of claim 1, wherein the polymer comprises a hydrophilic side chain.

3. The gel electrode of claim 2, wherein the hydrophilic side chain comprises an amino group, a hydroxyl group, an amide group, a sulfonic acid, a sulfonate group, an organosulfate group, a carboxylic acid, a carboxylate group, a phosphoric acid, a phosphate group, a phosphorous acid, a phosphonate group, —SO₃Z, —CO₂Z, —(CH₂)ₘPO₃Z₂, X, —NR′₃⁺, —NO₂, —SO₂R′, —CN, —CX₃, —COX, —C(H)O, —C(O)R′, —C(O)NH₂, —C(O)NHR′, —C(O)NR′₂, —N═O, —OR′, —(CH₂CH₂O)ₚR′, or any combination thereof, wherein each R′ independently is H, aliphatic, or heteroaliphatic; X is halo; each Z independently is a counterion with a +1 charge; m is an integer from 0 to 10; and p is an integer from 1 to 10.

4. The gel electrode of claim 1, wherein the polymer is xanthan gum (XG), chitosan, gelatin, iota-carrageenan (IC), cellulose, carboxyl methyl cellulose, polyacrylic acid (PAA), polyvinyl alcohol (PVA), or polyvinyl acetate.

5. The gel electrode of claim 1, wherein the conductive material is a conductive carbon material selected from carbon powder, a carbon nanotube, or a carbon fiber, or any combination thereof.

6. The gel electrode of claim 1, wherein the solvent is water, an organic solvent, or a mixture thereof.

7. The gel electrode of claim 1, wherein the electroactive material is an organic electroactive material, an inorganic electroactive material, or a combination thereof.

8. The gel electrode of claim 1, wherein the electroactive material is an inorganic electroactive material comprising Zn, Zn²⁺, I₃⁻, I⁻, or any combination thereof.

9. The gel electrode of claim 1, wherein the electroactive material is an inorganic electroactive material comprising:
Zn and/or Zn²⁺;
Cr²⁺ and/or Cr³⁺;
V²⁺ and/or V³⁺;
S₄²⁻ and/or S₂²⁻;
H⁺ and/or H₂; or
Ti³⁺ and/or Ti⁴⁺.

10. The gel electrode of claim 1, wherein the electroactive material is an inorganic electroactive material comprising:
I₃⁻ and/or I⁻;
Fe²⁺ and/or Fe³⁺;
V⁴⁺ and/or V⁵⁺;
Br₂ and/or Br⁻;
Mn²⁺ and/or Mn⁴⁺; or
Mn²⁺ and/or Mn³⁺.

11. The gel electrode of claim 7, wherein the electroactive material is an organic electroactive material comprising (i) an electroactive monomer, (ii) an electroactive dimer comprising two electroactive monomers that are bound together, (iii) an electroactive polymer comprising three or more electroactive monomers that are bound together, (iv) an electroactive polymer comprising a backbone polymer linked with one or more electroactive monomers, or (v) any combination of two or more of (i), (ii), (iii), or (iv).

12. The gel electrode of claim 11, wherein the electroactive monomer comprises:
a phenazine ring system and/or ions and/or N-functionalized versions thereof;
an anthraquinone ring system and/or ions thereof;
an alloxazine ring system and/or ions thereof;
a viologen ring system and/or ions thereof;
a diazobenzene ring system and/or ions thereof;
a fluorenone ring system and/or ions thereof;
a naphthalene diimide ring system and/or ions thereof;
a TEMPO ring system and/or ions thereof;
a quinone ring system and/or ions thereof;
a phenothiazine ring system and/or ions and/or N-functionalized versions thereof;
a phenoxazine ring system and/or ions and/or N-functionalized versions thereof;
a catechol ring system and/or ions thereof;
a resorcinol ring system and/or ions thereof; or
an organometallic compound comprising Fe, Co, Mn, Ti, Cr, or Cu, and/or ions of the organometallic compound.

13. The gel electrode of claim 12, wherein the organometallic compound comprises [Fe(CN)₆]⁴⁻ and/or [Fe(CN)₆]³⁻.

14. The gel electrode of claim 11, wherein the electroactive polymer in (iv) is polyvinyl alcohol (PVA) linked with one or more electroactive monomers comprising a TEMPO ring system and/or ions thereof.

15. The gel electrode of claim 1, wherein the electrode further comprises a metal substrate positioned on a surface of the electrode.

16. The gel electrode of claim 1, comprising:
carbon powder; and
an electrolyte comprising (i) a polymer selected from xanthan gum (XG) or polyvinyl alcohol (PVA); (ii) an electroactive material comprising Zn, Zn²⁺, I₃⁻, I⁻, or any combination thereof; and (iii) water;
wherein the polymer and the water form a gel, and wherein the carbon powder and electroactive material are dispersed in the gel.

17. The gel electrode of claim 1, comprising:
carbon powder; and
an electrolyte comprising (i) a polymer selected from xanthan gum (XG) or polyvinyl alcohol (PVA); (ii) an electroactive material comprising Zn and/or Zn²⁺, or comprising disulfonated fluorenone and/or ions thereof; and (iii) water;
wherein the polymer and the water form a gel, and wherein the carbon powder and electroactive material are dispersed in the gel.

18. The gel electrode of claim 1, comprising:
carbon powder; and
an electrolyte comprising (i) a polymer selected from xanthan gum (XG) or polyvinyl alcohol (PVA); (ii) an electroactive material comprising a TEMPO ring system and/or ions thereof; ferrocene and/or ions thereof; and/or [Fe(CN)₆]⁴⁻ and/or [Fe(CN)₆]³⁻; and (iii) water;
wherein the polymer and the water form a gel, and wherein the carbon powder and electroactive material are dispersed in the gel.

19. A cell, comprising:
a first electrode;
a second electrode; and
a separator disposed between a first surface of the first electrode and a first surface of the second electrode;
wherein the first electrode and the second electrode independently comprises a structure according to the electrode of claim 1.

20. The cell of claim 19, wherein the first electrode and the second electrode are the same.

21. The cell of claim 19, wherein:
(a) the first electrode and the second electrode independently comprise carbon powder and an electrolyte comprising (i) a polymer selected from xanthan gum (XG) or polyvinyl alcohol (PVA); (ii) Zn, Zn²⁺, I₃⁻, I⁻, or any combination thereof; and (iii) water; and
(b) the polymer and the water form a gel, and wherein the carbon powder and the Zn, Zn²⁺, I₃⁻, I⁻, or the combination thereof are dispersed in the gel.

22. The cell of claim 19, wherein:
(a) the first electrode and the second electrode independently comprise carbon powder and an electrolyte comprising (i) a polymer selected from xanthan gum (XG) or polyvinyl alcohol (PVA); (ii) an electroactive material; and (iii) water;
(b) the polymer and the water form a gel, and wherein the carbon powder and the electroactive material are dispersed in the gel; and
(c) the electroactive material in the first electrode comprises Zn and/or Zn²⁺, and the electroactive material in the second electrode comprises (i) a TEMPO ring system and/or ions thereof, or (ii) ferrocene and/or ions thereof.

23. The cell of claim 19, wherein:
(a) the first electrode and the second electrode independently comprise carbon powder and an electrolyte comprising (i) a polymer selected from xanthan gum (XG) or polyvinyl alcohol (PVA); (ii) an electroactive material; and (iii) water;
(b) the polymer and the water form a gel, and wherein the carbon powder and the electroactive material are dispersed in the gel; and
(c) wherein the electroactive material in the first electrode comprises fluorenone and/or ions thereof;
and the electroactive material in the second electrode comprises [Fe(CN)₆]⁴⁻ and/or [Fe(CN)₆]³⁻.

24. A method of making a gel electrode, comprising mixing (i) a conductive material, (ii) a polymer, or a monomer capable of polymerizing to form the polymer; (ii) an electroactive material, and (iv) a solvent to form the gel electrode, wherein the conductive material and the electroactive material are dispersed in the gel electrode.
